(19) United States
(12) Patent Application Publication
(10) Pub. No.: US 2017/0073591 A1
(43) Pub. Date: Mar. 16, 2017

(54) PROCESS FOR REMOVAL OF WATER (BOTH BOUND AND UNBOUND) FROM PETROLEUM SLUDGES AND EMULSIONS WITH A VIEW TO RETRIEVE ORIGINAL HYDROCARBONS PRESENT THEREIN

(71) Applicant: NAGAARJUNA SHUBHO GREEN TECHNOLOGIES PRIVATE LIMITED, Hyderabad (IN)

(72) Inventor: Dhruva Jyoti Dasgupta, Hyderabad (IN)

(21) Appl. No.: 15/122,089

(22) PCT Filed: Feb. 27, 2015
(86) PCT No.: PCT/IN2015/050014

§ 371 Date: Aug. 26, 2016

(30) Foreign Application Priority Data
Mar. 2, 2014 (IN) 3930/CHE/2013

(51) Int. Cl. C10G 33/06; C02F 1/26; B01D 21/00; B01D 11/04; B01D 17/04; C02F 1/04; C02F 11/12

(52) U.S. Cl. CPC C10G 33/06; C02F 1/048; C02F 1/26; C02F 11/127; B01D 11/04; B01D 17/042; B01D 21/00; C02F 2101/32

(57) ABSTRACT

The present invention discloses a process for pretreatment of viscous hydrocarbon sludge and subsequent process for removal bound water thereby either opting for a total reflux of solvent till achieving till achieving a boiling point of the solvent. The present invention further discloses a process for pretreatment of non-viscous hydrocarbon sludge and subsequent process for removal bound water thereby opting for a complete reflux of solvent till a maximum temperature of 99° C. when the solvent has a boiling point distinctly below 99° C. The present invention further discloses a process for treatment of non-viscous sludge thereby opting for complete reflux of solvent either till boiling point of solvent or till boiling point of solvent when the boiling point of solvent is distinctly lower than boiling point of hydrocarbons present in the non-viscous sludge.

### FIELD OF THE INVENTION

The present invention relates to processes for treatment of petroleum/crude sludge, and emulsions. More particularly, the present invention relates to a process of removal of bound and unbound water from petroleum/crude sludge consisting of hydrocarbons, water, salts and solids for improving overall commercial value thereof.

### BACKGROUND OF THE INVENTION

In refineries, production, transportation, storage and refining of the crude oil mostly create sludge. Sludge is generally a tightly held viscous emulsion of oil, water and solids wherein the solid content could vary widely. Whenever oil and water is mixed and agitated, the sludge is formed. In refineries, sludge is also formed in the desalting unit where crude is washed with fresh water to remove alkalis that had ingressed with seawater. Also, the sludge gets produced in hydro-crackers, crude storage tanks, slop oil, API separators and the like. Normally 1.6 Kg of sludge is produced per ton of crude. As per 1992 US-EPA report, petroleum refineries unavoidably generate about 30,000 tons of oil sludge waste streams per year per refinery. More than 80% of this sludge comes under the EPA hazardous waste nos. F037 and F038. In India, more than 2.62 lac ton of sludge is being produced in a year.

Sludge also gets formed, when water in crude is vigorously agitated/sheared by transfer pumps. Being heavier than light oils, the sludge tends to settle at the bottom of ship load, but gets removed from ship, when crude is pumped out at the refinery. Apart from that, tank sludge, which is a solid layer that accumulates with time at ship bottom, is removed once in 5 years or so. Typically a 60-M tank disgorges 1,000 MT of material. About 85 to 90% of it constitutes heavy hydrocarbons like paraffin, asphalt, micro-crystalline wax, etc. Often this material is removed using high pressure water jets. Sludge also gets generated in post refinery operations. When heavy liquid fuels like LSHS or furnace oil are used for power generation through low speed DG sets 0.5 wt % to 1 wt % sludge gets formed. These DG sets could either be land based or marine. Sludge also gets produced in waste-oil re-conditioning plants. Formation of sludge is a great problem in overall world.

Accordingly, it is evident that petroleum sludge is a huge issue all around the world. Each year US produces 30,000 tons of oily sludge, whereas China produces about 3 million tons of sludge each year. Even with all the developments made in the petroleum industry, we produce 1 ton of oily sludge waste for every 500 tons of crude oil that is processed. There have been several inventions made to solve this problem and yet there is 11.589 billion tons of sludge sitting in lagoons containing 5.79 billion tons of crude oil.

Recently, cleaning-up of sludge ponds and lagoons has emerged as a lucrative commercial business. Refineries are keen to recover oil from sludge. Refineries are keen to extract energy from the sludge when recovery of oil is not possible. When even that's not possible, refineries try to convert it into innocuous substances, at the least cost. Moreover, there are various efforts seen in the art for treating the sludge using various techniques for dewatering of petroleum sludges using various techniques like centrifugation, distillation, heating and use of de-emulsifiers. However, none of the above techniques has been found satisfactorily effective to remove bound water. The term “Bound water” referred herein is defined as water that cannot be separated from hydrocarbons after subjecting it to centrifugation at 21,893 RCF for 10 min. There are few attempts seen in the art that utilize azeotropic solvents for recovery of bound water from the sludges.

For example, the German Patent No.19, 936,474, discloses a simplified method for separation of oil from sludge with the use of azeotropic solvents. The disclosed process involves addition of solvent until the mixture becomes a stirrable pulp. Addition of excess amount of solvent may result in excessive use of solvent than required. Under certain circumstances, addition of less amount of solvent than required may result in more solvent recycle and higher energy consumption. It was also observed that stirring a viscous mixture, as disclosed in cited patent document, consumes a lot of energy. The cited patent document discloses that the solids are removed after water separation from sludge. Accordingly, presence of solids in azeotropic distillation stage may negatively affect the heat transfer properties of boiling equipment and increase energy consumption. It may also lead to loss of hydrocarbons due to oily solids or alternatively increase the cost of de-oiling of solids. The process in cited patent document leads to incomplete separation of water from sludge as the operating temperature of water-solvent azeotrope does not exceed the azeotropic boiling point of water-solvent azeotrope. Moreover, in the cited process, solvent added for removal of water from the sludge is not recovered as it would increase the cost of solvent utilized in said process as well as diminishes the commercial value of the recovered hydrocarbons. In addition, the cited process includes impeller assisted agitation that would increase the amount of foam formed during said process by incorporating air bubbles into foam due to low surface tension liquid. Accordingly, the cited process fails to have provisions for handling high foaming sludges and hence cannot be used universally for all the sludges.

Further, U.S. Pat. No. 8,323,456 discloses use of azeotropic solvent for removal of bound water from bio-oil, however, the bound water in bio-oil is held due to chemical bonds and not due to viscosity. It is well known that Bio-oil has very low viscosity thereby limiting use thereof in the azeotropic distillation columns. The process as explained in the cited patent document essentially requires use of vacuum and high temperatures of 130° C. However, complete water separation is not possible by cited process and recovery of entire hydrocarbon fraction is also not possible. Further, cited process is not suitable for viscous hydrocarbon sludge.

U.S. Pat. No. 4,741,840 discloses a process that uses water-immiscible azeotropic solvent to remove liquid hydrocarbons from solids. In cited process, solvent is added to reduce viscosity of sludge in order to facilitate mechanical separation of solids and liquid hydrocarbons. It is seen that, water is removed by azeotropic distillation, if present in sludge. However, the amount of solvent added and lack of reflux make cited process inefficient for removal of water. In cited process, free water is added in an amount of about 2-5 times that of solvent. However, addition of excess amount of water in such a huge amount, may further lead to increase in energy consumption.

Russian Patent No. SU 566867 discloses a process of dehydration of aqueous emulsion by addition of solvent in proportion to the weight of sludge followed by azeotropic distillation in presence of an inert gas to separate water from emulsion. In cited process, the solids and excess solvent are separated in later stages by filtration and heating up to boiling point of solvent with or without reduced pressure. However, said process fails to remove solids from the sludge before heating it to remove water. This could cause fouling and scaling of heat transfer surfaces. Moreover, if the sludge being treated in said process contains emulsifiers then it may result into formation of foam due to air bubbles trapped in the sludge due to low surface tension. In addition, said process would fail to recover entire solvent if heated up to boiling point of the solvent. Moreover, the recovered solvent might be obtained contaminated with low boiling hydrocarbons present in the sludge as said process fails to disclose or suggest any attempt towards recovery of low boiling hydrocarbons.

There are also few efforts seen in the art wherein azeotropic distillation is disclosed for separation of water or hydrocarbons from sludge. However, these processes are substantially incompetent to handle highly viscous petroleum sludge with bound water present therein. For example, U.S. Pat. No. 4,243,493 uses methanol to transport hydrocarbons and methanol-hydrocarbon azeotrope to separate light hydrocarbons from crude. European patent No. 0347605 discloses a method for separation of solvent from hydrocarbons by spraying said mixture in an evaporating boiler and passing dry gas through it to vaporize the solvent and separate it from the liquid phase. European Patent No. 0361839 discloses a dehydration process using azeotropic distillation which is used to separate water from the product stream of chemical reaction by cooling the condensate of azeotropic distillation till the organic phase becomes supersaturated resulting in an organic phase with reduced water content to be recycled back into the reactor. U.S. Pat. No. 4,686,774, discloses a method for dehydration of a composition of a fine powder and water, by adding solvent to form an emulsion and boiling said emulsion to obtain water free fine powder without formation of agglomerates. In addition, U.S. Pat. No. 3,669,847 discloses a process for separating steam-volatile organic solvents from industrial process waste water that separates organic solvents from process waste water by injection of steam and allowing organic solvent to vaporize followed by condensing said vapor phase to recover said solvents. Chinese Patent CN10151407 discloses a process for sludge dewatering to treat waste water sewage sludge by adding organic solvent and boiling azeotropically to reduce the water content of sewage sludge. Chinese Patent CN1298811 discloses dewatering method of fusel oil in production of alcohol fuel which uses water-miscible ethanol as an entrainer in a homogeneous azeotropic distillation of fusel oil to reduce the water content in fusel oil. U.S. Pat. No. 5,2996,040, discloses process for cleaning debris containing water contaminated with pollutants by adding solvent in which solubility of pollutants is more than solubility in water, followed by azeotropic distillation of said mixture to get pollutant free solids and solvent with dissolved pollutants that removed from said solvent by distillation.

In addition, US Patent Application No. 2009/0223858 discloses a method to recover crude oil from sludge by addition of reagent and homogenization to destabilize micellar structure of oil-water emulsion. However, destabilization of micellar structure only works for sludges wherein emulsion is stabilized due to presence of emulsifiers or surfactants which limits utility of said process to treat most sludges found where water is held due to viscosity, especially sludge with bound water present. It is seen that addition of reagent may change the properties of the hydrocarbons as well as contaminates the recovery of final hydrocarbon product. Accordingly, it was observed that use of centrifuge is an energy intensive process to remove water from emulsion and cannot remove water from all types of sludges.

Moreover, International Patent Pub. No. WO 2014/091498 discloses a process for recovering water from sludge by addition of solvent and heat. However, said process fails to disclose refluxing of solvent after collection of vaporized solvent. Accordingly, a substantially excess amount of solvent needs to be added in said process for removal of entire water from the sludge. Hence, said process requires substantially large size of reactors to treat the sludge. Further, rate of heating needs to be critically controlled in said process to recover entire water content from the sludge to prevent pure boiling of the solvent without water. However, the controlled rate of heating diminishes kinetics of water removal especially towards the fag end of the process, more preferably when the water remaining in the sludge is very small. In said process, excess amount of solvent present may lower the viscosity of the sludge to an extent where water separates from the sludge and it becomes difficult for water to be removed in azeotropic ratio thereby adversely affecting efficiency and kinetics of the process. In addition, segregation of water also reduces solvent-water interaction in said process thereby depleting availability of solvent especially at the bottom of the reactor.

Accordingly, there exists a need of a process for treatment of viscous sludges/emulsions for removal of entire bound and unbound water thereby making adequate and efficient use of water-immiscible azeotropic solvents.

### SUMMARY OF THE INVENTION

The present invention provides a process for treatment of sludge mixture, emulsions and water bearing hydrocarbons preferably with determined quantity of water present therein. The present invention includes an initial step of pretreatment of the sludge mixture for removal of unbound water, salts, solids, water soluble emulsifiers, free flowing hydrocarbons and viscous pure hydrocarbons thereby obtaining a predefined amount of remaining sludge. In next step, the remaining sludge is segregated by viscosity using separation equipments followed by recovering a plurality of recovered fractions separately for removal of entire or partial bound and/or unbound water therefrom. In next step, a plurality of different hydrocarbon fractions containing bound water and low boiling hydrocarbons are treated thereby optionally adding free water followed by heating up to a boiling point of the water thereby employing steam stripping in said process. In next step, the plurality of hydrocarbon fractions separately for removal of both bound and unbound water recovered in earlier step are treated thereby selectively depressing boiling point through addition of a predefined amount of water immiscible solvent in said process. In next step, the reaction mixture in earlier step is boiled by applying heat for achieving a predefined temperature of said mixture optionally controlling said process on the basis of final raised temperature or by an amount of water collected or both. In next step, a specific quantity of the solvent and water are added thereby partially or continuously refluxing a predefined amount of the recovered solvent during said process until achieving the predefined temperature. In next step, a predefined amount of free water is added to the hydrocarbons in followed by boiling out the solvent through application of heat thereby removing excess free water left behind by optionally through a gravity settling or a centrifuge in hot condition or via boiling, thereby rapidly separating residual water from said hydrocarbons. In next step, a specific amount of original hydrocarbons is recovered in marketable form with highest possible commercial value thereof followed by recovering bound water, unbound water and free water in an environmentally safe and useful condition after treating the water for such use. The recovered solvent is reused in said process for further removal of bound water of incoming sludge mixture after removing entrained, soluble water therein followed by purifying at least a part of said solvent for removing fractions of dissolved hydrocarbons therefrom.

### BRIEF DESCRIPTION OF DRAWINGS

FIG. 1 is a process flow diagram showing a process for pretreatment of viscous hydrocarbon sludge prior to removal of bound water therefrom;

FIG. 2 is a process flow diagram showing a process for treatment of viscous hydrocarbon sludge for removal of bound water thereby opting for a complete reflux of solvent till a boiling point of the solvent at an atmospheric pressure;

FIG. 3 is a process flow diagram showing a process for pretreatment of non-viscous hydrocarbon sludge prior to removal of bound water therefrom;

FIG. 4A is a process flow diagram showing a process for treatment of non-viscous sludge thereby opting for complete reflux of solvent till a maximum temperature of 99° C. at an atmospheric pressure wherein the solvent has a boiling point distinctly below 99° C.;

FIG. 4B is a process flow diagram showing a process for treatment of non-viscous sludge thereby opting for complete reflux of solvent till boiling point of solvent at an atmospheric pressure;

FIG. 4C is a process flow diagram showing a process for treatment of non-viscous sludge thereby opting for complete reflux of solvent till boiling point of solvent at an atmospheric pressure wherein the boiling point of solvent is distinctly lower than boiling point of hydrocarbons present in the non-viscous sludge;

FIG. 5A is a graphical representation of purity of Toluene recovered from the sludge containing furnace oil and diesel against Wt. % of Toluene recovered; and

FIG. 5B is a graphical representation of purity of Xylene recovered from the sludge containing Furnace Oil and Diesel against Wt. % of Xylene recovered.

### DETAILED DESCRIPTION OF THE INVENTION

The invention described herein is explained using specific exemplary details or better understanding. However, the invention disclosed can be worked on by a person skilled in the art without the use of these specific details.

References in the specification to “one embodiment” or “ an embodiment” means that a particular feature, structure, characteristic, or function described in connection with the embodiment is included in at least one embodiment of the invention. The appearances of the phrase “in one embodiment” in various places in the specification are not necessarily all referring to the same embodiment.

References in the specification to “preferred embodiment” means that a particular feature, structure, characteristic, or function described in detail thereby omitting known constructions and functions for clear description of the present invention.

In the description and in the claims, the term “Sludge” is defined broadly a mixture of hydrocarbons, solids, salts, emulsifiers, unbound water and bound water thereby having a viscosity varying from about 10 centiPoise(cP, hereinafter) to 1,25,000 cP at 30° C.

In the description and in the claims, the term “Free flowing hydrocarbons” is a mixture of hydrocarbons with or without bound water, solids and salts thereby having a viscosity values less than about 100 cP at 30° C.

In the description and in the claims, the term “Viscous hydrocarbons” is a sludge mixture having bound water, solids, salts and viscosity values from about 100 cP to 1,25,000 cP at 30° C.

In the description and in the claims, the term “Non-viscous Sludge” is defined broadly as solids-free non-viscous hydrocarbons sludge with bound water and without low boiling hydrocarbons and with or without some unbound water and emulsifier present, if any.

In the description and in the claims, the term “Solids” are materials whose content can vary from 0 to 80% of the total material.

In the description and in the claims, the term “Bound Water” is defined broadly as water that does not come out hydrocarbon inspite centrifuging the sludge at 21893 RCF for at least 10 minutes.

In the description and in the claims, the term “Unbound Water” is defined broadly as any water apart from bound water.

In the description and in the claims, the term “Condenser” is a two stage condenser, first stage being ambient air based and second stage being chiller based.

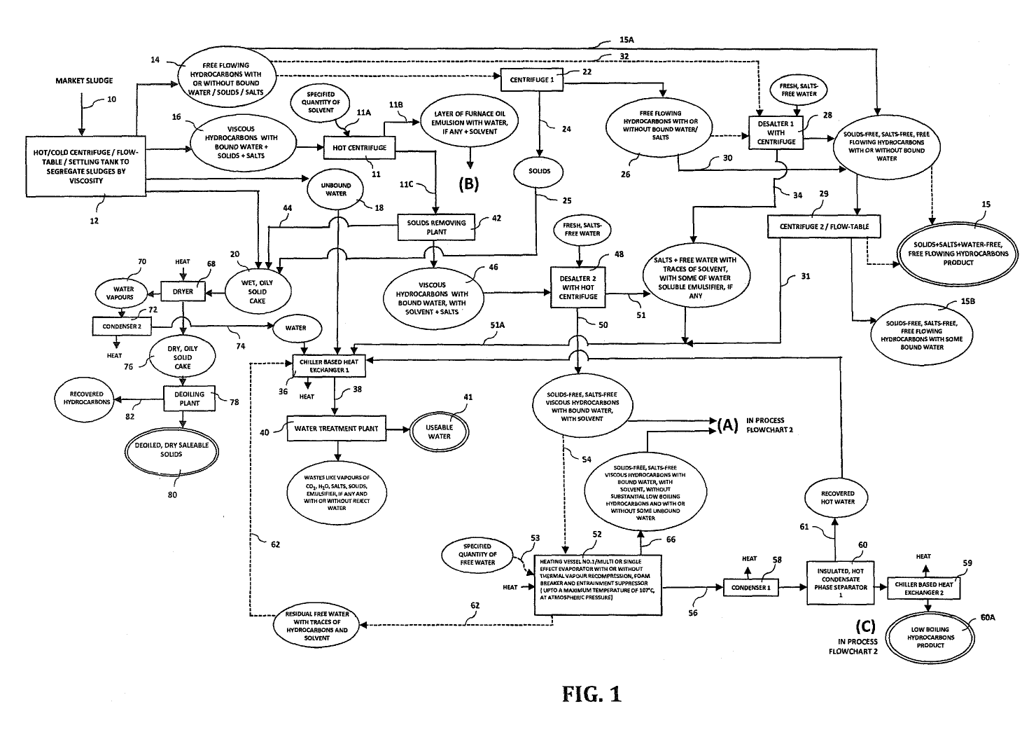

Referring to FIG. 1, a process for pretreatment of sludges having viscous hydrocarbons prior to removal of bound water is shown. In the context of the present invention, the sludge mixture is a market sludge that acts as a feed stream 10. In an initial step, the feed stream 10 is fed to a centrifuge 12 to segregate sludges on account of viscosity. In this one embodiment the centrifuge 12 is selected from a hot centrifuge, a cold centrifuge, a flow table, a settling tank and the like, either alone or in combination, to segregate sludge in the feed stream 10 on account of viscosity. The centrifuge 12 is a maintained at a temperature range of about 30 to 95° C. The centrifuge 12 separates a free flowing hydrocarbon layer 14 from a viscous hydrocarbon layer 16 thereby removing an unbound water layer 18 and retaining a residual wet, oily solid cake layer 20 in the centrifuge 12.

Optionally, a predefined amount of solvent may be added to the hot centrifuge 11 along line 11A such that a layer of viscous hydrocarbon emulsion with water, if any, along with solvent is recovered along line 11B and viscous hydrocarbon layer is obtained along line 11C with bound water, solvent and salts. The layer of hydrocarbon emulsion with water, if any, along with solvent 11B is processed along line-B in further process. It is understood here that addition of specified quantity of solvent along line 11A reduces viscosity during said process. The predefined quantity of solvent is preferably in a predefined proportion that is not more that the quantity of solvent being added in further process of the present invention.

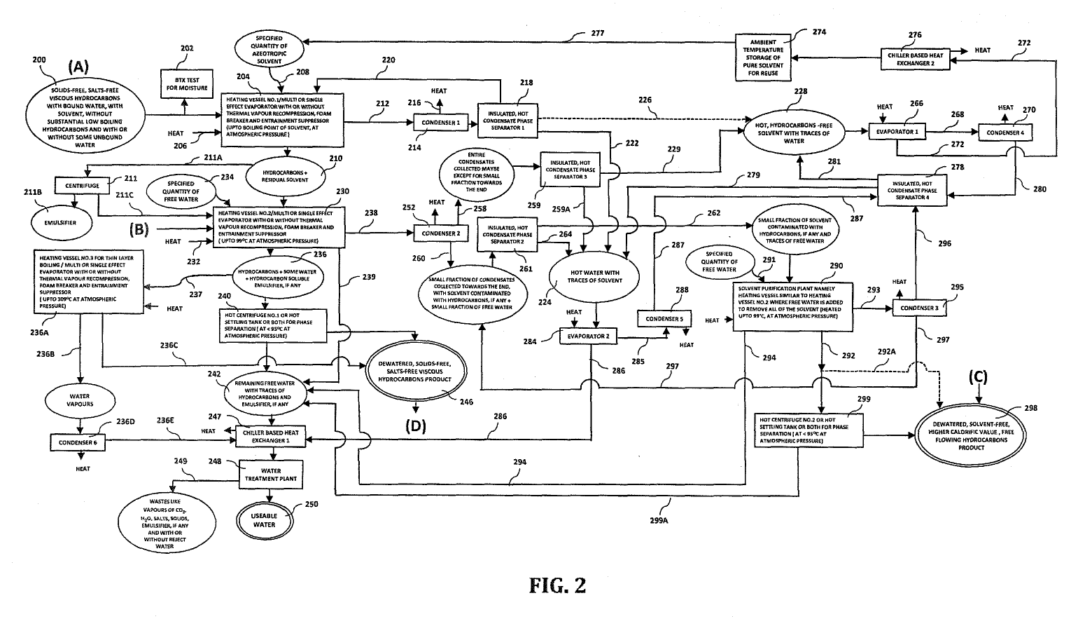

The free flowing hydrocarbon layer 14 contains free flowing hydrocarbons with or without bound water, solids and salts. The free flowing hydrocarbon layer 14 is directly stored as a solids-free, salts-free, water-free free flowing hydrocarbon product 15 thereby recovering the same along line 15A, if it is free from salts, solids and bound water. Alternatively, the free flowing hydrocarbon layer 14 is sent to a centrifuge 22 if it contains solids with or without salts. The centrifuge 22 separates solids along line 24 thereby obtaining a free flowing hydrocarbon layer 26 with or without bound water and salts. The solids separated along line 24 are mixed with the wet, oily solid cake layer 20 along line 25 as shown. The free flowing hydrocarbon layer 26 is sent to a desalter with centrifuge 28 if salts are present therein. Alternatively, the free flowing hydrocarbon layer 26 is passed along line 30 if it contains bound water without any salts or solids present therein. The free flowing hydrocarbon layer 14 is stored as solids-free, salts-free, water-free free flowing hydrocarbon product 15 if it is free from bound water else it is treated in a centrifuge 29 or flow-table for separating water along line 31 for obtaining solids-free, salts-free, free flowing hydrocarbons with bound water 15B that is used in further process as an input material without being mixed with viscous hydrocarbon layer for being treated in further process as shown in FIG. 2. In one embodiment, the free flowing hydrocarbon layer 14 is directly sent to the desalter with centrifuge 28 along line 32 without being passed through the centrifuge 22, if it is free from solids. In this step, a predefined amount of salts-free water is added in the desalter with centrifuge 28 thereby obtaining a free water layer 34 containing salts with water soluble emulsifiers present, if any.

In next step, the unbound water layer 18 is sent to a chiller based heat exchanger 36 for removing heat therefrom. The unbound water layer 18 has Total Dissolved Solids of about 40,730 ppm. In this step, the chiller based heat exchanger 36 removes heat from the unbound water layer 18. The chiller based heat exchanger 36 provides a product water layer 38 that is further treated in a water treatment plant 40 thereby obtaining usable water product 41. In this step, the water recovered along line 31 is also added to the water treatment plant 40, after being passed through chiller based heat exchanger 36, for obtaining usable water product 41.

In next step, the viscous hydrocarbon layer 16 is passed through hot centrifuge 11 and subsequently sent to a solid removal plant 42 along line 11C that removes solids from the viscous hydrocarbon layer 16 along line 44 thereby obtaining solids-free viscous hydrocarbon layer 46 with bound water, solvent and salts. The solids removed along line 44 are mixed with wet, oily solid cake layer 20 as shown. It is understood here that the solids removed along line 25 are also mixed with the wet, oily solid cake layer 20 in this step. The solid free viscous hydrocarbon layer 46 is sent to a desalter with hot centrifuge 48 wherein a predefined amount of fresh salt-free water is added such that a viscous hydrocarbon layer 50 is obtained which contains bound water, solvent and is free from solids and salts. In this step, a predefined amount of free water is recovered along line 51 containing salts, free water with traces of solvent and water soluble emulsifiers present, if any. The free water recovered along line 51 is mixed with the free water layer 34 and subsequently sent to the chiller based heat exchanger 38 along line 51A for recovery of usable water after passing through water treatment plant 40. The solids-free, salts-free viscous hydrocarbon layer 50 is processed ahead along line-A, if it is free from low boiling hydrocarbons.

In one embodiment, the viscous hydrocarbon layer 50 is sent to a reactor 52 along line 54, if it contains low boiling hydrocarbons. Additionally, a predefined amount of free water may or may not be added to the reactor 52 along line 53. In the context of the present invention, the reactor 52 is a heating vessel or single/multi-effect evaporator with/without thermal vapor recompression, foam breaker and entrainment suppressor. The thermal vapor recompression in the reactor 52 avoids thermal cracking of the product hydrocarbon stream. The foam breaker and entrainment separator in the reactor 52 avoid entrainment of hydrocarbons. The reactor 52 operates at a predefined pressure. In this one particular embodiment, the predefined pressure is an atmospheric pressure. The reactor 52 operates at a predefined temperature. In this one particular embodiment, the predefined temperature of the reactor 52 is designed to reach a maximum temperature up to 107° C. A heat source is provided to the reactor 52. The heat source in the reactor 52 is a waste heat source that reduces cost of energy involved in said process. The reactor 52 boils out vapors of low boiling hydrocarbons and water along line 56 that is sent to a condenser 58 followed by passing through an insulated, hot condensate phase separator 60 followed by a chiller based heat exchanger 59 which recovers low boiling hydrocarbons product 60A, thereby recovering hot water along line 61 that is recycled to the chiller based heat exchanger 36 for recovery of usable water through water treatment plant 40 as shown. If free water is added along line 53 then the reactor 52 removes a residual free water layer 62 containing traces of hydrocarbons and solvent. The residual free water layer 62 is recycled to the chiller based heat exchanger 36 for recovery of usable water through the water treatment plant 40 as shown. The reactor 52 discharges a viscous hydrocarbon layer along line 66 that is processed ahead along line-A as shown.

The wet, oily solid cake layer 20 is fed to a dryer 68, after being mixed with wet, oily solid cake layers recovered along lines 25 and 44. A heat source is provided to the dryer 68 to achieve a predefined temperature in this one embodiment. The predefined temperature is about 108° C. The heat source in the dryer 68 is preferably a waste heat source that reduces cost of energy involved in said process. The dryer 68 evaporates water vapors from the wet, oily solid cake layer 20 which are recovered along line 70. The water vapors recovered along line 70 are condensed in a condenser 72 for obtaining water in liquid form along line 74. The water obtained along line 74 is fed to the chiller based heat exchanger 36 for recovery of usable water through water treatment plant 40 as illustrated. The wet, oily solid cake layer 20 is dried in the dryer 68 thereby obtaining dried solid cake 76. The dried solid cake 76 is sent to a de-oiling plant 78 for obtaining hydrocarbon-free de-oiled dry saleable solid product 80, thereby recovering hydrocarbons along line 82 as illustrated.

The process of pretreatment in the context of the present invention is such that the time of stripping to get the output along lines-A is adequate and predefined such that all the low boiling hydrocarbons having boiling point maximum up to 15° C. more than that of solvent are utilized in following flowchart 2 thereby recovering the same in the pretreatment process. These recovered low boiling hydrocarbons are processed along line-C as illustrated.

The process for treatment in accordance with the present invention separates the viscous hydrocarbon along line-A such that addition of solvent in further process of treatment of this viscous hydrocarbon layer enhances density difference between water and hydrocarbons in order to achieve more separation of water during further process. In addition, the process of pretreatment also reduces viscosity of hydrocarbons and helps in bringing out more bound water in further process. In addition, it selectively leaches out hydrocarbon from the water in remaining emulsion such that water content in remaining emulsion goes to about 80 to 85%. Hence, the process of pretreatment may act as a route to make emulsions with viscous hydrocarbons thereby having at least 60% water content.

Referring to FIG. 2, a total reflux based process for treatment of a sludge mixture is disclosed. In the context of the present invention, the sludge mixture is a feed stream 200 that is obtained along line-A. The feed stream 200 is preferably a sludge mixture that contains solids-free, salts-free viscous hydrocarbons with bound water, with solvent, without substantial low boiling hydrocarbons and with or without some unbound water. In a first step, the feed stream 200 is subjected to a BTX test 202 for detecting moisture contained in the feed stream 200. In next step, the feed stream 200 is charged to a reactor 204. In the context of the present invention, the reactor 204 is a heating vessel or single/multi-effect evaporator with/without thermal vapor recompression, foam breaker and entrainment suppressor. The thermal vapor recompression in the reactor 204 avoids thermal cracking of the product hydrocarbon stream. The foam breaker and entrainment separator in the reactor 204 avoid entrainment of hydrocarbons. The reactor 204 operates at a predefined pressure. In this one particular embodiment, the predefined pressure is an atmospheric pressure. The reactor 204 operates at a predefined temperature. In this one particular embodiment, the predefined temperature of the reactor 204 is configured to reach maximum up to a temperature of boiling point of solvent used in said process. A heat source 206 facilitates the reactor 204 to achieve the predefined temperature in this one embodiment. The heat source 206 in the reactor 204 is a waste heat source that reduces cost of energy involved in said process.

In this step, a predefined amount of azeotropic solvent is added to the reactor 204 along line 208. In the context of the present invention, the predefined amount of azeotropic solvent has a critical impact in bringing out the bound water at least temperature from the hydrocarbon stream. The azeotropic solvent is selected from the group of Benzene, Toluene, Xylene, Hexane, Heptane and mixtures thereof. In case of Xylene being used as solvent, preferably, ratio of weight of water present to Xylene is maintained at 1:3. In case of Toluene being used as solvent, preferably, ratio of weight of water present to Toluene is maintained at 1:3 or 1:4 In case of Benzene being used as solvent, preferably, ratio of weight of water present to Benzene is maintained at 1:3. Alternatively, solvent is added with respect to amount of hydrocarbons present. For Xylene, weight ratio of Xylene to hydrocarbons is 1.6:1 to 2:1. For Toluene, weight ratio of Toluene to hydrocarbons is 2:1. For Benzene, weight ratio to Benzene to hydrocarbons is 1:1 to 2:1. From above two criteria for ratio of solvent with water present or hydrocarbons present in reactor 204, the highest of the above two quantities of solvent is selected for addition. The reactor 204 generates a residual phase 210 and a vapor phase 212. The vapor phase 212 is a solvent stream that contains vapors of solvent and entire bound water. The residual phase 210 is a hydrocarbon stream that contains entire solvent.

In next step, the vapor phase 212 is fed to a condenser 214. In the condenser 214, the vapor phase 212 is condensed by removing heat along line 216 and subsequently sent for phase separation in an insulated, hot condensate phase separator 218. In the insulated, hot condensate phase separator 218, a solvent layer is recovered along line 220 and a hot water layer is recovered along line 222. The hot water layer recovered along line 222 is stored in an intermediate hot water storage tank 224.

In this one embodiment, the solvent recovered along line 220 is totally refluxed back to the reactor 204 during said process. Preferably, solvent is refluxed back such that foam breaker arrangement in reactor 204 remains at high temperature. It is necessary here that refluxing solvent does not interfere with the foam breaker. In the context of this embodiment, removal of entire bound and unbound water is enabled such that the boiling point of bound water is depressed thereby applying heat and reaching a temperature up to the boiling point of the solvent thereby refluxing back all the solvent during said process. Alternatively, a certain fraction of solvent condensed in 218 may not be refluxed back to 204 and instead removed along line 226 such that solvent to residual hydrocarbon weight ratio in reactor 204 does not drop below predefined minimum weight ratio for the same.

In next step, the residual phase 210 is either directly sent to a reactor 230 if it is free from water soluble emulsifiers. Alternatively, the residual phase 210 is sent to a centrifuge 211 along line 211A if it contains water soluble emulsifiers. Accordingly, the centrifuge 211 removes emulsifiers along line 211B, thereby charging water soluble emulsifier-free residual phase 210 to the reactor 230 along line 211C. The reactor 230 is a heating vessel or single/multi-effect evaporator with/without thermal vapor recompression, foam breaker and entrainment suppressor. The thermal vapor recompression in the reactor 230 avoids thermal cracking of the product hydrocarbon stream. The foam breaker and entrainment separator in the reactor 230 avoid entrainment of hydrocarbons. The reactor 230 operates at a predefined pressure. In this one particular embodiment, the predefined pressure is an atmospheric pressure. The reactor 230 operates at a predefined temperature. In this one particular embodiment, the predefined temperature of the reactor 230 is designed to reach maximum up to 99° C. A heat source 232 facilitates the reactor 230 to achieve the predefined temperature in this one embodiment. The heat source 232 is preferably a waste heat source which reduces cost of energy in said process. In this step, a predefined amount of free water is added to the third reactor 230 along line 234. It is understood here that addition of predefined amount of free water 234 has a critical impact in bringing out water at least temperature from the hydrocarbon stream.

Accordingly, the predefined amount of free water 234 is added in a predefined ratio with respect to weight of solvent present in the reactor 230. In this step, the layer of furnace oil emulsion with water, if any, and solvent obtained along line-B is also added to the reactor 230. Preferably, weight ratio of free water to solvent is added at 1:1 for Toluene, 2:1 for Xylene and 1:1 for Benzene. The reactor 230 generates a residual phase 236 and a vapor phase 238. The vapor phase 238 contains vapors of entire solvent and part of free water may be with hydrocarbon contamination obtained towards end. The residual phase 236 contains hydrocarbon stream with some water and hydrocarbon soluble emulsifiers present, if any. The reactor 230 removes remaining free water with traces of hydrocarbons along line 239. The residual phase 236 is passed through a reactor 236A along line 237 for removal of water vapors along line 236B thereby obtaining a dewatered, solids-free, salt-free viscous hydrocarbon product 246 along line 236C. To avoid condensation of water vapors present in 237, reactor 236A is provided with either thin layer cascading arrangement, spray arrangement, holding vessel with continuous agitation arrangement or a hot hydro-cylone arrangement. Alternatively, water vapors can be fluidized by bubbling flue/inert gas through 237. The water vapors along line 236B are condensed into a liquid form in a condenser 236D followed by passing it through a chiller based heat exchanger 247 along line 236E. The reactor 236A operates at a predefined pressure and a predefined temperature. The predefined pressure of the reactor 236A is atmospheric pressure. The predefined temperature of the reactor 236A is configured to reach up to maximum of 109° C. A predefined amount of heat source is supplied to the reactor 236A to facilitate heating. The heat source supplied to the reactor 236A is a waste heat source in accordance with the present invention.

Alternatively but not preferably, the residual phase 236 is fed to a hot centrifuge 240 without being passed through the reactor 236A. The hot centrifuge 240 or a settling tank or a combination of both operates at a predefined temperature and predefined pressure. In this one particular embodiment, the predefined temperature of the hot centrifuge 240 is configured to reach to a temperature maximum up to 95° C. The predefined pressure of the hot centrifuge 240 is atmospheric pressure. The hot centrifuge 240 ensures adequate reduction in viscosity of hydrocarbons, thereby forming two layers namely a first layer 242 and a second layer 246. The first layer 242 contains remaining free water with traces of hydrocarbons and emulsifier, if any. The second layer 246 is obtained as de-watered, solids-free, salts-free viscous hydrocarbon product in a range of about 95 to 99 wt % that is passed along line-D. The first layer 242 is passed through the chiller based heat exchanger 247 followed by treatment thereof through a water treatment plant 248 for obtaining usable water product 250 in a range of about 94 to 99 wt %, thereby separating wastes along line 249 such as vapors of CO₂, H₂O, salts, solids, emulsifier, if any, and with or without reject water.

In next step, the vapor phase 238 is fed to a condenser 252. In the condenser 252, the vapor phase 238 is condensed, wherein a first layer is recovered along line 258 and a second layer is recovered along line 260. The first layer 258 preferably contains entire condensates collected may be except for small fractions towards the end. The second layer 260 preferably contains small fractions of condensates collected towards the end with solvent contaminated with hydrocarbons, if any, along with small fractions of free water. The first layer 258 is passed through insulated, hot condensate phase separator 259 for removal of hot water with traces of solvent along line 259A and hot, hydrocarbons-free solvent with traces of water is fed to a hot solvent storage tank 228 along line 229. The second layer 260 is fed to an insulated, hot condensate phase separator 261 thereby recovering a solvent layer 262 and a water layer 264 respectively. The solvent layer 262 preferably contains small fractions of solvent contaminated with hydrocarbons, if any, and traces of free water. The water layer 264 preferably contains hot water with traces of solvent. The water layer 264 is added to the intermediate hot water storage tank 224 as shown.

In next step, the hot solvent stored in the intermediate hot solvent storage tank 228 is sent to an evaporator 266. The evaporator 266 is supplied with a heat source that facilitates heating to the first evaporator 266 for achieving a predefined temperature essential to boil out solvent without water. Preferably, the evaporator 266 operates at a temperature of about 100° C. in this one preferred embodiment. The heat source provides controlled heating such that predefined temperature of the first evaporator 266 is prohibited from reaching up to the boiling point of solvent. The heat source is a waste heat source which reduces cost of energy in said process. The evaporator 266 recovers vapors of solvent and water along line 268 which are fed to a condenser 270. A bulk amount of pure solvent without water is let out from evaporator 266 in liquid form that is recovered along line 272 and stored in a pure solvent storage tank 274 at an ambient temperature after being passed through a chiller based heat exchanger 276. The pure solvent is optionally recycled in a process along line 277 for being mixed with the solvent stream 208, if needed. The condenser 270 provides condensates of solvent along with water that are fed to an insulated, hot condensate phase separator 278 along line 280. The insulated, hot condensate phase separator 278 removes hot water with traces of solvent which are added to the intermediate hot water storage tank 224 along line 279. The insulated, hot condensate phase separator 278 removes hot, hydrocarbons-free solvent with traces of water which are added to the intermediate hot solvent storage tank 228 along line 281.

In next step, the hot water in the intermediate hot water storage tank 224 is added to an evaporator 284 wherein a predefined amount of heat is supplied for forming a vapor phase 285 and a liquid phase 286. The vapor phase 285 contains vapors of solvent along with water. The liquid phase 286 contains bulk water without any solvent. The liquid phase 286 is fed to the chiller based heat exchanger 247 for being treated through the water treatment plant 248 to recover usable water as illustrated. The vapor phase 285 is sent to a condenser 288 wherein vapors of solvent are condensed to obtain condensates along line 287. The condensates obtained along line 287 contain condensates of solvent along with water which is fed to the insulated, hot condensate phase separator 278 as illustrated.

In next step, the solvent layer 262 containing small fraction of solvent contaminated with hydrocarbons, if any, and traces of free water is added to a solvent purification plant 290 wherein a predefined amount of free water is added along line 291. The solvent purification plant 290 is a heating vessel that is identical to the reactor 230 wherein free water is added to remove all the remaining solvent. The solvent purification plant 290 operates at a predefined pressure. In this one particular embodiment, the predefined pressure is an atmospheric pressure. The solvent purification plant 290 operates at a predefined temperature. In this one particular embodiment, the predefined temperature of the solvent purification plant 290 is designed to reach to a maximum temperature up to 99° C. A heat source is applied to the solvent purification plant 290 to achieve the predefined temperature in this one embodiment. The heat source is preferably a waste heat source which reduces cost of energy in said process. In this step, the predefined amount of free water added along line 291 has a critical impact in bringing out all the solvent. The predefined amount of free water 291 is added in a predefined ratio with respect to weight of solvent present in the solvent purification plant 290. Preferably, weight ratio of free water to solvent is added at 1:1 for Toluene, 2:1 for Xylene and 1:1 for Benzene. The solvent purification plant 290 generates a residual phase 292, a vapor phase 293 and a free water phase 294. The free water phase 294 is mixed with the first layer 242 for being treated through the water treatment plant 248 in order to obtain usable water as shown. The vapor phase 293 contains vapors that are condensed in a condenser 295 such that entire condensates are collected along line 296 except for small fraction towards the end with small fraction of free water. The condenser 295 also provides small fractions of condensates along line 297 that are collected at the end with solvent contaminated with hydrocarbons and having small fractions of the free water therein. The condensates along line 297 are added to the second layer 260 as illustrated. The residual phase 292 is stored as dewatered, solvent-free, free flowing hydrocarbon product 298 along line 292A, if free water is not present therein. The dewatered, solvent-free, free flowing hydrocarbon product 298 is obtained in a range of about 1 to 15 wt % of original solvent added to the system. Alternatively, the residual phase 292 is charged to a hot centrifuge 299 if it contains free water. The hot centrifuge 299 or a hot settling tank or a combination of both removes remaining free water with traces of hydrocarbons along line 299A that is mixed with the first layer 242 as illustrated. The hot centrifuge 299 operates at a predefined temperature and predefined pressure. In this one particular embodiment, the predefined temperature of the hot centrifuge 299 is configured to reach a maximum temperature up to 95° C. The predefined pressure of the hot centrifuge 299 is atmospheric pressure. In this step, low boiling hydrocarbons product obtained along line-C is added to the free flowing hydrocarbon product 298.

As shown in FIG. 2, it is understood here that recovery of solvent by supplying heat to reactor 230 is affected by remaining high boiling hydrocarbons present in the sludge prior boiling in pretreatment is carried out to remove low boiling hydrocarbons and in such case very pure solvent is recovered. However, the kinetics of the process slows down excessively. Alternatively, when low boiling hydrocarbons are not removed in pretreatment process, recovery of solvent in the processes shown in FIG. 2 is governed by these low boiling hydrocarbons present and in such case the kinetics of recovery of solvent gets accelerated because of the presence of low boiling hydrocarbons. However, in such case compromise is made with regard to purity of solvent, as the collected solvent has low boiling hydrocarbons as impurities. Accordingly, a balance has to be made between purity of solvent collected or desired faster kinetics of the process involved.

As shown in FIG. 2, heating in the reactors is preferably done only from the bottom side, thereby having larger heating surface area, for handling sludges wherein segregation can occur. Heating from bottom side can help to boil out water before such segregation can occur and reactors having larger heating surface area help in such cases. In addition, heat treatment from bottom side is necessary as azeotropy works at minimum boiling point and minimum boiling ratio. As shown in FIG. 2, water is continuously recovered but solvent is refluxed back in the reactor 204 and this ratio keeps on decreasing with time and because of that low boiling point of solvent never remains the same. In such case, if heat provided is not from bottom but from sideways then solvent may start boiling without affecting the water left behind in the heating vessel 204. However, if refluxed solvent is introduced in the reactor 204 from the bottom side thereby making sure that heat is given from bottom, then solvent stripping acts a governing mechanism for removing residual water left behind. Hence it is preferable that heat transfer provided along line 206 is from bottom side.

As shown in FIG. 2, preferably impure solvent is not added back for reuse, because it contains low boiling hydrocarbons as impurities. Hence, if it used back as such then these impurities may keep on increasing in every step of process. Therefore, solvent is purified first before using it in its purest form in the process.

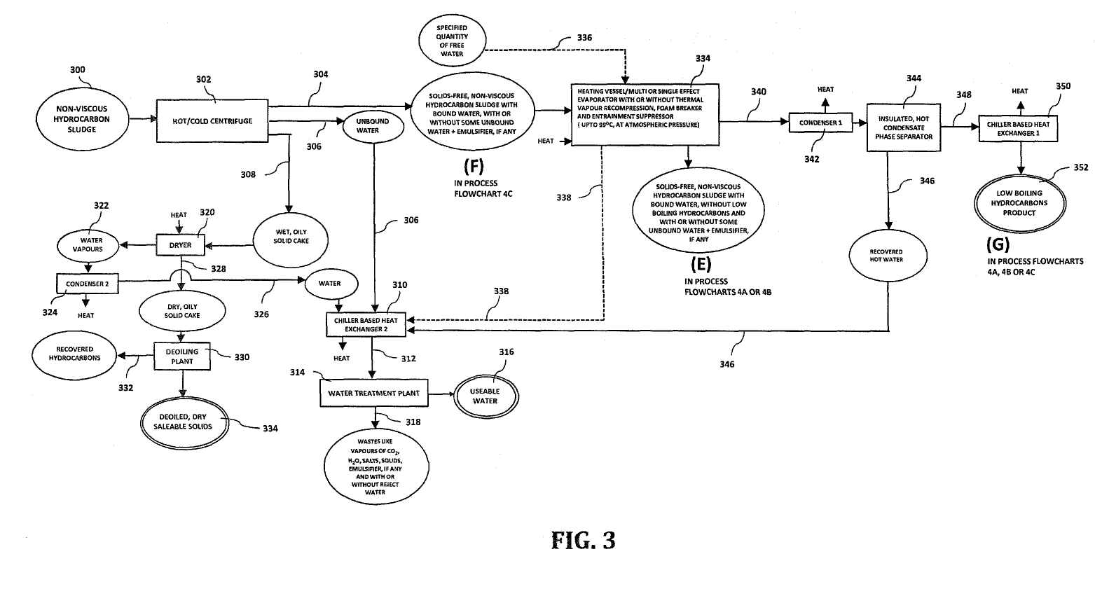

Referring to FIG. 3, a process for pretreatment of sludge mixture having non-viscous hydrocarbons prior to removal of bound water is shown. In the context of the present invention, the sludge mixture is a non-viscous hydrocarbon sludge that acts as a feed stream 300. In an initial step, the feed stream 300 is fed to a hot/cold centrifuge 302 that operates at a predefined temperature. The predefined temperature is maintained at a temperature below 95° C. The hot centrifuge 302 forms a first layer 304, a second layer 306 and a third layer 308. The first layer 304 is obtained as solids-free, non-viscous hydrocarbon sludge with bound water, with or without some unbound water and emulsifier, if any in a range of about 60 wt %. The second layer 306 is unbound water that is fed to a chiller based heat exchanger 310 to recover water in liquid form along line 312. The water recovered along line 312 is sent to a water treatment plant 314 to recover usable water along line 316, thereby removing wastes along line 318 that contains vapors of CO₂, H₂O, salts, solids, emulsifier, if any, and with or without reject water. The third layer 308 is a wet, oily solid cake layer that is fed to a dryer 320. The dryer 320 is supplied with a heat source that evaporates water vapors along line 322 that are subsequently condensed in a condenser 324 to recover water in liquid form along line 326. The water recovered along line 326 is fed to the chiller based heat exchanger 310 for recovery of usable water through the water treatment plant 314 as illustrated. The dryer 320 discharges dry, oily solid cake along line 328 that are fed to a de-oiling plant 330 thereby obtaining recovery of hydrocarbons along line 332 and dried, de-oiled salable solid product stream 334.

In next step, the first layer 304 is processed ahead along line-F as shown or charged to a reactor 334 wherein a specified quantity of free water is added along line 336 only if large quantities of low boiling hydrocarbons are present in the first layer 304. The reactor 334 recovers residual free water with traces of hydrocarbons along line 338. The residual free water obtained along line 338 is sent to the chiller based heat exchanger 310 for recovery of usable water through the water treatment plant 314 as illustrated.

In the context of the present invention, the reactor 334 is a heating vessel or single/multi-effect evaporator with/without thermal vapor recompression, foam breaker and entrainment suppressor. The thermal vapor recompression in the reactor 334 avoids thermal cracking of the product hydrocarbon stream. The foam breaker and entrainment separator in the reactor 334 avoid entrainment of hydrocarbons. The reactor 334 operates at a first predefined pressure. In this one particular embodiment, the first predefined pressure is an atmospheric pressure. The reactor 334 operates at a first predefined temperature. In this one particular embodiment, the first predefined temperature of the reactor 334 is configured to reach a maximum temperature up to 99° C. A heat source is provided to the reactor 334. The heat source is a waste heat source that reduces cost of energy involved in said process. The reactor 334 produces solids-free, non-viscous hydrocarbon sludge in a range of about 70 to 90 wt % that is processed ahead in further process along line-E as shown. The non-viscous hydrocarbon sludge obtained along line-E contains bound water without low boiling hydrocarbons and with or without some unbound water along with emulsifiers present, if any. The reactor 334 evaporates vapors of low boiling hydrocarbons and water along line 340 that are fed to a condenser 342 followed by processing through an insulated, hot condensate phase separator 344. The insulated, hot condensate phase separator 344 recovers hot water along line 346 which is sent to the chiller based heat exchanger 310 for recovery of usable water through the water treatment plant 314 as illustrated. The insulated, hot condensate phase separator 344 produces a hot stream of low boiling hydrocarbon product along line 348 that is passed through a chiller based heat exchanger 350 for obtaining low boiling hydrocarbon product 352. The low boiling hydrocarbon product is process ahead along line-G in a range of about 10 to 30 wt %.

As shown in FIG. 3, the Specified quantity of free water added along line 336 to the reactor 334 only when large quantities of low boiling hydrocarbons are present in hydrocarbon steam along line-F or when water soluble emulsifier is present therein. Also, the time for which heating has to be done in the reactor 334 is more in this case.

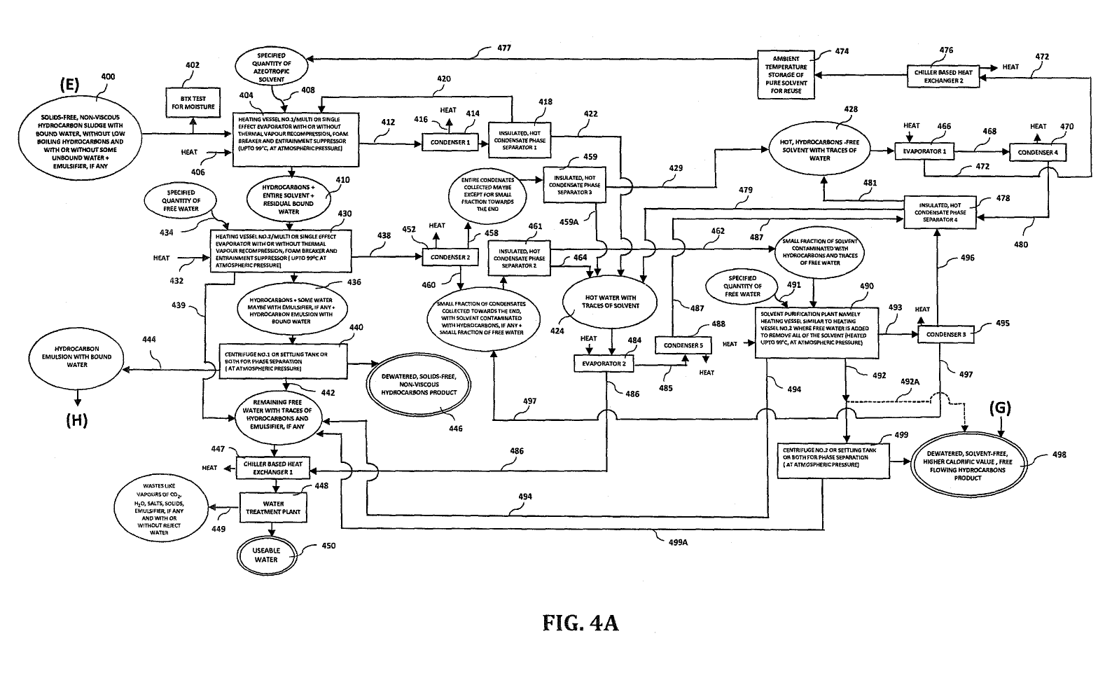

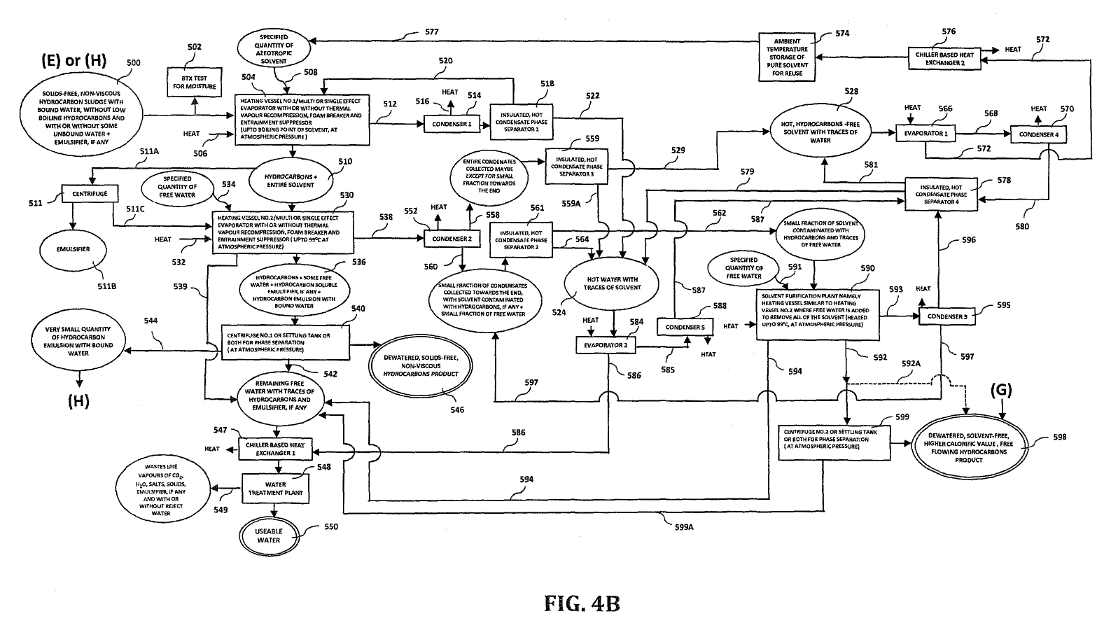

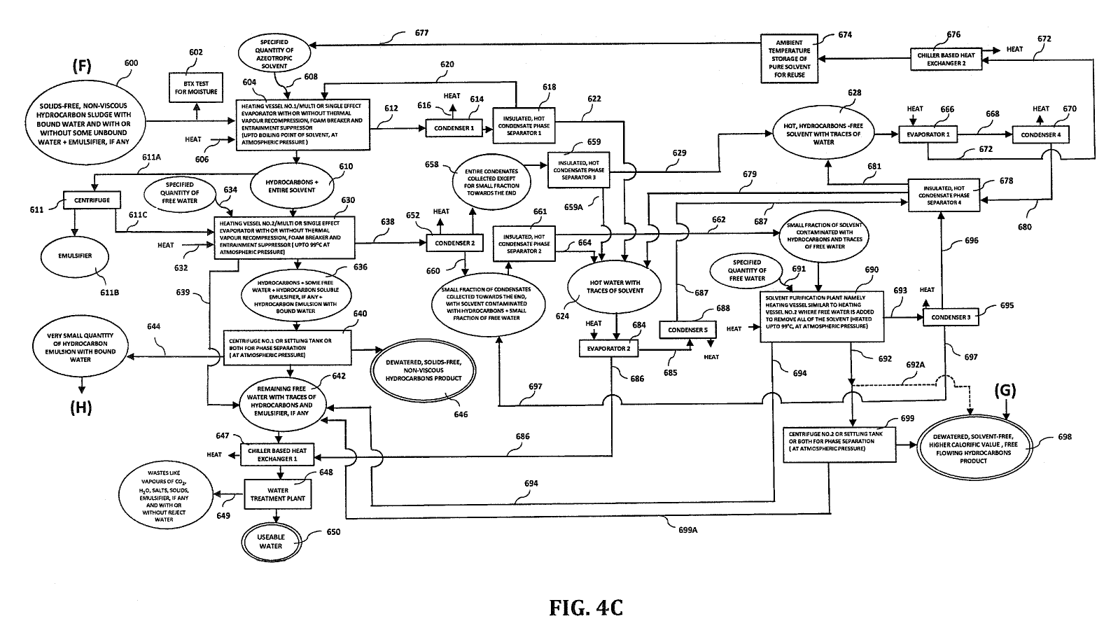

As shown in FIG. 4A, a total reflux based process for treatment of a sludge mixture is disclosed. In the context of the present invention, the sludge mixture is a feed stream 400 that is obtained along line-E. The feed stream 400 is preferably a sludge mixture that contains solids-free, non-viscous hydrocarbon sludge with bound water, without low boiling hydrocarbons and with or without some unbound water and emulsifier, if any. In a first step, the feed stream 400 is subjected to a BTX test 402 for detecting moisture contained in the feed stream 400. In next step, the feed stream 400 is charged to a reactor 404. In the context of the present invention, the reactor 404 is a heating vessel or single/multi-effect evaporator with or without thermal vapor recompression, foam breaker and entrainment suppressor. The thermal vapor recompression in the reactor 404 avoids thermal cracking of the product hydrocarbon stream. The foam breaker and entrainment separator in the reactor 404 avoid entrainment of hydrocarbons. The reactor 404 operates at a predefined pressure. In this one particular embodiment, the predefined pressure is an atmospheric pressure. The reactor 404 operates at a predefined temperature. In this one particular embodiment, the predefined temperature of the reactor 404 is configured to reach a maximum temperature up to 99° C. A heat source 406 facilitates the reactor 404 to achieve the predefined temperature in this one embodiment. The heat source 406 is a waste heat source that reduces cost of energy involved in said process.

In this step, a predefined amount of azeotropic solvent is added to the reactor 404 along line 408. In the context of the present invention, the predefined amount of azeotropic solvent has a critical impact in bringing out the bound water at least temperature from the hydrocarbon stream. The azeotropic solvent is selected from the group of Benzene, Toluene, Xylene and mixtures thereof. In case of Xylene being used as solvent, preferably, ratio of weight of water present to Xylene is maintained at 1:3. In case of Toluene being used as solvent, preferably, ratio of weight of water present to Toluene is maintained at 1:3 or 1:4 In case of Benzene being used as solvent, preferably, ratio of weight of water present to Benzene is maintained at 1:3. Alternatively, solvent is added with respect to amount of hydrocarbons present. For Xylene, weight ratio of Xylene to hydrocarbons is 1.6:1 to 2:1. For Toluene, weight ratio of Toluene to hydrocarbons is 2:1. For Benzene, weight ratio of Benzene to hydrocarbons is 1:1 to 2:1. From above two criteria for ratio of solvent with water present or hydrocarbons present in reactor 404, the highest of the above two quantities of solvent is selected for addition. The reactor 404 generates a residual phase 410 and a vapor phase 412. The vapor phase 412 is a solvent stream that contains vapors of solvent and most of the bound water. The residual phase 410 is a hydrocarbon stream that contains hydrocarbons with entire solvent and residual bound water.

In next step, the vapor phase 412 is fed to a condenser 414. In the condenser 414, the vapor phase 412 is condensed by removing heat along line 416 and subsequently sent for phase separation in an insulated, hot condensate phase separator 418. In the insulated, hot condensate phase separator 418, a solvent layer is recovered along line 420 and a hot water layer is recovered along line 422. The hot water layer recovered along line 422 is stored in an intermediate hot water storage tank 424.

In this one embodiment, the solvent recovered along line 420 is totally refluxed back to the reactor 404 during said process. Preferably, solvent is refluxed back such that foam breaker arrangement in reactor 404 remains at high temperature. It is necessary here that refluxing solvent does not interfere with the foam breaker. In the context of this embodiment, removal of both bound and unbound water is enabled such that the boiling point of bound water is depressed thereby applying heat and reaching a temperature up to 99° C.

In next step, the first residual phase 410 is directly sent to a reactor 430. The reactor 430 is a heating vessel or single/multi-effect evaporator with/without thermal vapor recompression, foam breaker and entrainment suppressor. The thermal vapor recompression in the reactor 430 avoids thermal cracking of the product hydrocarbon stream. The foam breaker and entrainment separator in the reactor 430 avoid entrainment of hydrocarbons. The reactor 430 operates at a predefined pressure. In this one particular embodiment, the predefined pressure is an atmospheric pressure. The reactor 430 operates at a predefined temperature. In this one particular embodiment, the predefined temperature of the reactor 430 is designed to reach maximum up to 99° C. A heat source 432 facilitates the reactor 430 to achieve the predefined temperature in this one embodiment. The heat source 432 is preferably a waste heat source which reduces cost of energy in said process.

In this step, a predefined amount of free water is added to the third reactor 430 along line 434. It is understood here that addition of predefined amount of free water 434 has a critical impact in recovering solvent at least temperature from the hydrocarbon stream. Accordingly, the predefined amount of free water 434 is added in a predefined ratio with respect to weight of solvent present in the reactor 430. Preferably, weight ratio of free water to solvent is added at 1:1 for Toluene, 2:1 for Xylene and 1:1 for Benzene. The reactor 430 generates a residual phase 436 and a vapor phase 438. The vapor phase 438 contains vapors of entire solvent, part of bound water if any and part of free water may be with hydrocarbon contamination obtained towards end. The residual phase 436 contains hydrocarbon with some water may be with emulsifiers present, if any and hydrocarbon emulsion with bound water. The reactor 430 removes remaining free water with traces of hydrocarbons along line 439.

In next step, the residual phase 436 is fed to a centrifuge 400 or a settling tank or a combination of both. The centrifuge 440 operates at a predefined pressure. The predefined pressure of the hot centrifuge 440 is atmospheric pressure. The centrifuge 440 facilitates phase separation thereby forming three layers namely a first layer 442, a second layer 444 and a third layer 446. The first layer 442 contains remaining free water with traces of hydrocarbons and emulsifier, if any. The second layer 444 contains substantial quantity of hydrocarbon emulsion with bound water in a range of about 10 Wt % to 50 Wt % that is processed ahead in further process along line-H. The third layer 446 is obtained as de-watered, solids-free, salts-free non-viscous hydrocarbon product in a range of about 30 to 50 wt %. The first layer 442 is passed through the chiller based heat exchanger 447 followed by treatment thereof through a water treatment plant 448 for obtaining usable water product 450 in a range of about 70 to 90 wt % thereby separating wastes along line 449 such as vapors of CO₂, H₂O, salts, solids, emulsifier, if any, and with or without reject water.

In next step, the vapor phase 438 is fed to a condenser 452. In the condenser 452, the vapor phase 438 is condensed, wherein a first layer is recovered along line 458 and a second layer is recovered along line 460. The first layer 458 preferably contains entire condensates collected may be except for small fractions towards the end. The second layer 460 preferably contains small fractions of condensates collected towards the end with solvent contaminated with hydrocarbons, if any, along with small fractions of free water. The first layer 458 is passed through insulated, hot condensate phase separator 459 for removal of hot water along line 459A and subsequently fed to a hot solvent storage tank 428 along line 429. The second layer 460 is fed to an insulated, hot condensate phase separator 461 thereby recovering a solvent layer 462 and a water layer 464 respectively. The solvent layer 462 preferably contains small fractions of solvent contaminated with hydrocarbons and traces of free water. The water layer 464 preferably contains hot water with traces of solvent. The water layer 464 is added to the intermediate hot water storage tank 424 as shown.

In next step, the hot solvent stored in the intermediate hot solvent storage tank 428 is sent to an evaporator 466. The evaporator 466 is supplied with a heat source that facilitates heating to the first evaporator 466 for achieving a predefined temperature. Preferably, the evaporator 466 operates at a temperature range of about 100° C. in this one preferred embodiment. The heat source provides controlled heating such that predefined temperature of the first evaporator 466 is prohibited from reaching up to the boiling point of solvent. The heat source is a waste heat source which reduces cost of energy in said process. The evaporator 466 recovers vapors of solvent and water along line 468 which are fed to a condenser 470. The evaporator 466 recovers a bulk amount of solvent without water in liquid form that is let out to the chiller based heat exchanger 476 in a range of about 99 wt % and subsequently stored in a pure solvent storage tank 474 at an ambient temperature after being passed through a chiller based heat exchanger 476. The pure solvent is optionally recycled in said process along line 477 for being mixed with the solvent stream 408, if needed. The condenser 470 provides condensates of solvent along with water that are fed to an insulated, hot condensate phase separator 478 along line 480. The insulated, hot condensate phase separator 478 removes hot water with traces of solvent which are added to the intermediate hot water storage tank 424 along line 479. The insulated, hot condensate phase separator 478 removes hot hydrocarbons-free solvent with traces of water which are added to the intermediate hot solvent storage tank 428 along line 481.

In next step, the hot water in the intermediate hot water storage tank 424 is added to an evaporator 484 wherein a predefined amount of heat is supplied for forming a vapor phase 485 and a liquid phase 486. The vapor phase 485 contains vapors of solvent along with water. The liquid phase 486 contains bulk water without any solvent. The liquid phase 486 is fed to the chiller based heat exchanger 447 for being treated through the water treatment plant 448 to recover usable water as illustrated. The vapor phase 485 is sent to a condenser 488 wherein vapors of solvent are condensed to obtain condensates along line 487. The condensates obtained along line 487 contain condensates of solvent along with water which is fed to the insulated, hot condensate phase separator 478 as illustrated.

In next step, the solvent layer 462 containing small fraction of solvent contaminated with hydrocarbons and traces of free water is added to a solvent purification plant 490 wherein a predefined amount of free water is added along line 491. The solvent purification plant 490 is a heating vessel that is identical to the reactor 430 wherein free water is added to remove all the remaining solvent. The solvent purification plant 490 operates at a predefined pressure. In this one particular embodiment, the predefined pressure is an atmospheric pressure. The solvent purification plant 490 operates at a predefined temperature. In this one particular embodiment, the predefined temperature of the solvent purification plant 490 is designed to reach to a maximum temperature up to 99° C. A heat source is applied to the solvent purification plant 490 to achieve the predefined temperature in this one embodiment. The heat source is preferably a waste heat source which reduces cost of energy in said process. In this step, the predefined amount of free water added along line 491 has a critical impact in bringing out all the solvent. The predefined amount of free water 491 is added in a predefined ratio with respect to weight of solvent present in the solvent purification plant 490. Preferably, weight ratio of free water to solvent is added at 1:1 for Toluene, 2:1 for Xylene and 1:1 for Benzene. The solvent purification plant 490 generates a residual phase 492, a vapor phase 493 and a free water phase 494. The free water phase 494 is mixed with the first layer 442 for being treated through the water treatment plant 448 in order to obtain usable water as shown. The vapor phase 493 contains vapors that are condensed in a condenser 495 such that entire condensates are collected along line 496 except for small fraction towards the end with small fraction of free water. The condenser 495 also provides small fractions of condensates along line 497 collected at the end with solvent contaminated with hydrocarbons and having small fractions of the free water therein. The condensates along line 497 are added to the second layer 460 as illustrated. The residual phase 492 is stored as dewatered, solvent-free, free flowing hydrocarbon product 498 along line 492A, if free water is not present therein. Alternatively, the residual phase 492 is charged to a centrifuge 499 if it contains free water. The centrifuge 499 or a settling tank or a combination of both removes remaining free water with traces of hydrocarbons along line 499A that is mixed with the first layer 442 as illustrated. The centrifuge 499 operates at a predefined pressure. The predefined pressure of the centrifuge 499 is atmospheric pressure. In this step, low boiling hydrocarbons product obtained along line-G is added to the free flowing hydrocarbon product 498.

As shown in FIG. 4A, the process is preferably recommended for solvents having boiling points distinctly lower than 99° C. For example, Benzene having boiling point of about 80° C. may be used for the process in FIG. 4A. Also, there would not be any formation of hydrocarbon emulsion with Bound water obtained along line-H, when Benzene is used as a solvent. Therefore, use of benzene as solvent is generally preferred when formation of layer of hydrocarbon emulsion with bound water is not desirable. However, the kinetics of the reaction slows down in such case. In general, strong and large quantities of hydrocarbon emulsion with Bound Water are formed along line 444 when any other solvent is used in the process shown in FIG. 4A.

In the context of FIG. 4A, centrifuge works because of difference in density and difference in particle size distribution wherein main deciding factor is always the difference is density. Accordingly, the centrifuge 440 is used after reactor 430 separates hydrocarbons along line 446, hydrocarbon emulsion with bound water along line 444 and remaining free water with traces of hydrocarbons and emulsifiers if any along line 442 because centrifuge works efficiently when distributed particles are present. This ensures the starting materials along lines-E or F to have uniform particles and no distributed particles cannot be separated into separate components by use of Centrifuge at that point in said process.

Referring to FIG. 4B, a total reflux based process for treatment of a sludge mixture is disclosed. In the context of the present invention, the sludge mixture is a feed stream 500 that is obtained either along line-E or line-H. The feed stream 500 is preferably a sludge mixture that contains solids-free, non-viscous hydrocarbon sludge with bound water, without low boiling hydrocarbons and with or without some unbound water and emulsifier, if any. In a first step, the feed stream 500 is subjected to a BTX test 502 for detecting moisture contained in the feed stream 500. In next step, the feed stream 500 is charged to a reactor 504. In the context of the present invention, the reactor 504 is a heating vessel or single/multi-effect evaporator with or without thermal vapor recompression, foam breaker and entrainment suppressor. The thermal vapor recompression in the reactor 504 avoids thermal cracking of the product hydrocarbon stream. The foam breaker and entrainment separator in the reactor 504 avoid entrainment of hydrocarbons. The reactor 504 operates at a predefined pressure. In this one particular embodiment, the predefined pressure is an atmospheric pressure. The reactor 504 operates at a predefined temperature. In this one particular embodiment, the predefined temperature of the reactor 504 is configured to reach a maximum temperature up to boiling point of a solvent being added to the reactor 504. A heat source 506 facilitates the reactor 504 to achieve the predefined temperature in this one embodiment. The heat source 506 is a waste heat source that reduces cost of energy involved in said process.

In this step, a predefined amount of azeotropic solvent is added to the reactor 504 along line 508. In the context of the present invention, the predefined amount of azeotropic solvent has a critical impact in bringing out the bound water at least temperature from the hydrocarbon stream. The azeotropic solvent is selected from the group of Benzene, Toluene, Xylene and mixtures thereof. In case of Xylene being used as solvent, preferably, ratio of weight of water present to Xylene is maintained at 1:3. In case of Toluene being used as solvent, preferably, ratio of weight of water present to Toluene is maintained at 1:3 or 1:4 In case of Benzene being used as solvent, preferably, ratio of weight of water present to Benzene is maintained at 1:3. Alternatively, solvent is added with respect to amount of hydrocarbons present. For Xylene, weight ratio of Xylene to hydrocarbons is 1.6:1 to 2:1. For Toluene, weight ratio of Toluene to hydrocarbons is 2:1. For Benzene, weight ratio of Benzene to hydrocarbons is 1:1 to 2:1. From above two criteria for ratio of solvent with water present or hydrocarbons present in reactor 504, the highest of the above two quantities of solvent is selected for addition. The reactor 504 generates a residual phase 510 and a vapor phase 512. The vapor phase 512 is a solvent stream that contains vapors of solvent and entire bound water. The residual phase 510 is a hydrocarbon stream that contains hydrocarbons with entire solvent.

In next step, the vapor phase 512 is fed to a condenser 514. In the condenser 514, the vapor phase 512 is condensed by removing heat along line 516 and subsequently sent for phase separation in an insulated, hot condensate phase separator 518. In the insulated, hot condensate phase separator 518, a solvent layer is recovered along line 520 and a hot water layer is recovered along line 522. The hot water layer recovered along line 522 is stored in an intermediate hot water storage tank 524.

In this one embodiment, the solvent recovered along line 520 is totally refluxed back to the reactor 504 during said process. Preferably, solvent is refluxed back such that foam breaker arrangement in reactor 504 remains at high temperature. It is necessary here that refluxing solvent does not interfere with the foam breaker. It is understood here that, total reflux of the recovered solvent along line 520 is continued up to boiling point of solvent added to the reactor 504. In the context of this embodiment, removal of both bound and unbound water is enabled such that the boiling point of bound water is depressed thereby applying heat and reaching a temperature up to boiling point of the solvent.

In next step, the first residual phase 510 is either directly sent to a reactor 530 if it is free from water soluble emulsifiers. Alternatively, the first residual phase 510 is sent to a centrifuge 511 along line 511A if it contains water soluble emulsifiers. Accordingly, the centrifuge 511 removes emulsifiers along line 511B thereby charging water soluble emulsifier-free first residual phase 510 to the reactor 530 along line 511C. The reactor 530 is a heating vessel or single/multi-effect evaporator with/without thermal vapor recompression, foam breaker and entrainment suppressor. The thermal vapor recompression in the reactor 530 avoids thermal cracking of the product hydrocarbon stream. The foam breaker and entrainment separator in the reactor 530 avoid entrainment of hydrocarbons. The reactor 530 operates at a predefined pressure. In this one particular embodiment, the predefined pressure is an atmospheric pressure. The reactor 530 operates at a predefined temperature. In this one particular embodiment, the predefined temperature of the reactor 530 is designed to reach maximum up to 99° C. A heat source 532 facilitates the reactor 530 to achieve the predefined temperature in this one embodiment. The heat source 532 is preferably a waste heat source which reduces cost of energy in said process.

In this step, a predefined amount of free water is added to the third reactor 530 along line 534. It is understood here that addition of predefined amount of free water 534 has a critical impact in bringing out water at least temperature from the hydrocarbon stream. Accordingly, the predefined amount of free water 534 is added in a predefined ratio with respect to weight of solvent present in the reactor 530. Preferably, weight ratio of free water to solvent is added at 1:1 for Toluene, 2:1 for Xylene and 1:1 for Benzene. The reactor 530 generates a residual phase 536 and a vapor phase 538. The vapor phase 538 contains vapors of entire solvent and part of free water may be with hydrocarbon contamination towards the end. The residual phase 536 contains hydrocarbon with some free water, hydrocarbon soluble emulsifier, if any, and hydrocarbon emulsion with bound water. The reactor 530 removes remaining free water with traces of hydrocarbons along line 539.

In next step, the residual phase 536 is fed to a centrifuge 540 or a settling tank or a combination of both. The centrifuge 540 operates at a predefined pressure. The predefined pressure of the hot centrifuge 540 is atmospheric pressure. The centrifuge 540 facilitates phase separation and adequate reduction in viscosity of hydrocarbons, thereby forming three layers namely a first layer 542, a second layer 544 and a third layer 546. The first layer 542 contains remaining free water with traces of hydrocarbons and emulsifier, if any. The second layer 544 contains very small quantity of hydrocarbon emulsion with bound water in a range of about 1 to 5 Wt %. that is processed ahead in the process along line-H. The third layer 546 is obtained as de-watered, solids-free, non-viscous hydrocarbon product in a range of about 95 to 99 wt %. The first layer 542 is passed through the chiller based heat exchanger 547 followed by treatment thereof through a water treatment plant 548 for obtaining usable water product 550 in a range of about 95 to 99 wt % thereby separating wastes along line 549 such as vapors of CO₂, H₂O, salts, solids, emulsifier, if any, and with or without reject water.

In next step, the vapor phase 538 is fed to a condenser 552. In the condenser 552, the vapor phase 538 is condensed, wherein a first layer is recovered along line 558 and a second layer is recovered along line 560. The first layer 558 preferably contains entire condensates collected may be except for small fractions towards the end. The second layer 560 preferably contains small fractions of condensates collected towards the end with solvent contaminated with hydrocarbons, if any, along with small fractions of free water. The first layer 558 is passed through insulated, hot condensate phase separator 559 for removal of traces of hot water with solvent along line 559A and hot hydrocarbons-free solvent with traces of water along line 529. The second layer 560 is fed to an insulated, hot condensate phase separator 561 thereby recovering a solvent layer 562 and a water layer 564 respectively. The solvent layer 562 preferably contains small fractions of solvent contaminated with hydrocarbons and traces of free water. The water layer 564 preferably contains hot water with traces of solvent. The water layer 564 is added to the intermediate hot water storage tank 524 as shown.

In next step, the hot solvent stored in the intermediate hot solvent storage tank 528 is sent to an evaporator 566. The evaporator 566 is supplied with a heat source that facilitates heating to the first evaporator 566 for achieving a predefined temperature essential to boil out solvent without water. Preferably, the evaporator 566 operates at a temperature range of about 100 to 140° C. in this one preferred embodiment. The heat source provides controlled heating such that predefined temperature of the first evaporator 566 is prohibited from reaching up to the boiling point of solvent. The heat source is a waste heat source which reduces cost of energy in said process. The evaporator 566 recovers vapors of solvent and water along line 568 which are fed to a condenser 570. The evaporator 566 recovers a bulk amount of solvent without water in liquid form that is let out to the chiller based heat exchanger 576 in a range of about 99 wt % and subsequently stored in a pure solvent storage tank 574 at an ambient temperature after being passed through a chiller based heat exchanger 576. The pure solvent is optionally recycled in said process along line 577 for being mixed with the solvent stream 508, if needed. The condenser 570 provides condensates of solvent along with water that are fed to an insulated, hot condensate phase separator 578 along line 580. The insulated, hot condensate phase separator 578 removes hot water with traces of water which are added to the intermediate hot water storage tank 524 along line 579. The insulated, hot condensate phase separator 578 removes hot hydrocarbons-free solvent with traces of water which are added to the intermediate hot solvent storage tank 528 along line 581.

In next step, the hot water in the intermediate hot water storage tank 524 is added to an evaporator 584 wherein a predefined amount of heat is supplied for forming a vapor phase 585 and a liquid phase 586. The vapor phase 585 contains vapors of solvent along with water. The liquid phase 586 contains bulk water without any solvent. The liquid phase 586 is fed to the chiller based heat exchanger 547 for being treated through the water treatment plant 548 to recover usable water as illustrated. The vapor phase 585 is sent to a condenser 588 wherein vapors of solvent and water are condensed to obtain condensates along line 587. The condensates obtained along line 587 contain condensates of solvent along with water which are fed to the insulated, hot condensate phase separator 578 as illustrated.

In next step, the solvent layer 562 containing small fraction of solvent contaminated with hydrocarbons and traces of free water is added to a solvent purification plant 590 wherein a predefined amount of free water is added along line 591. The solvent purification plant 590 is a heating vessel that is identical to the reactor 530 wherein free water is added to remove all the remaining solvent. The solvent purification plant 590 operates at a predefined pressure. In this one particular embodiment, the predefined pressure is an atmospheric pressure. The solvent purification plant 590 operates at a predefined temperature. In this one particular embodiment, the predefined temperature of the solvent purification plant 590 is designed to reach to a maximum temperature up to 99° C. A heat source is applied to the solvent purification plant 590 to achieve the predefined temperature in this one embodiment. The heat source is preferably a waste heat source which reduces cost of energy in said process. In this step, the predefined amount of free water added along line 591 has a critical impact in bringing out all the solvent. The predefined amount of free water 591 is added in a predefined ratio with respect to weight of solvent present in the solvent purification plant 590. Preferably, weight ratio of free water to solvent is added at 1:1 for Toluene, 2:1 for Xylene and 1:1 for Benzene. The solvent purification plant 590 generates a residual phase 592, a vapor phase 593 and a free water phase 594. The free water phase 594 is mixed with the first layer 542 for being treated through the water treatment plant 548 in order to obtain usable water as shown. The vapor phase 593 contains vapors that are condensed in a condenser 595 such that entire condensates are collected along line 596 except for small fraction towards the end with small fraction of free water. The condenser 595 also provides small fractions of condensates along line 597 collected at the end with solvent contaminated with hydrocarbons and having small fractions of the free water therein. The condensates along line 597 are added to the second layer 560 as illustrated. The residual phase 592 is stored as dewatered, solvent-free, free flowing hydrocarbon product 598 along line 592A, if free water is not present therein. Alternatively, the residual phase 592 is charged to a centrifuge 599 if it contains free water. The centrifuge 599, a settling tank, or a combination of both removes remaining free water with traces of hydrocarbons along line 599A that is mixed with the first layer 542 as illustrated. The centrifuge 599 operates at a predefined pressure. The predefined pressure of the centrifuge 599 is atmospheric pressure. In this step, low boiling hydrocarbons product obtained along line-G is added to the free flowing hydrocarbon product 598.

As shown in FIG. 4B, the process is preferably recommended for solvents having medium boiling points. In particular, the process is preferred for solvents having boiling point lower than any hydrocarbons present in sludge because less quantities of low boiling hydrocarbons may contaminate the last part of recovered solvent. However, if high boiling point solvent is used in said process then both first and last certain fraction of collected solvent will have large contamination. For example, when Xylene is used solvent collection starts impure. In the case of high boiling point solvent, generally contamination is throughout the recovery of solvent. In said process, quantity of hydrocarbon emulsion with Bound water may be more if high boiling point solvent is used as it leaves behind more residual water. Similarly, in said process, last fraction of collected solvent observes large contamination for low boiling point solvent.

Referring to FIG. 4C, a total reflux based process for treatment of a sludge mixture is disclosed. In the context this embodiment, the sludge mixture is a feed stream 600 that is obtained either along line-F. The feed stream 600 is preferably a sludge mixture that contains solids-free, non-viscous hydrocarbon sludge with bound water, and with or without some unbound water and emulsifier, if any. In a first step, the feed stream 600 is subjected to a BTX test 602 for detecting moisture contained in the feed stream 600. In next step, the feed stream 600 is charged to a reactor 604. In the context of the present invention, the reactor 604 is a heating vessel or single/multi-effect evaporator with or without thermal vapor recompression, foam breaker and entrainment suppressor. The thermal vapor recompression in the reactor 604 avoids thermal cracking of the product hydrocarbon stream. The foam breaker and entrainment separator in the reactor 604 avoid entrainment of hydrocarbons. The reactor 604 operates at a predefined pressure. In this one particular embodiment, the predefined pressure is an atmospheric pressure. The reactor 604 operates at a predefined temperature. In this one particular embodiment, the predefined temperature of the reactor 604 is configured to reach a maximum temperature up to boiling point of a solvent being added to the reactor 604. A heat source 606 facilitates the reactor 604 to achieve the predefined temperature in this one embodiment. The heat source 606 is a waste heat source that reduces cost of energy involved in said process.

In this step, a predefined amount of azeotropic solvent is added to the reactor 604 along line 608. In the context of the present invention, the predefined amount of azeotropic solvent has a critical impact in bringing out the bound water at least temperature from the hydrocarbon stream. The azeotropic solvent is selected from the group of Benzene, Toluene, Xylene and mixtures thereof. In case of Xylene being used as solvent, preferably, ratio of weight of water present to Xylene is maintained at 1:3. In case of Toluene being used as solvent, preferably, ratio of weight of water present to Toluene is maintained at 1:3 or 1:4 In case of Benzene being used as solvent, preferably, ratio of weight of water present to Benzene is maintained at 1:3. Alternatively, solvent is added with respect to amount of hydrocarbons present. For Xylene, weight ratio of Xylene to hydrocarbons is 1.6:1 to 2:1. For Toluene, weight ratio of Toluene to hydrocarbons is 2:1. For Benzene, weight ratio of Benzene to hydrocarbons is 1:1 to 2:1. From above two criteria for ratio of solvent with water present or hydrocarbons present in reactor 604, the highest of the above two quantities of solvent is selected for addition. The reactor 604 generates a residual phase 610 and a vapor phase 612. The vapor phase 612 is a solvent stream that contains vapors of solvent and entire bound water. The residual phase 610 is a hydrocarbon stream that contains hydrocarbons with entire solvent.

In next step, the vapor phase 612 is fed to a condenser 614. In the condenser 614, the vapor phase 612 is condensed by removing heat along line 616 and subsequently sent for phase separation in an insulated, hot condensate phase separator 618. In the insulated, hot condensate phase separator 618, a solvent layer is recovered along line 620 and a hot water layer is recovered along line 622. The hot water layer recovered along line 622 is stored in an intermediate hot water storage tank 624.

In this one embodiment, the solvent recovered along line 620 is totally refluxed back to the reactor 604 during said process. Preferably, solvent is refluxed back such that foam breaker arrangement in reactor 604 remains at high temperature. It is necessary here that refluxing solvent does not interfere with the foam breaker. It is understood here that, total reflux of the recovered solvent along line 620 is continued up to boiling point of solvent added to the reactor 604. In the context of this embodiment, removal of entire bound and unbound water is enabled such that the boiling point of bound water is depressed thereby applying heat and reaching a temperature up to boiling point of the solvent.

In next step, the first residual phase 610 is either directly sent to a reactor 630 if it is free from water soluble emulsifiers. Alternatively, the first residual phase 610 is sent to a centrifuge 611 along line 611A if it contains water soluble emulsifiers. Accordingly, the centrifuge 611 removes emulsifiers along line 611B thereby charging water soluble emulsifier-free first residual phase 610 to the reactor 630 along line 611C.

The reactor 630 is a heating vessel or single/multi-effect evaporator with/without thermal vapor recompression, foam breaker and entrainment suppressor. The thermal vapor recompression in the reactor 630 avoids thermal cracking of the product hydrocarbon stream. The foam breaker and entrainment separator in the reactor 630 avoid entrainment of hydrocarbons. The reactor 630 operates at a predefined pressure. In this one particular embodiment, the predefined pressure is an atmospheric pressure. The reactor 630 operates at a predefined temperature. In this one particular embodiment, the predefined temperature of the reactor 630 is designed to reach maximum up to 99° C. A heat source 632 facilitates the reactor 630 to achieve the predefined temperature in this one embodiment. The heat source 632 is preferably a waste heat source which reduces cost of energy in said process.

In this step, a predefined amount of free water is added to the third reactor 630 along line 634. It is understood here that addition of predefined amount of free water 634 has a critical impact in recovering solvent at least temperature from the hydrocarbon stream. Accordingly, the predefined amount of free water 634 is added in a predefined ratio with respect to weight of solvent present in the reactor 630. Preferably, weight ratio of free water to solvent is added at 1:1 for Toluene, 2:1 for Xylene and 1:1 for Benzene. The reactor 630 generates a residual phase 636 and a vapor phase 638. The vapor phase 638 contains vapors of entire solvent and part of free water with hydrocarbon contamination towards the end. The residual phase 636 contains hydrocarbon with some free water, hydrocarbon soluble emulsifier, if any, and hydrocarbon emulsion with bound water. The reactor 630 removes remaining free water with traces of hydrocarbons along line 639.

In next step, the residual phase 636 is fed to a centrifuge 640 or a settling tank or a combination of both. The centrifuge 640 operates at a predefined pressure. The predefined pressure of the centrifuge 640 is atmospheric pressure. The centrifuge 640 facilitates phase separation and adequate reduction in viscosity of hydrocarbons, thereby forming three layers namely a first layer 642, a second layer 644 and a third layer 646. The first layer 642 contains remaining free water with traces of hydrocarbons and emulsifier, if any. The second layer 644 contains very small quantity of hydrocarbon emulsion with bound water in a range of about 1 to 5 wt % that is processed ahead in the process along line-H. The third layer 646 is obtained as de-watered, solids-free, non-viscous hydrocarbon product in a range of about 95 to 99 wt %. The first layer 642 is passed through the chiller based heat exchanger 647 followed by treatment thereof through a water treatment plant 648 for obtaining usable water product 650 in a range of about 95 to 99wt % thereby separating wastes along line 649 such as vapors of CO₂, H₂O, salts, solids, emulsifier, if any, and with or without reject water.

In next step, the vapor phase 638 is fed to a condenser 652. In the condenser 652, the vapor phase 638 is condensed, wherein a first layer is recovered along line 658 and a second layer is recovered along line 660. The first layer 658 preferably contains entire condensates collected except for small fractions towards the end. The second layer 660 preferably contains small fractions of condensates collected towards the end with solvent contaminated with hydrocarbons along with small fractions of free water. The first layer 658 is passed through insulated, hot condensate phase separator 659 for removal of hot water with traces of solvent along line 659A and hot hydrocarbons-free solvent with traces of water along line 629. The second layer 660 is fed to an insulated, hot condensate phase separator 661 thereby recovering a solvent layer 662 and a water layer 664 respectively. The solvent layer 662 preferably contains small fractions of solvent contaminated with hydrocarbons and traces of free water. The water layer 664 preferably contains hot water with traces of solvent. The water layer 664 is added to the intermediate hot water storage tank 624 as shown.

In next step, the hot solvent stored in the intermediate hot solvent storage tank 628 is sent to an evaporator 666. The evaporator 666 is supplied with a heat source that facilitates heating to the first evaporator 666 for achieving a predefined temperature essential to boil out solvent without water. Preferably, the evaporator 666 operates at a temperature range of about 100° C. in this one preferred embodiment. The heat source provides controlled heating such that predefined temperature of the first evaporator 666 is prohibited from reaching up to the boiling point of solvent. The heat source is a waste heat source which reduces cost of energy in said process. The evaporator 666 recovers vapors of solvent and water along line 668 which are fed to a condenser 670. The evaporator 666 recovers a bulk amount of solvent without water in liquid form that is let out to the chiller based heat exchanger 676 in a range of about 99 wt % and subsequently stored in a pure solvent storage tank 674 at an ambient temperature after being passed through a chiller based heat exchanger 676. The pure solvent is optionally recycled in said process along line 677 for being mixed with the solvent stream 608, if needed. The condenser 670 provides condensates of solvent along with water that are fed to an insulated, hot condensate phase separator 678 along line 680. The insulated, hot condensate phase separator 678 removes hot water with traces of water which are added to the intermediate hot water storage tank 624 along line 679. The insulated, hot condensate phase separator 678 removes hot hydrocarbons-free solvent with traces of water which are added to the intermediate hot solvent storage tank 628 along line 681.

In next step, the hot water in the intermediate hot water storage tank 624 is added to an evaporator 684 wherein a predefined amount of heat is supplied for forming a vapor phase 685 and a liquid phase 686. The vapor phase 685 contains vapors of solvent along with water. The liquid phase 686 contains bulk water without any solvent. The liquid phase 686 is fed to the chiller based heat exchanger 647 for being treated through the water treatment plant 648 to recover usable water as illustrated. The vapor phase 685 is sent to a condenser 688 wherein vapors of solvent are condensed to obtain condensates along line 687. The condensates obtained along line 687 contain condensates of solvent along with water which are fed to the insulated, hot condensate phase separator 678 as illustrated.

In next step, the solvent layer 662 containing small fraction of solvent contaminated with hydrocarbons and traces of free water is added to a solvent purification plant 690 wherein a predefined amount of free water is added along line 691. The solvent purification plant 690 is a heating vessel that is identical to the reactor 630 wherein free water is added to remove all the remaining solvent. The solvent purification plant 690 operates at a predefined pressure. In this one particular embodiment, the predefined pressure is an atmospheric pressure. The solvent purification plant 690 operates at a predefined temperature. In this one particular embodiment, the predefined temperature of the solvent purification plant 690 is designed to reach to a maximum temperature up to 99° C. A heat source is applied to the solvent purification plant 690 to achieve the predefined temperature in this one embodiment. The heat source is preferably a waste heat source which reduces cost of energy in said process. In this step, the predefined amount of free water added along line 691 has a critical impact in bringing out all the solvent. The predefined amount of free water 691 is added in a predefined ratio with respect to weight of solvent present in the solvent purification plant 690. Preferably, weight ratio of free water to solvent is added at 1:1 for Toluene, 2:1 for Xylene and 1:1 for Benzene. The solvent purification plant 690 generates a residual phase 692, a vapor phase 693 and a free water phase 694. The free water phase 694 is mixed with the first layer 642 for being treated through the water treatment plant 648 in order to obtain usable water as shown. The vapor phase 693 contains vapors that are condensed in a condenser 695 such that entire condensates are collected along line 696 except for small fraction towards the end with small fraction of free water. The condenser 695 also provides small fractions of condensates along line 697 collected at the end with solvent contaminated with hydrocarbons and having small fractions of the free water therein. The condensates along line 697 are added to the second layer 660 as illustrated. The residual phase 692 is stored as dewatered, solvent-free, free flowing hydrocarbon product 698 along line 692A, if free water is not present therein. Alternatively, the residual phase 692 is charged to a centrifuge 699 if it contains free water. The centrifuge 699 or a settling tank or a combination of both removes remaining free water with traces of hydrocarbons along line 699A that is mixed with the first layer 642 as illustrated. The centrifuge 699 operates at a predefined pressure. The predefined pressure of the centrifuge 499 is atmospheric pressure. In this step, low boiling hydrocarbons product obtained along line-G is added to the free flowing hydrocarbon product 698 in a range of about 5 to 15 wt %.

Referring to FIGS. 4A-4C, in general, quantity of residual water is a very important factor in the formation of hydrocarbon emulsion with water. Preferably, quantity of emulsion depends on quantity of residual water entrapped in hydrocarbons and also on the concentration of water soluble emulsifiers. Preferably, quality of emulsion increases with increase in residual water quantity as well as increase in concentration of water soluble emulsifier and such emulsion is more viscous as compared to individual components forming such emulsion.

In the context of the present invention, the process of pretreatment provides the sludge mixture as an emulsion after removal of entire solids from the viscous fraction thereof. In the context of the present invention, addition of solvent to only the viscous part of the hydrocarbons recovered after said process of pre-treatment provides a super emulsion. In the context of the present invention, addition of solvent to the viscous/non-viscous portions obtained after pre-treatment followed by reflux till boiling point of solvent provides hydrocarbons in its purest form. In the context of the present invention, addition of solvent only to the viscous portion obtained after pre-treatment followed by heating said mixture below the boiling point of the solvent provides a stronger emulsion with least water without any hydrocarbons present therein. In the context of the present invention, wherein addition of solvent only to the non-viscous portion of the sludge mixture with emulsifiers followed by heating below the boiling point of the solvent provides hydrocarbons along with strong emulsion during said process. In the context of the present invention, addition of solvent in non-viscous sludge followed by boiling with solvent slightly below the boiling point of the solvent provides a weak emulsion capable of being broken during the pre-treatment thereby producing pure hydrocarbons at lower temperature without any thermal damage thereto. In the context of the present invention, the process recovers, strongly held, solids and salt free but not necessarily emulsifier free, water in hydrocarbon emulsions, with hydrocarbon being the continuous phase, with water weight percent in emulsion varying from about 50 to 80 wt. %, as value added, marketable product.

In the context of the present invention, the process advantageously treats the sludge mixture with determined quantity of water present wherein said sludge mixture is first pre-treated for removal of unbound water, salts, solids, water soluble emulsifiers, free flowing and often even viscous pure hydrocarbons and thereafter segregates remaining sludge by viscosity using hot/cold centrifuge, vibratory flow-tables, settling tanks with or without aeration and the like. In next step, different fractions are then further treated separately for removal of both bound and unbound water, preferably bound water alone due to economic reasons, either entirely or partially, by selectively depressing its boiling point alone through the use of water immiscible solvents and then boil it out by applying heat while raising the temperature of the materials up to a specific level depending on the desired objective wherein the process is controlled either by final raised temperature of the system or by the amount of water collected or both, in a manner where said process starts with specific quantity of solvent added to hydrocarbons often at pre-treatment stage while refluxing said solvent back continuously during the process up to a specific temperature. In next step, the free water is added and solvent is boiled out through application of heat thereby finally removing excess free water left behind by either separation through gravity settling or centrifuge in hot condition or through boiling or any other mechanism/equipment that allows for reasonably rapid separation of residual water from hydrocarbons, with the aim to recover original hydrocarbons in marketable form with highest possible commercial value, as well as recover bound and unbound water present in sludge along with free water added for subsequent environmentally safe, useful applications after treating the water for such uses and reuse the recovered solvent again after removing entrained and soluble water from therein and also after further purifying part of it to remove dissolved hydrocarbons in subsequent process for further removal of bound water of incoming sludge.

In the context of the present invention, the process of pre-treatment of sludge includes prior removal of salt at the source where oil is produced or near the oil well. It is understood here that removal of soluble salts helps transporting less saline hydrocarbons thereby preventing corrosion, fouling of equipment and avoiding the needless repetition of desalting at refinery and thereby saving on capital requiring less freshwater and ensuring that salt free crude can be kept into downstream equipment with ensuing benefits. In addition, removal of salt can also result in removal of a fraction of water soluble emulsifiers present in sludge, if any. The process of pre-treatment of present invention focuses on first removal of unbound water by known means and subjecting the viscous part alone that contains bound water to our process. The known processes may include hot/cold centrifuge, filtration, flow tables and the like to segregate the sludge by way of its density/viscosity and remove all free and unbound water therein along with as much as insoluble solid content. In accordance with the present invention segregation based on density/viscosity difference is essential, because sludges with different viscosities behave differently while boiling hence subjected to different variation of our process. In addition, removal of solids also enhances the commercial value of hydrocarbons recovered. Further, removal of solids prevents fouling of heat transfer surfaces. Moreover, removal of solvent before boiling reduces loss of hydrocarbons due to oily sludge and reduces cost of de-oiling solids. It is understood here that characteristics changes with density/viscosity, denser the material more is bound water content.

In the present process, hot solvent is added to viscous fraction of sludge to reduce its viscosity as well as increase density difference between hydrocarbon and water/solids beneficial for further removal of solids and free water by gravity settling preferably via centrifuge while maintaining high temperature of sludge. It is understood here that the solvent is added not only to depress the boiling point of water through heterogeneous low boiling azeotrope but also to enhance density difference, reduce viscosity and ease transportation of water vapour and liquid droplets through reduced viscosity liquid pool.

In the present process, quantum of sludge processed is reduced by removing free water/solids and free flowing hydrocarbons by means of known processes reduce cost and time requirements for downstream processes. In addition, it also reduces solvent required to treat a given amount of raw sludge and corresponding free water required to remove said solvent from recovered hydrocarbons. Moreover, it also reduces heat required to remove said bound water, solvent and free water as well as it also increases the overall plant productivity.

In the view of the present invention, refluxing allows for using a smaller initial quantum of solvent for a given weight of sludge with a given water content and thereby reduce the quantum and cost of solvent required for the process. For a given solvent it does not require more heat or higher reactor volume. In addition, use of reflux improves productivity from the same evaporator containing same quantity of sludge by improving kinetics through reduction of viscosity leads to more temperature homogenization and turbulence. This in turn, allows convective currents intimate contact between solvent and bound water. This is more apparent when the solvent uses has higher boiling point than the pure water. In addition, the use of solvent maintains almost constant viscosity for given process and it is more amenable to add excess solvent for getting lower average viscosity. There is no depletion of solvent hence decrease in viscosity occurs towards the fag end of the process. In addition, during refluxing of the solvent in said process, the heating rate does not matter because the ratio of residual weight of solvent to residual weight of water can never go down below the critical point and only thing can happen is more heat could be consumed because weight of water removed per unit weight of solvent could fall but the controlling the rate of heating is a boon. In addition, refluxing of avoids explosive discharge of vapours thereby reducing the risk factor. However, it is understood here that the temperature required to drive out entire bound water can never ever increase beyond the boiling point of solvent. Moreover, refluxing solvent can break foam formed during azeotropic boiling thereby acting as a foam breaker. In addition, flushing is not required in said process due to use of solvent which dramatically improves kinetics. It is understood here that the present process allows addition of lesser quantity of solvent which doesn't allow huge decrease in viscosity in initial stages hence water doesn't separate negatively effecting azeotropic boiling. In the context of the present invention, the solvent is azeotrope of water like Benzene, Toluene, Xylene and the like or mixtures thereof. The solvent may include any water immiscible hydrocarbon since that also depresses the boiling point of water, such as Hexane, Heptanes or low boiling petroleum products or fractions thereof. In the context of the present invention, the solvent is added to the sludge in a ratio that is 1.6-8.0 times to the weight of water/hydrocarbons present in the sludge. In the present process, the temperature of the mixture is in the range of 70° C.-140° C. at atmospheric pressure which depends on quantity and nature of solvent.

Preferably, the solvent selected in the present process is based on the nature of hydrocarbon present in the sludge and the maximum allowable temperature of the mixture so as to avoid adverse impact on hydrocarbons due to high temperature. In addition it provides ease of storing, less evaporation costs and safety of process. In the context of the present invention, the amount of specific solvent added depends on nature of solvent. It is preferably added in a given ratio with respect to water or another given ratio with respect to hydrocarbon whichever is higher. Sludge with low initial water content require more solvent the optimum solvent to water ratio to remove entire solvent without exceeding boiling point of solvent. Lower mole fraction of solvent elevates solvent boiling point according to Raoult's law. For example, the sludge with less than 10% water requires at least 2 times weight of solvent with respect to hydrocarbons.

In the context of the present invention, the entire bound water from the sludge can be removed approximately around the boiling point of solvent used, irrespective of the nature and quantity of the water content in the sludge. It works on all kinds of sludges irrespective of the nature of sludge, water-hydrocarbon in sludge, composition of hydrocarbons or solvent used, to drive out entire water one has to go to boiling point of solvent. For examply, with xylene being used as a solvent, the residual moisture is brought down to about 9% by boiling point of water, for toluene it is about half of that value.

In the context of the present invention, while using low boiling solvents energy and time required is more but hydrocarbons are subjected to a lower temperature. Energy requirement is not an issue as it is low grade energy but productivity is an issue. Benzene here is a health hazard, but other low boiling hydrocarbon solvents like hexane or petroleum products like petrol or diesel can be used. Productivity of reactor of a given size can be increased by increasing the heat transfer area or by increasing temperature difference between systems and heating media. Condenser duty can be more but that can be negated by using multi effect evaporator. There is no direct correlation between area of heat transfer and size of reactor i.e. within a given size of the reactor you can increase the heat transfer area by putting extra heat transfer plates. This is possible where the quantity of solvent is not high and in this context reflux is better than non-reflux. Reflux is useful when you compare unit water removal using low boiling solvent as it require less energy.

In particular, use of reflux with low boiling solvents helps in making the plant substantially compact and reduces the energy required for fluid flow but it limits the maximum heat supply through its initial stages. Use of benzene does not necessarily mean poor kinetics but it only means more heat consumption. Here it is understood here that the weight of water removal per unit weight of solvent boiled is low because at lower operating temperature vapour pressure contribution from boiling water is less therefore when using benzene the heat supply has to be jacked up and to a large extent that will be met by increased ΔT across heat transfer surface when using the same source of heat. But here one must take care of excess foaming and explosive discharge of vapours through the use of mechanical foam breaker, inverted droplet collectors and cyclones. Use of reflux with any solvent we can make the plant compact at the cost of putting an upper limit on the heat supply rate. Reducing reactor volume will limit heating surface area available to sludge to some extent.

It is understood here that lack of water at the end of process prevents boiling of both water and solvent, especially in case of Xylene. Small size of droplets suppresses vapour pressure of water, thus the combined vapour pressure of solvent and water is lower than ambient pressure, creating a range of temperature where nothing is collected. Multi effect evaporator or sudden blast of heat may be needed to collect last fraction of water. To improve kinetics solvent has to be supplied to bottom of reactor and high heat flux should be provided to reach boiling point as fast as possible. In the present process, heat from vapour of condensate may be used for further boiling through any evaporator, ME, or MVR. Heat may be dissipated from the final condenser into large water bodies.

The present process is immensely amenable for ME as vapours are generated at different temperature during different stages of our process, also vapour generated during our process is at saturation temperature hence condenses at the same temperature as vapour generation. This allows for more efficient heat transfer between consecutive effects in ME without use of vacuum or addition of steam. Preferably, the temperature range when using Xylene as a solvent is in a range of about 97° C. to 143° C. with a gap where no water comes out. In case of toluene temperature range is from 87° C. to 110° C., with continuous vapour generation. Hence, it is possible to use ME without any reduction in system pressure. In the context of the present invention, one may preferably use waste heat available in flue gases in co-generation with gas turbine based power plant or any other industrial operation.

In the context of the present invention, after removing bound water, one must remove the solvent present through addition of free water and application of heat and thereafter one must recover back the free water by gravity settling. From low and medium viscosity hydrocarbons, it is relatively easy to remove free water from hydrocarbons through combination of heat, hot/cold centrifuge or settling tank. For high viscosity hydrocarbons, final free water is removed by boiling the water out in a thin film evaporator with cascading trays or by spraying hot hydrocarbons into an evaporation chamber at temperature above boiling point of water or by passing fine bubbles of inert flue gas/air depending on flash point of hydrocarbons or hot cyclone or agitator with or without baffles.

In the context of the present invention, while using high boiling solvents, higher temperature can be avoided by terminating the process at lower temperature when the maximum fraction of water got removed then adding free water to remove solvent and then subsequent separation of oil from free water by gravity separation. This has more effect in case of Xylene. It could be used in case of emulsifier based sludges, where recovery of entire or partial fraction of hydrocarbons is required in emulsion form. Emulsion thus formed is tightly bound, in case of Xylene, but in case of toluene most of the hydrocarbon content in sludge is recovered in its pure state.

In the context of the present invention, heat may be recovered from hot dewatered oil without leading to excessive rise in viscosity. Dewatered oil should be discharged off at the temperature below flash point. In the present invention, initial portion of condenser has to be small in volume to ensure that most of the solvent stays in the reactor or is collected out. In the present invention, traces of hydrocarbons present in distilled water can be removed by bio-degradation. In accordance with the present invention, solvent from sludge by adding free water in excess ensure that water present in enough to recover entire solvent from hydrocarbons. The ratio in which water is added is determined by azeotropic ratio of solvent and water.

In the context of the present invention, the boiling point of azeotrope increases with decrease in droplet size, however finer droplets are more dispersed so more water can be removed at a lower temperature. More dispersed the droplets are more contact area between solvent and bound water and water is less likely to separate. Both of these factors help in maintaining collection at azeotropic ratio for a larger fraction of water collected.

In accordance with the present invention, the sludge containing emulsifiers may be re-emulsified with free water during solvent removal stage. In which case, that part of sludge can be recycled back to the reactor with the next batch. It is understood here that formation of emulsion at the interface of water and hydrocarbons is unavoidable, as surfactant will be present at the interface reducing interfacial tension and promoting emulsification. It is a small fraction of total amount of hydrocarbons present.

In the context of the present invention, steam could be sent to strip out solvent from hydrocarbons; preventing re-emulsification of hydrocarbons with free water. The thermal or mechanical foam breakers may be used in the present invention to mitigate foaming during reflux or solvent recovery step. Thermal foam breaker is favoured when emulsifiers are present. Temperature of thermal foam breaker must be high. Finer foam formed due to emulsifier cannot be broken by mechanical foam breakers. In case of partial reflux, thermal foam breaker has to be followed by temperature conditioner to mitigate the problem of light hydrocarbons contaminating solvent. If temperature conditioner is not present solvent collected has higher fraction of hydrocarbons contaminating the solvent condensate.

In accordance with the present invention, part of solvent that is not refluxed back into the reactor, rather removed from the condenser and sent for purification. More amount of solvent is required at the beginning of the process due high water content, however as water is depleting, more solvent is not required and hence can be removed. Partial removal of solvent can continue as long as solvent to hydrocarbon ratio does not diminish below a predefined ratio for a given solvent-hydrocarbon system. This is to maintain final temperature of system close to boiling point of solvent. Ensure that partial solvent removal ends before we reach fag end of the process as more solvent is required at the bottom heating surface to promote solvent stripping.

In accordance with present invention, the solvent reflux can be terminated once sludge temperature reaches about 90° C., followed by boiling of sludge without refluxing back solvent till sludge temperature reaches 100° C. Bound water removal is terminated at 100° C. and solvent is removed by free water addition. This process works for low viscosity hydrocarbon sludge where water soluble emulsifier is present. Strength of emulsion depends on the amount of water remaining after bound water removal stage. If water content is more than a threshold value, emulsion is weak with low water content, but if water remaining after bound water removal is less, emulsion is tightly bound and has high water content. This depends on the concentration of emulsifier present; concentration is more when bound water remaining is less and concentration less when bound water removed is more.

In accordance of the present invention, the solvent recovered from hydrocarbons may be contaminated with light hydrocarbons present in sludge. Contamination is only towards the end of solvent recovery process, small fraction of total solvent recovered has high contamination. Except in case of high boiling solvents where contamination is more in the beginning as well as the end of solvent recovery. The solvent recovered from sludge may be purified by steam stripping solvent or by fractional distillation or by both.

In accordance with the present invention, the light hydrocarbons may be removed from sludge preferably by boiling before solvent addition to reduce the contamination of solvent recovered from such sludge. Boiling may be carried out with or without free water addition. In the process of the present invention, part of hydrocarbons with relatively higher residual water content after gravity separation, may be boiled such that thickness of liquid layer is very small, preferably under vacuum. This works for medium viscosity hydrocarbons.

In accordance with the present invention, the solvent refluxed enters heating vessel preferably at the lowest part of the vessel preferably with heating element present at the bottom. This will ensure presence of solvent throughout the bulk of sludge and remove water more effectively. This will enhance kinetics wherein solvent stripping begins from the bottom of the vessel, scavenging remainder of bound water throughout the bulk of sludge. In the present invention the average boiling point could be higher for finer water droplet but azeotropy is better due to better distribution of water droplets.

In accordance with the present invention, when water is being removed from sludge by appropriate combination of azeotropy, steam stripping and solvent stripping mechanisms. Here azeotropy is modified by solvent being soluble in hydrocarbon by altering its boiling point across a large range, and also fine droplets present in sludge will have slight increase in its boiling point as well. To remove water using solvent, solvent has to be in excess; hence as water depletes azeotropic ratio and azeotropic temperature cannot be maintained.

In the context of the present invention, the low viscosity light oil sludges are boiled with or without free water with view to remove low boiling hydrocarbons present therein. These low boiling hydrocarbons boil out at temperature significantly lower than their original boiling point and being less viscous with higher calorific value on account of higher hydrogen to carbon ratio, their commercial value is high. Hence, apart from aiding recovery of purer solvents, this also helps raising the commercial value of recovered hydrocarbons.

In accordance with the present invention, during solvent removal, when the solvent present is very small, the ratio of water to solvent collect goes up dramatically on account of rapidly rising boiling point of solvent. This is observed in viscous sludge where high boiling hydrocarbons are present. This rise is arrested to some extent by presence of even small quantities low boiling hydrocarbons therein thereby aiding its efficient and quick removal. In case of strong sludges, the segregation of water is due reduced viscosity and increased density difference on account of solvent present does not occur. This allows for holding of azeotropic ratio and temperature to a larger extent even with negative aspects of a strong sludge is still present.

In accordance with the present invention, addition of the hot solvent to sludge before centrifuge is preferred to produce furnace oil sludge with high water content wherein the solvent leaches out fraction of hydrocarbons from furnace oil sludge without any segregation of water present in sludge.

In the context of the present invention, the amount of solvent to be added during reflux depends on nature of solvent, nature of hydrocarbons and position at which the reflux stream enters to the reactor. In the context of the present invention, the solvent is preferably added in a ratio of 3-4 times the weight of water or 1-2 times the weight of hydrocarbons such that the solvent added is more than or equal to both the ratios thereof. The free water is preferably added during solvent recovery step that is 1-2.5 times the weight of residual solvent present in the hydrocarbons.

The process of pretreatment of the present invention forms the sludge mixture as a saleable product emulsion after removal of entire solids from the viscous fraction thereof. The process of the present invention facilitates removal of salt and a fraction of water soluble emulsifiers present in the sludge mixture. In the process of the present invention, viscous/non-viscous portions obtained after pretreatment followed by addition of the solvent and reflux till boiling point of the solvent forms hydrocarbons in saleable form. In said process, the hydro carbons are formed along with weak emulsion that is further treated in case of non-viscous sludge. The process of the present invention recovers strongly held solids-free, salts-free but not necessarily emulsifier-free water in hydrocarbon emulsions as value added marketable product with water content varying in a range of about 50 Wt. % to 80 Wt. % by addition of hot solvent and centrifuge. In the context of the present invention, the predefined temperature in said process is in a range of 70° C. to 140° C. In the context of the present invention, the residual water content for all the solvents is less than 10 Wt. % of the original water present therein.

In the context of the present invention, said process removes entire bound water from the sludge mixture approximately around a boiling point of the solvent irrespective of the nature and quantity of the water content of the sludge mixture. In the context of the present invention, said process improves productivity of the heating vessel or reactor either by increasing heat transfer area or by increasing temperature difference between heating medium and system. In the context of the present invention, said heating vessel or reactor optionally includes extra heat transfer plates to have an increased heat transfer area. In the context of the present invention, the heat from vapour of condensate is used for further boiling through an evaporator, or a multiple effect evaporator or a mechanical vapour re-compressor such that heat is dissipated from the final condenser into large water bodies. In the context of the present invention, said process uses waste heat available in flue gases during co-generation with gas turbine based power plant or any other industrial operation. In the context of the present invention, said process treats high viscosity hydrocarbons such that final free water is removed by boiling the water out by one or more of the following processes such as a thin film evaporator with cascading trays, hot spraying of hydrocarbons into an evaporation chamber at a temperature above the boiling point of water, passing fine bubbles of inert flue gas/air or a hot cyclone or agitator with or without baffles.

In the context of the present invention, said process avoids higher temperature when using high boiling solvents thereby terminating said process at a lower temperature when the maximum fraction of water is removed followed by addition of free water to remove solvent and subsequent separation of hydrocarbons from free water by gravity separation. In the context of the present invention, said process is preferred when low viscosity hydrocarbons are present in the sludge mixture. In the context of the present invention, said process recovers heat from hot dewatered hydrocarbons without leading to excessive rise in viscosity such that the dewatered hydrocarbons are discharged at a temperature below flash point thereof. In the context of the present invention, said process utilizes a condenser that has a smaller volume in order to ensure that most of the solvent stays in the reactor during said process.

In the context of the present invention, said process removes traces of hydrocarbons present in recovered water by bio-degradation. In the context of the present invention, said process removes solvent from the sludge mixture by adding free water in an excess amount that is determined by azeotropic ratio of solvent and water by ensuring that water added is sufficient enough to recover entire solvent from hydrocarbons. In the context of the present invention, the boiling point of azeotrope increases with decrease in droplet size in said process however finer droplets are more dispersed such that water can be removed at a lower temperature. In the context of the present invention, the sludge mixture containing emulsifiers re-emulsify with free water during solvent removal stage. In the context of the present invention, said process facilitates steam stripping to strip out solvent from hydrocarbons thereby preventing re-emulsification of hydrocarbons with free water.

In the context of the present invention, said process utilizes thermal or mechanical foam breakers to mitigate foaming during reflux or solvent recovery step of said process. In the context of the present invention, the thermal foam breakers are preferred when emulsifiers are present in the sludge mixture. The thermal foam breakers are followed by temperature conditioner in case of partial refluxing of the solvent in order to mitigate the problem of light hydrocarbons contaminating solvent condensate. In the context of the present invention, said process recovers light hydrocarbons by having boiling before solvent addition during said process in order to reduce contamination of the recovered solvent from the sludge such that said boiling is with or without free water addition. In the context of the present invention, said process facilitates at least a portion of hydrocarbons or a portion of medium viscosity hydrocarbons with relatively higher residual water content to be boiled preferably under vacuum thereby having a thickness of a liquid layer to be substantially small during said boiling.

In the context of the present invention, said process utilizes an appropriate combination of various mechanisms such as azeotropy, steam stripping and solvent stripping in order to effectively remove water from the sludge mixture. In the context of the present invention, wherein said azeotropy is modified by solvent being contaminated by hydrocarbons thereby altering boiling point thereof across a large range and fine water droplets present in sludge have slight increase in boiling point thereof. In the context of the present invention, said process facilitates boiling of non-viscous or low viscous hydrocarbon sludge with or without free water with view to remove low boiling hydrocarbons present therein. The low boiling hydrocarbons boil out at a temperature significantly below than their original boiling point and with higher calorific value on account of higher hydrogen to carbon ratio thereby having a high commercial value. In the context of the present invention, a ratio of water to recovered solvent increases on account of rapidly rising boiling point of solvent in case where solvent present is in a smaller amount during solvent recovery step of said process. In the context of the present invention, the viscous sludge having high boiling hydrocarbons observe rapid rise in the boiling point of the solvent such that said rise in boiling point is arrested to some extent by presence of low boiling hydrocarbons thereby aiding efficient and quick removal thereof. In the context of the present invention, the strong sludges hold azeotropic ratio and azeotropic temperature for a larger fraction of water removal without having segregation of water due reduced viscosity and increased density difference on account of solvent present in said process.

In the context of the present invention, segregation of sludge during the pretreatment step is facilitated by the separation equipments such as a cold centrifuge, a hot centrifuge, a vibratory flow-table, a settling tank with or without aeration and the like. In the context of the present invention, segregation of sludge during the pretreatment step is facilitated by the separation equipments such as a cold centrifuge, a hot centrifuge, a vibratory flow-table, a settling tank with or without aeration and the like. In the context of the present invention, segregation of sludge during the pretreatment step is facilitated by the separation equipments such as a cold centrifuge, a hot centrifuge, a vibratory flow-table, a settling tank with or without aeration and the like. In the context of the present invention, said process of pretreatment removes salts from said process thereby allowing carrying saline-free hydrocarbons in a downstream of said process thereby preventing corrosion and fouling of equipments used in the downstream of said process. In the context of the present invention, said process of pretreatment removes salts and solids from said process thereby aiding removal of emulsifiers present in the sludge mixture. The removal of solids during pretreatment enhances commercial value of the recovered hydrocarbons and prevents fouling of heat transfer surfaces. The removal of solids during pretreatment and before boiling reduces loss of hydrocarbons due to oily sludge and reduction in the cost of de-oiling of solids. In the context of the present invention, said process of pretreatment removes most of the unbound water thereby subjects only the viscous part of the sludge containing bound water in the downstream of said process. In the context of the present invention, said process of pretreatment reduces quantum of the sludge mixture which effectively reduces solvent required to treat the sludge mixture and further reduces quantity of free water required to remove said solvent from recovered hydrocarbons thereby reducing heat required to remove bound water, solvent and free water for increasing productivity of said process.

In accordance with the present invention, addition of solvent to the viscous portion obtained after pretreatment followed by heating said mixture below boiling point of the solvent forms a stronger emulsion with low water content present therein. In accordance with the present invention, addition of solvent to the non-viscous portion of the sludge mixture containing emulsifiers followed by heating thereof below the boiling point of the solvent forms saleable hydrocarbons and strong emulsion product. In accordance with the present invention, addition of solvent in the non-viscous sludge followed by boiling with solvent slightly below the boiling point of the solvent forms a weak emulsion that is broken during the pretreatment step for producing pure hydrocarbons at a lower temperature and without any thermal damage. In the context of the present invention, the solvent is added in hot a condition to the viscous fraction of hydrocarbon to reduce viscosity and increase density difference between hydrocarbon and water or solids that facilitates removal solids and free water by a gravity settling or a centrifuge while maintaining high temperature of the sludge. In the context of the present invention, the solvent depresses the boiling point of water through heterogeneous low boiling azeotrope, reduces viscosity and enhances density difference thereby facilitating ease of transportation of water vapour and liquid droplets through reduced viscosity liquid pool. In the context of the present invention, refluxing of the solvent facilitates addition of smaller initial quantum of solvent for a given weight of sludge at given water content in order to reduce quantum and cost of overall solvent required in said process. In the context of the present invention, said refluxing of the solvent improves kinetics through reduction of viscosity during boiling step thereby improving productivity of said process. In the context of the present invention, said refluxing of the solvent maintains constant viscosity in said process that is amenable to add excess solvent for obtaining lower average viscosity without depletion of the solvent level. In the context of the present invention, said refluxing of the solvent is such that a ratio of residual weight of solvent to residual weight of water is maintained above a specified point irrespective of a heating rate. In the context of the present invention, said refluxing of the solvent avoids explosive discharge of vapours thereby reducing risk factors in said process. In the context of the present invention, said refluxing of the solvent ensures that a temperature required for driving out entire bound water is below the boiling point of solvent. In the context of the present invention, the solvent is an azeotrope of water selected from the group of Benzene, Toluene, Xylene, Hexane, Heptane, or mixtures thereof and the like. In the context of the present invention, the predefined amount of solvent is in a ratio of 1.6 to 8.0 times the weight of water/hydrocarbons present in the feed stream. In the context of the present invention, the predefined amount of solvent is selected based on the nature of hydrocarbons present in the sludge and maximum allowable temperature of the sludge mixture in order to prevent thermal cracking. In the context of the present invention, the solvent is added in a ratio of 3-4 times the weight of water or 1-2 times the weight of hydrocarbons such that the solvent added is more than or equal to both the ratios thereof. In the context of the present invention, the free water added during solvent recovery step is 1-2.5 times the weight of residual solvent present in the hydrocarbons. In the context of the present invention, said refluxing of the solvent is preferred with low boiling solvents in order to complete said process at a temperature substantially lower than boiling point of water. In the context of the present invention, said refluxing of the low boiling solvent is carried out with co-generation or in a multi-effect evaporator as it requires less energy.

In the context of the present invention, a part of solvent is removed from the condenser without being refluxed. In the context of the present invention, partial removal of solvent is continued till solvent to hydrocarbon ratio does not diminish below a predefined solvent-hydrocarbon ratio in said process. In the context of the present invention, said refluxing of solvent is terminated when the sludge temperature reaches up to 90° C. followed by boiling of the sludge without solvent reflux till the sludge temperature reaches up to 100° C. In the context of the present invention, the solvent recovered from hydrocarbons is contaminated with light hydrocarbons towards the end of the solvent recovery step of said process. In the context of the present invention, the solvent recovered from the sludge mixture is purified by process selected from steam stripping or fractional distillation or both. In the context of the present invention, the solvent being refluxed in the reactor or heating vessel enters at a lowest part of said vessel preferably with heating element present at the bottom thereof in order to ensure presence of solvent throughout the bulk of sludge mixture for effective water removal with enhanced kinetics.

In the context of the present invention, the solvents with varying boiling points are used in said process thereby using a multi-effect evaporator in said process such that different evaporation chambers of said multi-effect evaporator. For example, if Xylene, Toluene and Benzene are being used in said process then Xylene, Toluene and Benzene are respectively added to respective evaporation chambers of the multi effect evaporator such that vapours evolving from a chamber containing Xylene supply heat to a chamber containing Tolune and vapours evolving from the chamber containing Toluene supply heat to a chamber containing Benzene. This saves overall energy cost involved in said process.

### EXAMPLES

The following examples and comparative examples are provided to demonstrate particular embodiments of the present invention. It should be appreciated by those skill in the art that the methods disclosed in the examples and comparative examples that follow merely represent exemplary embodiments of the present invention. Those of skill in the art should, in light of the present disclosure, appreciate that many changes can be made in the specific embodiments described and still obtain a like or similar result without departing from the spirit and scope of the present invention.

### Example 1

### Pre-Treatment of Lagoon Sludges with Centrifuge

Experiments were conducted to determine the extent of bound water present in lagoon sludges procured from ONGC, Oil and Natural Gas Corporation. Consequently, the unbound water in sludge was removed thus reducing the quantum of sludge making it easier to further treat the sludge. Also, removal of the unbound water left only the uniformly distributed bound water in the sludge which gave uniform behaviour in further treatment of sludge. The sludge was homogenized and evaluated for moisture content using BTX process, for Calorific Value using Bomb calorimeter, and for Ash content using Muffle Furnace. Further, the sludge was centrifuged in a Heavy Duty Non-Refrigerated Batch Type Centrifuge operated for a residence time of 10 minutes at 4500 RCF.

Consequently, after centrifuge, the ONGC sludge was separated into 3 or 4 fractions namely Free flowing Hydrocarbons as top fraction, medium viscous hydrocarbons as the middle portion and slop oil as bottom portion. A viscous hydrocarbon layer was also separated as a bottom fraction in ONGC Lagoon Sludge#2. All these fractions were evaluated for moisture content, ash content, sediment content and the separated water was evaluated for turbidity. Consequently, ONGC lagoon Sludge#2 fractions were further treated in centrifuge at 4500 RCF and 21893 RCF and the residual Hydrocarbon was evaluated for moisture content.

TABLE 1.1A
CENTRIFUGING DETAILS

| | | TEST 1 | TEST 2 | TEST 3 |
|---|---|---|---|---|
| SI. | | Lagoon | | Lagoon |
| No. | PARTICULARS | Sludge 1 | | Sludge 2 |
| 1 | Wt. of Sludge taken for treatment (g) | 700.91 | 2,115.91 | 701.77 |
| 2 | Wt. % Water in above Sludge as determined | 39.97 | 40.95 | 46.23 |
| | by BTX | | | |
| 3 | Wt. % Ash Content in above Hydrocarbons | 3.68 | 3.70 | — |
| 4 | Calorific Value of above Sludge (kcal/kg) | 6,038 | 5,945 | 5,243 |
| 5 | Time taken to Reach Max. Relative | 2.75 | 2.67 | 3.69 |
| | Centrifugal Force (mins.) | | | |
| 6 | Max. Relative Centrifugal Force at which the | 4,500 | 21,893 | 4500 |
| | Centrifuge was operated (RCF) | | | |
| 7 | Holding Time at Max. Relative Centrifugal | 10.00 | 10.00 | 10.00 |
| | Force (mins) | | | |
| 8 | Time taken to come back to zero Relative | 16.65 | 2.17 | 16.70 |
| | Centrifugal Force (mins.) | | | |
| 9 | Total Residence Time inside centrifuge | 29.45 | 14.83 | 30.39 |
| | (mins.) | | | |

TABLE 1.1B
RESULTS OF PRE-TREATMENT OF ONGC SLUDGE IN CENTRIFUGE

| SI. | | | | |
|---|---|---|---|---|
| No. | PARTICULARS | TEST 1 | TEST 2 | TEST 3 |
| 1 | Wt. % Free flowing Hydrocarbons that | 40.99 | 42.60 | 26.72 |
| | separated out from above sludge | | | |
| 2 | Wt. % Water in above Hydrocarbons as | 0.39 | 0.15 | 8.70 |
| | determined by BTX. | | | |
| 3 | Wt. % Ash/Sediment Content in above Sludge | 0.88 | 0.73 | 1.14 |
| 4 | Calorific Value of above Hydrocarbons | 10,633 | 10,681 | 9,808 |
| | (kcal/kg) | | | |
| 5 | Wt. % Medium Viscous Hydrocarbons that | 31.67 | 20.85 | 32.66 |
| | Separated Out from above Sludge | | | |
| 6 | Wt. % Water in above Medium Viscous | 42.21 | 30.26 | 43.54 |
| | Hydrocarbons as determined by BTX. | | | |
| 7 | Calorific Value of Medium Viscous | 5,212 | 6,635 | 5,415 |
| | Hydrocarbons (kcal/kg) | | | |
| 8 | Wt. % Ash/sediment Content in above | 8.61 | 7.23 | 8.83 |
| | Hydrocarbons | | | |
| 9 | Wt. % Slop Oil that Separated Out from above | 26.46 | 35.91 | 15.67 |
| | Sludge | | | |
| 10 | Hydrocarbons Content in Slop Oil (ppm) | 0 | 0 | 0 |
| 11 | Turbidity of Slop Oil (NTU) | 398 | 1132 | 682 |
| 12 | Wt. % Ash Content in above Slop Oil | 2.04 | 5.18 | — |
| 13 | Wt. % Viscous Hydrocarbons that separated | — | — | 23.62 |
| | out from above sludge | | | |
| 14 | Wt. % Water in above Hydrocarbons as | — | — | 59.32 |
| | determined by BTX. | | | |
| 15 | Wt. % Sediment Content in above Sludge | — | — | 16.09 |
| 16 | Calorific Value of above Hydrocarbons | — | — | 3,003 |
| | (kcal/kg) | | | |
| 17 | Wt. % Hydrocarbons + Ash lost through | 0.37 | 0.12 | 1.12 |
| | adhering to various surfaces | | | |
| 18 | Wt. % Water lost through Evaporation and | 0.52 | 0.54 | 0.21 |
| | Wetting of Surfaces | | | |

TABLE 1.1C
TREATMENT OF ONGC LAGOON SLUDGE #2 FRACTIONS
AFTER INITIAL CENTRIFUGE

| | | Free | Medium | |
|---|---|---|---|---|
| | | Flowing | Viscous | Viscous |
| SI. | | Hydro- | Hydro- | Hydro- |
| No. | Particulars | carbons | carbons | carbons |
| 1 | Wt. of Material taken for further treatment (g) | 702.78 | 140.14 | 4070.12 |
| 2 | Wt. % Residual Hydrocarbons separated | 65.63 | — | — |
| | after centrifuging with 4500 RCF | | | |
| 3 | Moisture % of above Residual Hydrocarbons | 5 | — | — |
| 4 | Wt. % Residual Sludge separated after | 32.06 | — | 52.45 |
| | centrifuging with 4500 RCF | | | |
| 5 | Moisture % of above Residual Sludge | 16.02 | — | 37.38 |
| 6 | Calorific Value of above Residual Sludge | — | — | 4233 |
| | (kcal/kg) | | | |
| 7 | Wt. % Sediment Content in above Sludge | — | — | 24.25 |
| 8 | Wt. % Slop Oil separated after centrifuging | — | — | 46.21 |
| | with 4500 RCF | | | |
| 9 | Wt. % Material lost as adhering to surfaces | 2.18 | — | 1.10 |
| 10 | Wt. % Material lost as evaporation losses, etc. | 0.13 | — | 0.23 |
| 11 | Wt. of above Residual | 232.18 | 140.14 | 70.11* |
| | Hydrocarbons/Sludge* for further | | | |
| | centrifuge at 21893 RCF (g) | | | |
| 12 | Wt. % Remaining Hydrocarbons separated | 56.42 | 26.50 | 19.31 |
| | after centrifuging above residual | | | |
| | Hydrocarbons/sludge at 21893 RCF | | | |
| 13 | Moisture % of above Remaining | 0.01 | 0.03 | 1.39 |
| | Hydrocarbons | | | |
| 14 | Calorific Value of above Remaining | 10,787 | 10,762 | 10,380 |
| | Hydrocarbons (kcal/kg) | | | |
| 15 | Wt. % Remaining Sludge separated after | 41.21 | 44.50 | 63.42 |
| | centrifuging above residual Hydrocarbons/ | | | |
| | sludge at 21893 RCF | | | |
| 16 | Wt. % water in above Remaining Sludge | 11.27 | 36.89 | 33.94 |
| 17 | Calorific Value of above Remaining Sludge | 9,394 | 5,977 | 3,437 |
| | (kcal/kg) | | | |
| 18 | Wt. % Sediment Content in above Sludge | 0.57 | 10.33 | 34.03 |
| 19 | Wt. % Slop Oil separated after centrifuging | — | 28.43 | 16.87 |
| | above residual Hydrocarbons/sludge at 21893 | | | |
| | RCF | | | |
| 20 | Wt. % Material lost as adhering to surfaces | 2.32 | 0.54 | 0.3 |
| 21 | Wt. % Material lost as evaporation losses, etc. | 0.05 | 0.06 | 0.1 |

It was observed that pre-treatment with centrifuge had varying results for different ONGC Sludges as seen from Table 1.1 A and 1.1 B. It was observed in Test 1 about 41 wt. % of saleable, free flowing hydrocarbons with calorific value of about 10,633 kcal/kg was obtained. However, for Test 3, the free flowing hydrocarbons separated had high moisture percentage and the further separated to give a 41.21% solids fraction, hence overall only 9.89% free flowing hydrocarbons with calorific value of about 10,787 kcal/kg was obtained.

Further, it was observed that nature of sludge had an effect with the type of fractions separated after centrifuge. For Sludge #2, a fourth medium viscous hydrocarbon fraction was separated above the free water layer. It was observed that this layer had lower saleable value as the moisture content was higher, and calorific value was lower than free flowing hydrocarbons and almost similar to that of ONGC Lagoon Sludge #2.

Besides, it was also observed that the amount of sludge given for further treatment was reduced by about two thirds in its amount. It was also observed that pre-treatment of sludge helped in reducing salt and ash content in hydrocarbons. Further it was confirmed that only centrifuge cannot remove entire water from the sludge. It was observed that the centrifuge enhances acceleration due to gravity by enormously speeding up the naturally occurring separation of two different immiscible liquids due to density difference. However, the centrifuge was helping when the mean free path between tiny droplets of the particular liquid was small followed by consolidating them into much larger droplets, with reduced drag which then helped them to move even faster. It was observed that Lagoon Sludge#2 was more recalcitrant than to Lagoon Sludge#1 for the pre-treatment with centrifuge.

Further, it was observed that separation of free water was possible in spite of the fact that viscous layer of hydrocarbons separated before the water layer and then after the water layer. From Test 1 and Test 2, it was observed that by increasing the RCF, more amount of free water was separated and consequently in the Free flowing Hydrocarbons and Viscous hydrocarbons less moisture content was observed. For ONGC Lagoon sludge #2 fractions, total water in free flowing hydrocarbons was observed to be bound water. It was observed that out of the 43.54% water in medium viscous hydrocarbons, 34.71% was bound water, and remaining 65.29% water was separated as unbound water. In addition, out of the 59.32% water in viscous hydrocarbons, 7.19% was bound water while the remaining 92.81% water was separated as unbound water.

After further pre-treatment of ONGC Lagoon sludge fractions, it was observed that residual free flowing fraction, even though with the high moisture content failed to separate any water, and gave less than half of its weight as saleable free-flowing hydrocarbons. The medium viscous hydrocarbons after centrifuge through 21893 RCF gave merely 26.50% of saleable hydrocarbons, although separated another 28.43% fraction as water. The viscous hydrocarbons which had large amount of water, large quantity of it separated through treatment with centrifuge, although not entire water. Further, it was observed that only fraction of viscous hydrocarbons were recovered as saleable hydrocarbons. It was observed that by increasing the RCF more amount of free water can be separated. Lastly, it was established that constituents of lagoon sludge do not naturally separate out with time even after decades, wherein quantum of bonds broken depends on the operative RCF of centrifuge and residence time of the sludge within the centrifuge.

Combines Effect of Centrifuge & Solvent on Sludges with Bound Water, to Reduce Amount of Sludge to be Treated Further for Bound Water Removal

In order to understand the mechanism and also the impact on the release of bound water from hydrocarbons firstly by reducing viscosity of various sludges by adding solvents, such that the mixture contains 67 wt. % solvents, subsequently centrifuging it for 10 minutes at 4,500 RCF and at an ambient temperature of about 28 to 32° C. was studied. Specifically, solvents like Xylene and Toluene were added to viscous Furnace Oil Sludge prepared in-house with 50 wt. % water. Alternatively, solvents like Xylene and Toluene were added to viscous ONGC sludge with 42.21 wt. % bound water recovered after batch centrifuging in-coming ONGC Lagoon Sludge for 10 minutes at 4,500 RCF such that the mixture contains 67 wt. % solvent and then after stiffing immediately subjected it to non-stop centrifuging at 4,500 RCF for 10 minutes. The process of centrifuging produced two or three distinct layers of liquids. The third layer was obtained only in case of ONGC Sludge containing clear water. The Top-most layer was invariably water free. It was containing bulk of solvent added and also large amounts of hydrocarbons released from sludge. The middle layer, in cases where three layers were obtained, was consisting of hydrocarbons and water. Subsequently, the middle layer was evaluated. On centrifuging it for 10 minutes at 21,893 RCF we got sludge with bound water, albeit much smaller in quantity, a free flowing layer of solvent plus some dissolved hydrocarbons and slightly colored slop oil were obtained. The sludge thus obtained was then evaluated for bound water using BTX.

Furnace Oil Based Sludges with Bound Water

TABLE 1.2A
DESCRIPTION OF FURNACE OIL SLUDGE

| SI. | | | |
|---|---|---|---|
| No. | PARTICULARS | TEST 1 | TEST 2 |
| 1 | Wt. of Sludge taken for Treatment (g) | 234.47 | 233.55 |
| 2 | Wt. % Water in above Sludge as determined by | 49.91 | 49.91 |
| | BTX | | |
| 3 | Name of Solvent Used | Toluene | Xylene |
| 4 | Wt. of Solvent Added (g) | 469.75 | 467.18 |
| 5 | Final Wt. of Sludge with Solvent (g) | 704.22 | 700.73 |

TABLE 1.2B
CENTRIFUGING DETAILS

| SI. | | | |
|---|---|---|---|
| No. | PARTICULARS | TEST 1 | TEST 2 |
| 1 | Time taken to Reach Max. Relative | 2.70 | 2.65 |
| | ( Centrifugal Force mins) | | |
| 2 | Max. Operative Relative Centrifugal | 4,500 | 4,500 |
| | Force (RCF) | | |
| 3 | Holding Time at Max. Relative | 10 | 10 |
| | Centrifugal Force (mins) | | |
| 4 | Time taken to come back to zero Relative | 16.5 | 16.5 |
| | Centrifugal Force (mins) | | |
| 5 | Total Residence Time inside centrifuge | 29.20 | 29.15 |
| | (mins) | | |

TABLE 1.2C
COMBINED EFFECT OF CENTRIFUGE WITH SOLVENT
ON FURNACE OIL SLUDGE

| SI. | | | |
|---|---|---|---|
| No. | PARTICULARS | TEST 1 | TEST 2 |
| 1 | Wt. of Furnace Oil Sludge + Solvent | 702.94 | 699.59 |
| | Mixture taken for Centrifuge (g) | | |
| 2 | Wt. of top Most Layer with Furnace Oil + | 566.16 | 553.03 |
| | Solvent Recovered (g) | | |
| 3 | Wt. % of Top Most Layer | 80.54 | 79.05 |
| 4 | Wt. of Solvent in Top Most Layer (g) | 466.32 | 453.54 |
| 5 | Wt. of Furnace Oil with 0.23 wt. % ash in | 99.42 | 99.50 |
| | Top Most Layer (g) | | |
| 6 | Wt. % Water in Top Most Layer as | 0.06 | 0.00 |
| | determined by BTX | | |
| 7 | Wt. of Middle Layer containing Furnace | 134.60 | 144.68 |
| | Oil + Water + Solvent + Ash, inclusive | | |
| | of material sticking on surfaces or | | |
| | evaporated (g) | | |
| 8 | Wt. % of Middle Layer | 19.15 | 20.68 |
| 9 | Wt. of Sludge with Bound Water + | 94.46 | 104.81 |
| | Solvent + Ash in Middle Layer in (g) | | |
| 10 | Wt. of Solvent + Free Flowing Furnace | 1.25 | 12.92 |
| | Oil + Ash in Middle Layer (g) | | |
| 11 | Wt. of slightly colored Free Water in | 38.89 | 26.95 |
| | Middle Layer with Ash (g) | | |
| 12 | Wt. % of Sludge with Bound Water, | 70.18 | 72.44 |
| | Ash found within the Middle Layer | | |
| 13 | Wt. % Water in above Sludge from | 81.66 | 85.02 |
| | within the Middle Layer as determined | | |
| | by BTX | | |
| 14 | Calorific Value of above Sludge (kcal/kg) | 1,860 | 1,518 |
| 15 | Wt. of Clear Water with Ash & | 0.00 | 0.00 |
| | Emulsifier in Bottom Most layer (g) | | |
| 16 | Wt. % of Bottom Most Layer | 0.00 | 0.00 |
| 17 | W % of Loss of Material | 0.31 | 0.27 |

TABLE 1.3A
DESCRIPTION OF ONGC VISCOUS SLUDGE

| SI. | | | |
|---|---|---|---|
| No. | PARTICULARS | TEST 3 | TEST 4 |
| 1 | Wt. of Sludge taken for Treatment (g) | 212.86 | 233.53 |
| 2 | Wt. % Water in above Sludge as | 42.21 | 42.21 |
| | determined by BTX | | |
| 3 | Calorific Value of above Sludge (kcal/kg) | 5,213 | 5,213 |
| 4 | Name of Solvent Used | Toluene | Xylene |
| 5 | Wt. of Solvent Added (g) | 492.33 | 468.74 |
| 6 | Final Wt. of Sludge with Solvent (g) | 705.19 | 702.27 |

TABLE 1.3B
CENTRIFUGING DETAILS

| SI. | | | |
|---|---|---|---|
| No. | PARTICULARS | TEST 3 | TEST 4 |
| 1 | Time taken to Reach Max. Relative | 2.68 | 2.56 |
| | Centrifugal Force (mins) | | |
| 2 | Max. Operative Relative Centrifugal Force | 4,500 | 4,500 |
| | (RCF) | | |
| 3 | Holding Time at Max. Relative | 10.00 | 10.00 |
| | Centrifugal Force (mins.) | | |
| 4 | Time taken to come back to zero Relative | 16.60 | 16.50 |
| | Centrifugal Force (mins.) | | |
| 5 | Total Residence Time inside the centrifuge | 29.28 | 29.06 |
| | (mins.) | | |

TABLE 1.3C
COMBINED EFFECT OF CENTRIFUGE WITH SOLVENT ON
ONGC SLUDGE

| SI. | | | |
|---|---|---|---|
| No. | PARTICULARS | TEST 3 | TEST 4 |
| 1 | Wt. of Mixture taken for Centrifuge (g) | 705.08 | 702.14 |
| 2 | Wt. of Top Most Layer with Furnace Oil + | 534.30 | 511.47 |
| | Solvent Recovered (g) | | |
| 3 | Wt. % of Top Most Layer | 75.78 | 72.84 |
| 4 | Wt. of Solvent in Top Most Layer (g) | 481.92 | 455.88 |
| 5 | Wt. of ONGC Hydrocarbons in Top Most Layer | 44.17 | 47.52 |
| | (g) | | |
| 6 | Wt. of Ash in Top Most Layer (g) | 8.10 | 7.98 |
| 7 | Wt. % Water in Top Most Layer as determined by | 0.02 | 0.02 |
| | BTX | | |
| 8 | Wt. of Middle Layer containing ONGC | 108.29 | 131.13 |
| | Hydrocarbons + Water + Solvent + Ash, inclusive | | |
| | of material sticking on surfaces or evaporated (g) | | |
| 9 | Wt. % of Middle Layer | 15.36 | 18.68 |
| 10 | Wt. of Sludge with bound water in Middle Layer | 73.58 | 92.90 |
| | in (g) | | |
| 11 | Wt. of Solvent and free Flowing Hydrocarbons | 14.51 | 16.18 |
| | with ash in Middle Layer (g) | | |
| 12 | Wt. of Unbound, slightly colored Water with ash | 20.20 | 22.05 |
| | in Middle Layer (g) | | |
| 13 | Wt. % Sludge in Middle Layer | 67.95 | 70.85 |
| 14 | Wt. % Bound Water in above Sludge in Middle | 12.52 | 22.02 |
| | Layer as determined by BTX | | |
| 15 | Wt. of Bottom Most Layer containing clear water | 60.00 | 56.91 |
| | (g) | | |
| 16 | Wt. % of Bottom Most Layer | 8.51 | 8.11 |
| 17 | TDS of water obtained (PPM) | 32,190 | 36,280 |
| 18 | Wt. % Loss of Material | 0.35 | 0.37 |

It was observed for furnace oil, from table 1.2 C that by treating Sludge with solvent and centrifuge together, about 80% of material was formed as top layer and only 20% as middle layer, with no free water. Further, most of the hydrocarbons of about 85% of initial hydrocarbons present in sludge move into the top layer with solvent added. The BTX results revealed that, there wasn't any water in it. In 20% middle layer, which was further centrifuged, about 29% of slightly coloured free water was separated in case of Toluene. Moreover, the amount of Sludge remained for further treatment was reduced up to about less than half of initial amount of sludge taken.

Further, in case of ONGC Sludge, from table 1.3 C, it was observed that about 75.78%, 72.84% of top layer with Toluene and Xylene were formed respectively. Middle layer was 15.36% for Toluene and 18.68% for Xylene, which was slightly lesser than what was formed in case of furnace oil sludge. About 8% of the bottom layer was obtained for ONGC sludge, while no water was separated for Furnace oil sludge. Finally, the amount of sludge with bound water was about 35% and 40% of initial sludge taken for toluene and Xylene respectively.

In case of ONGC Sludge, Toluene was preferred over Xylene as it reduced mass of sludge with bound water by a factor of 2.89 against with that of 2.51 with Xylene. Similarly, for Furnace oil sludge, sludge was reduced by a factor of 2.48 and 2.30 with Toluene and Xylene respectively. It was also confirmed that water content is far more easily extractable in case of ONGC sludge as compared to furnace oil based sludge. This was also seen by the free water collected at the bottom. Accordingly, it was seen that the solvent reduced the viscosity of hydrocarbons and then centrifuging enhanced the gravity separation due to density differences, combined effects of which reduced the amount of sludge to be treated by about 2.5 times.

### Example-2

### Removal of Bound Water from Furnace Oil Sludges with 50 Wt. % Bound Water in it, by Boiling it with Azeotropic Solvents

In order to study the effect of various solvents in different quantities on removal of water from furnace oil sludges containing 50 Wt. % water, entire water being bound water, predefined proportion of sludge and solvent were taken in an RB flask of a Dean-Stark apparatus. The mixture was heated in heating mantle while the temperature of material was monitored using digital thermometer. The vapors of bound water and solvent were collected in the receiver after condensing them with circulating cold water at 5-6° C. in the insulated condenser. The condensates of water were collected in separating flask using the stop cork at the bottom of the receiver while the condensates of solvent were allowed to reflux back into the RB flask through the receiver. The water was collected until no water condensates were observed and collected water was weighed each time.

TABLE 2.1A
REMOVAL OF BOUND WATER FROM FURNACE OIL SLUDGE BY VARYING
PROPORTIONS OF XYLENE, WHILE REFLUXING XYLENE BACK AT 933 mbar:

| SI. | | | | |
|---|---|---|---|---|
| No. | PARTICULARS | TEST 1 | TEST 2 | TEST 3 |
| 1 | Wt. of Sludge taken in RB flask (g) | 303.99 | 300.42 | 302.88 |
| 2 | Wt. % Water Present in Sludge | 49.8082 | 49.8082 | 49.8082 |
| 3 | Wt. of Furnace Oil Present in Sludge (g) | 152.58 | 150.79 | 152.02 |
| 4 | Wt. of Solvent added in RB flask (g) | 244.20 | 271.89 | 304.34 |
| 5 | Wt. Ratio of Solvent to Water | 1.61 | 1.82 | 2.02 |
| 6 | Observed Boiling Temperature Range (° C.) | 95.71-145.78 | 98.75-142.54 | 97.42-140.88 |
| 7 | Wt. Avg. Rate of Water Collection (g/min) | 1.31 | 1.32 | 1.22 |
| 8 | Residual Water present in left over Solvent cum | 0 | 0 | 66 |
| | Furnace as determined by BTX Test (PPM) | | | |

TABLE 2.1B
REMOVAL OF BOUND WATER FROM FURNACE OIL SLUDGE BY VARYING
PROPORTIONS OF XYLENE, WHILE REFLUXING XYLENE BACK AT 933 mbar:

| SI. | | | | |
|---|---|---|---|---|
| No. | PARTICULARS | TEST 4 | TEST 5 | TEST 6 |
| 1 | Wt. of Sludge taken in RB flask (g) | 302.36 | 301.34 | 301.22 |
| 2 | Wt. % Water Present in Sludge | 49.8082 | 49.8082 | 49.8082 |
| 3 | Wt. of Furnace Oil Present in Sludge (g) | 151.76 | 151.25 | 151.19 |
| 4 | Wt. of Solvent added in RB flask (g) | 457.45 | 907.7 | 1,217.07 |
| 5 | Wt. Ratio of Solvent to Water | 3.04 | 6.05 | 8.11 |
| 6 | Observed Boiling Temperature Range (° C.) | 93.75-137.43 | 94.73-135.96 | 94.63-136.35 |
| 7 | Wt. Avg. Rate of Water Collection (g/min) | 1.47 | 1.43 | 1.37 |
| 8 | Residual Water Present in left over Solvent cum | 0 | 0 | 2 |
| | Furnace Oil as determined by BTX Test (PPM) | | | |

TABLE 2.2A
REMOVAL OF BOUND WATER FROM FURNACE OIL SLUDGE BY VARYING
PROPORTIONS OF TOLUENE, WHILE REFLUXING TOLUENE BACK AT 933 mbar:

| SI. | | | | |
|---|---|---|---|---|
| No. | PARTICULARS | TEST 1 | TEST 2 | TEST 3 |
| 1 | Wt. of Sludge taken in RB flask (g) | 602.93 | 304.01 | 600.52 |
| 2 | Wt. % Water Present in Sludge | 49.9137 | 49.9137 | 49.9137 |
| 3 | Wt. of Furnace Oil present in Sludge (g) | 301.99 | 152.27 | 300.78 |
| 4 | Wt. of Solvent added in RB flask (g) | 300.64 | 230.81 | 500.35 |
| 5 | Wt. Ratio of Solvent to Water | 1.00 | 1.52 | 1.67 |
| 6 | Observed Boiling Temperature Range (° C.) | 73.38-116.47 | 74.40-111.99 | 72.89-103.97 |
| 7 | Wt. Avg. Rate of Water Collection (g/min) | 1.44 | 1.19 | 1.58 |
| 8 | Residual Water Present in left over Solvent cum | 415 | 5039 | 3496 |
| | Furnace Oil as determined by BTX Test (PPM) | | | |

TABLE 2.2B
REMOVAL OF BOUND WATER FROM FURNACE OIL SLUDGE BY VARYING
PROPORTIONS OF TOLUENE, WHILE REFLUXING TOLUENE BACK AT 933 mbar:

| SI. | | | | |
|---|---|---|---|---|
| No. | PARTICULARS | TEST 4 | TEST 5 | TEST 6 |
| 1 | Wt. of Sludge taken in RB flask (g) | 301.93 | 302.10 | 300.73 |
| 2 | Wt. % Water Present in Sludge | 49.8082 | 49.8082 | 49.554 |
| 3 | Wt. of Furnace Oil Present in Sludge (g) | 151.54 | 151.63 | 151.71 |
| 4 | Wt. of Solvent added in RB flask (g) | 301.96 | 456.73 | 596.90 |
| 5 | Wt. Ratio of Solvent to Water | 2.01 | 3.04 | 4.01 |
| 6 | Observed Boiling Temperature Range (° C.) | 64.6-111.69 | 74.79-110.22 | 87.13-111.18 |
| 7 | Wt. Avg. Rate of Water Collection (g/min) | 1.28 | 1.38 | 1.17 |
| 8 | Residual Water Present in left over Solvent cum | 397 | 82 | 0 |
| | Furnace Oil as determined by BTX Test (PPM) | | | |

TABLE 2.2C
REMOVAL OF BOUND WATER FROM FURNACE OIL
SLUDGE BY VARYING PROPORTIONS OF TOLUENE,
WHILE REFLUXING TOLUENE BACK AT 933 mbar:

| SI. | | | |
|---|---|---|---|
| No. | PARTICULARS | TEST 7 | TEST 8 |
| 1 | Wt. of Sludge taken in RB flask (g) | 300.58 | 300.81 |
| 2 | Wt. % Water Present in Sludge | 49.9137 | 49.9137 |
| 3 | Wt. of Furnace Oil Present in | 150.55 | 150.66 |
| | Sludge (g) | | |
| 4 | Wt. of Solvent added in RB flask (g) | 750.12 | 1204.93 |
| 5 | Wt. Ratio of Solvent to Water | 5 | 8.03 |
| 6 | Observed Boiling Temperature | 85.90-109.14 | 85.72-108.55 |
| | Range (° C.) | | |
| 7 | Wt. Avg. Rate of Water | 1.54 | 1.46 |
| | Collection (g/min) | | |
| 8 | Residual Water Present in left over | 266 | 95 |
| | Solvent cum Furnace Oil as | | |
| | determined by BTX Test (PPM) | | |

TABLE 2.3A
REMOVAL OF BOUND WATER FROM FURNACE OIL SLUDGE BY VARYING
PROPORTIONS OF BENZENE, WHILE REFLUXING BENZENE BACK AT 933 mbar:

| SI. | | | | | |
|---|---|---|---|---|---|
| No. | PARTICULARS | TEST 1 | TEST 2 | TEST 3 | TEST 4 |
| 1 | Wt. of Sludge taken in RB flask (g) | 303.61 | 302.55 | 302.64 | 300.54 |
| 2 | Wt. % Water Present in Sludge | 49.554 | 49.8082 | 49.554 | 49.554 |
| 3 | Wt. of Furnace Oil Present in Sludge (g) | 153.16 | 151.86 | 152.67 | 151.61 |
| 4 | Wt. of Solvent added in RB flask (g) | 153.41 | 303.78 | 459.16 | 454.93 |
| 5 | Wt. Ratio of Solvent to Water | 1.02 | 2.02 | 3.06 | 3.05 |
| 6 | Observed Boiling Temperature Range (° C.) | 75.2-93.79 | 72.06-83.56 | 69.84-81.33 | 70.74-78.76 |
| 7 | Wt. Avg. Rate of Water Collection (g/min) | 0.47 | 0.56 | 0.70 | 0.40 |
| 8 | Residual Water Present in left over Solvent cum | 32 | 88 | 98 | 0 |
| | Furnace Oil as determined by BTX Test (PPM) | | | | |

It was observed from Table 2.1 that entire water from sludge was removed by using xylene as refluxing solvent with varying proportions in the range of 1.6-8.1 with respect to water present in sludge except in Test 3 where residual water in furnace oil was 66 ppm when it was subjected to a maximum temperature of 140.88° C. It was observed that the final temperature exceeded the boiling point of pure xylene at ambient pressure when weight of xylene added was in the range of 1.6-2.0 times the weight of water present in sludge. It was observed that the final temperature was below the boiling point of pure xylene at ambient pressure when xylene added was 3-8 times the weight of water present in sludge.

It was observed from Table 2.2 that the final temperature exceeded the boiling point of pure toluene when toluene was taken 1-2 times the water present in sludge (Except in 1.67) and also the residual matter contain 300-5000 ppm water at their respective maximum temperatures. Accordingly, it was seen that higher the solvent ratio lower was the maximum temperature. It was observed that addition of toluene 3-8 times have shown better results compared to lower ratios. Considering heat energy, solvent requirement and kinetics of the process, toluene to water wt. ratio of 4 is preferable when compared to other ratios.

It was observed from Table 2.3 that the final temperature of material exceeded the boiling point of pure benzene in which the solvent added was 1 and 2 times the weight of water present in sludge. In the case where solvent added was 3 times the weight of water present in sludge, then entire water was removed from the sludge without allowing the temperature to exceed the boiling point of benzene.

### Example 3

### Removal of Water from Furnace Oil Sludges Containing 50 Wt. % Water with Varying Mixing Time, Entire Water being Bound Water, by Boiling it with Azeotropic Solvents, while Re-Fluxing Solvent Back

Experiments were performed to evaluate efficacy of process for removal of bound water from different Furnace oil sludges with varying time of mixing in sludge preparation thereby keeping the oil to water ratio constant. Accordingly, predefined proportions of furnace oil and water were mixed and then stirred at 10,000 RPM using a high shear mixer by varying the time of mixing as 2 minutes, 5 minutes and 8 minutes, anticipating change in sludge properties. Consequently, the prepared Furnace Oil sludges were taken with predefined amount of solvents by weight in an RB flask of a Dean and Stark apparatus and followed by continuous heating thereof in the mantle heater while continuously monitoring the temperature of material in RB flask with a digital thermometer. The vapors of bound water and solvent were collected in the receiver after condensing them with circulating cold water at 5-6° C. in the insulated condenser. The condensates of water were collected in separating flask using the stop cork at the bottom of the receiver while the condensates of solvent were allowed to reflux back into the RB flask through the receiver. The water was collected until no water condensates were observed and collected water was weighed each time.

TABLE 3.1
REMOVAL OF BOUND WATER FROM FURNACE OIL SLUDGES WITH VARYING
MIXING TIME, WHILE REFLUXING BACK TOLUENE AT 933 mbar:

| SI. | | | | |
|---|---|---|---|---|
| No. | PARTICULARS | TEST 1 | TEST 2 | TEST 3 |
| 1 | Mixing time during Sludge Preparation (min) | 2 | 5 | 8 |
| 2 | Amount of Sludge (g) | 300.66 | 300.00 | 300.90 |
| 3 | Wt. % Water present in Sludge | 49.501 | 49.6205 | 49.5661 |
| 4 | Wt. of Solvent (Toluene) added (g) | 595.43 | 599.55 | 596.41 |
| 5 | Wt. Ratio of Solvent to Water | 4.00 | 4.01 | 4.00 |
| 6 | Wt. Ratio of Solvent to FurnaceOil | 3.92 | 3.94 | 3.93 |
| 7 | Observed Boiling Temperature Range (° C.) | 83.40-107.40 | 86.4-110.6 | 81.00-110.50 |
| 8 | Low Temperature Water Collection (° C.) at constant | 93.80 | 88.10 | 88.20 |
| | Rate of Collection | | | |
| 9 | Wt. % Water Collected up to above Temperature | 84.04 | 88.03 | 85.74 |
| 10 | Rate of Water Collection up to above | 1.21 | 1.74 | 1.44 |
| | Temperature (g/min) | | | |
| 11 | Final Temperature (° C.) | 107.40 | 109.10 | 110.50 |
| 12 | Rate of Water Collection for above Temperature (g/min) | 0.23 | 0.25 | 0.22 |
| 13 | Wt. Avg. Rate of Water Collection up to above | 1.10 | 1.58 | 1.27 |
| | Temperature (g/min) | | | |
| 14 | Residual Water Present in left over Solvent cum | 114 | 263 | 71 |
| | Furnace Oil as determined by BTX Test (PPM) | | | |

It was observed that, for the same heat flux supplied, bound water could be removed faster from sludge prepared with 8 min mixing time than with 2 min mixing time. Rate of water collection was observed to be faster for 8 min mixing sludge at lower temperatures and also fraction of water removed at low temperature was also higher for 8 min sludge in comparison to 2 min sludge. It was explored that the size of dispersed droplets in 2 min mixing sludge which was greater than that for 8 min sludge as more of water is in contact with solvent within 8 min sludge. Hence, more water was removed at a faster rate and at temperature closer to that of azeotropic boiling point of solvent-water azeotrope. Accordingly, minimum boiling ratio was found to be decreased with increase in average dispersion of droplet size.

Further, it was seen that the rate of water removal for 5 min mixing sludge was higher than that for 2 min or 8 min mixing sludge. This could be because of higher heat flux passing through the sludge in case of 5 min sludge. However, fraction of water removed at low temperature and at rapid water removal rate was comparable in 5 min and 8 min sludges and higher than 2 min sludge. Accordingly, it was established that size of dispersed water droplets for 5 min sludge was similar to that of 8 min sludge, but it was relatively smaller than 2 min sludge.

### Example -4

### Removal of Entire Water from Varying Amounts of Furnace Oil Sludges Containing 50 Wt. % Water, Entire Water being Bound Water, by Boiling it with Azeotropic Solvents, while Re-Fluxing Solvent Back

In order to evaluate implications of using varying amounts of Furnace Oil Sludge on bound water removal from Furnace Oil Sludge with 50% bound water in it, predefined portions of sludge and solvent by weight were taken in an RB flask of a Dean & Stark Apparatus, followed by continuous heating thereof on the mantle heater while continuously monitoring the temperature of material in RB flask with a digital thermometer. The vapors of bound water and solvent were collected in the receiver after condensing them with circulating cold water at 5-6° C. in the insulated condenser. The solvent was allowed to reflux back and water from receiver was collected at marked intervals and was weighed each time.

TABLE 4.1
REMOVAL OF BOUND WATER FROM VARYING AMOUNTS OF FURNACE OIL
SLUDGE BY TOLUENE WHILE REFLUXING TOLUENE BACK AT 933 MBAR:

| SI. | | | | |
|---|---|---|---|---|
| No. | PARTICULARS | TEST 1 | TEST 2 | TEST 3 |
| 1 | Amount of Sludge (g) | 150 | 300 | 450 |
| 2 | Wt. % Water Present in Sludge | 49.6205 | 49.6205 | 49.6205 |
| 3 | Wt. of Solvent (Toluene) added (g) | 300.94 | 599.55 | 894.79 |
| 4 | Wt. Ratio of Solvent to Water | 4.00 | 4.01 | 4.00 |
| 5 | Wt. Ratio of Solvent to Hydrocarbons | 3.94 | 3.94 | 3.94 |
| 6 | Observed Boiling Temperature Range (° C.) | 87.9-108.9 | 86.4-110.6 | 85.4-109.8 |
| 7 | Low Temperature Water Collection (° C.) at constant | 87.90 | 88.10 | 85.70 |
| | Rate of Collection | | | |
| 8 | Wt. % Water Collected up to above Temperature | 68.36 | 88.03 | 81.71 |
| 9 | Rate of Water Collection up to above | 1.32 | 1.74 | 1.14 |
| | Temperature (g/min) | | | |
| 10 | Temperature (° C.) | 108.90 | 109.10 | 109.50 |
| 11 | Rate of Water Collection for above Temperature (g/min) | 0.32 | 0.25 | 0.57 |
| 12 | Wt. Avg. Rate of Water Collection up to above | 1.01 | 1.58 | 1.04 |
| | Temperature | | | |
| 13 | Time taken for Collections (Hrs.) | 1.86 | 2.29 | 3.85 |
| 14 | Residual Water Present in left over Solvent cum | 245 | 265 | 193 |
| | Furnace Oil as determined by BTX test (PPM) | | | |

It was observed that, importance of quantity was due to utilization of heat flux transferred through a heating mantle. Since mantle provides heat through a distributed heating coil covered by the entire lower hemisphere of RB flask, any quantity of sludge that does not cover the entire lower surface area of RB will have inefficient heating. This was clearly seen from time taken for collection in 150 g sludge and 450 g sludge. The time taken for 150 g sludge was 1.86 hours which was more than third of the time taken for 450 g sludge which was worked out to be 1.28 hours (3.85/3). Quantity in RB for 300 g and 450 g sludge was 900 g and 1350 g respectively, since both fill the lower half of 2 lit RB, heat flux utilization was almost the same. This was also seen through time taken for water collection. Accordingly, it was observed that the time taken for 300 g sludge is 2.29 hours which was slightly less than two-thirds of time taken for 450 g which should have been 2.57 hours (3.85*2/3).

### Example-5

### Removal of Water from Furnace Oil Sludges Containing Varying Wt % of Water, by Boiling it with Azeotropic Solvents, while Re-Fluxing Solvent Back

It was an aim of the experiment to evaluate efficacy of the process for removal of bound water from Furnace Oil Sludge with varying water content. Accordingly, predefined portions of sludge and solvent by weight were taken in the RB flask of Dean & Stark Apparatus and followed by continuous heating thereof on the mantle heater while continuously monitoring temperature of material in RB flask with a digital thermometer. The vapors of bound water and solvent were collected in the receiver after condensing them with circulating cold water at 5-6° C. in the insulated condenser. The solvent was allowed to reflux back and water from receiver was collected at marked intervals and were weighed each time.

TABLE 5.1
REMOVAL OF WATER FROM FURNACE OIL SLUDGE WITH VARYING
PROPORTIONS OF BOUND WATER, WHILE REFLUXING TOLUENE BACK AT 933 mbar

| Sl. | | | | | | |
|---|---|---|---|---|---|---|
| No. | PARTICULARS | TEST 1 | TEST 2 | TEST 3 | TEST 4 | TEST 5 |
| 1 | Amount of Sludge (g) | 300.85 | 300.30 | 300.89 | 301.54 | 301.66 |
| 2 | Wt. % Water Present in Sludge | 2.546 | 10.357 | 10.357 | 34.715 | 35.055 |
| 3 | Wt. of Furnace Oil Present in Sludge (g) | 293.19 | 269.20 | 269.73 | 196.86 | 195.91 |
| 4 | Wt. of Solvent (Toluene) added (g) | 300.99 | 124.41 | 1079.8 | 314.12 | 423.58 |
| 5 | Wt. Ratio of Solvent to Water | 39.28 | 4.00 | 34.65 | 3.00 | 4.01 |
| 6 | Wt. Ratio of Solvent to Furnace Oil | 1.03 | 0.46 | 4.00 | 1.6 | 2.16 |
| 7 | Observed Boiling Temperature Range | 66.7-120.3 | 98.50-130.0 | 86.20-110.20 | 74.40-114.25 | 65.6-110.5 |
| | (° C.) | | | | | |
| 8 | Low Temperature Water Collection (° C.) | — | — | 87.5 | 88.8 | 97 |
| 9 | Wt. % Water Collected up to above | — | — | 36.29 | 59.66 | 85.54 |
| | Temperature | | | | | |
| 10 | Rate of Water Collection up to above | — | — | 1.05 | 1.23 | 1.23 |
| | Temperature (g/min) | | | | | |
| 11 | Temperature (° C.) | 120.30 | 130.00 | 110.20 | 112.29 | 110.50 |
| 12 | Rate of Water Collection for above | — | — | 0.20 | 0.45 | 0.17 |
| | Temperature (g/min) | | | | | |
| 13 | Wt. Avg. Rate of Water Collection up to | 0.22 | 0.49 | 0.28 | 0.92 | 1.08 |
| | above Temperature (g/min) | | | | | |
| 14 | Residual Water Present in left over | 108 | 55 | 116 | 78 | 312 |
| | Solvent cum Furnace Oil as determined | | | | | |
| | by BTX Test (PPM) | | | | | |

TABLE 5.2
REMOVAL OF WATER FROM FURNACE OIL SLUDGE WITH VARYING PROPORTIONS
OF BOUND WATER, WHILE REFLUXING TOLUENE BACK AT 933 mbar

| SI. | | | | | |
|---|---|---|---|---|---|
| No. | PARTICULARS | TEST 3 | TEST 4 | TEST 5 | TEST 6 |
| 1 | Amount of Sludge (g) | 300.65 | 302.1 | 301.44 | 300.32 |
| 2 | Wt. % Water Present in Sludge | 34.7159 | 49.8082 | 55.6706 | 59.4788 |
| 3 | Wt. of Furnace Oil present in Sludge (g) | 196.28 | 151.63 | 133.63 | 121.69 |
| 4 | Wt. of Solvent (Toluene) added (g) | 593.61 | 456.73 | 671.24 | 538.01 |
| 5 | Wt. Ratio of Solvent to Water | 5.69 | 3.04 | 4.00 | 3.01 |
| 6 | Wt. Ratio of Solvent to Furnace Oil | 3.02 | 3.01 | 5.02 | 4.42 |
| 7 | Observed Boiling Temperature Range (° C.) | 85.72-109.83 | 74.79-110.22 | 86.10-109.10 | 69.2-112.49 |
| 8 | Low Temperature Water Collection (° C.) | 87.98 | 87.5 | 97.4 | 97.51 |
| 9 | Wt. % Water Collected up to above Temperature | 61.90 | 87.34 | 94.46 | 90.84 |
| 10 | Rate of Water Collection up to above | 1.56 | 1.55 | 1.1 | 1.53 |
| | Temperature (g/min) | | | | |
| 11 | Temperature (° C.) | 109.83 | 108.75 | 109.1 | 110.33 |
| 12 | Rate of Water Collection for above (last) | 0.37 | 0.14 | 0.11 | 0.14 |
| | Temperature (g/min) | | | | |
| 13 | Wt. Avg. Rate of Water Collection up to above | 1.10 | 1.39 | 1.07 | 1.41 |
| | Temperature (g/min) | | | | |
| 14 | Residual Water Present in left over Solvent cum | 101 | 82 | 91 | 15 |
| | Furnace Oil as determined by BTX Test (PPM) | | | | |

For the experiments mentioned above, amount of solvent was added in different ratios with respect to both water and hydrocarbons. It was observed that final residual water in hydrocarbons remained unchanged. However, there was a significant difference in the final temperature of material especially in case of sludges with low initial water content where final temperature rose beyond the boiling point of solvent. In sludges, with 2% and 10% water present, final temperature for water collection was 120° C. and 130° C. respectively, when solvent present was less than 2 wt. ratio with respect to hydrocarbons.

It was observed that solvent was required to depress boiling point of water by forming a heterogeneous azeotrope with water as well as to reduce viscosity and induce convective heat transfer throughout the bulk of sludge. When solvent present was less compared to hydrocarbons, true boiling point of solvent was found to be increased due to higher mole fraction of high boiling point hydrocarbons in organic phase, as per the Raoult's Law. It was seen that final temperature was below the boiling point of solvent when solvent present was at least twice the weight of hydrocarbons present, thereby providing a guideline for amount of solvent to be added to remove entire water from sludge without exceeding boiling point of solvent.

It was seen that rapid rate of water removal was kept on hold for a larger fraction of water removed as wt. % of initial water present in the sludge was increased. Accordingly, range of temperature for rapid water collection was observed to be wider for 55% and 60% sludges. It was established that, it could be possibly due to presence of free water present in sludge on account of poor mixing. It was established that, free water, if present in sludge could percolate down to the bottom of RB flask; in which case, temperature observed will be that of free water steam stripping the solvent rather than solvent removing bound water azeotropically. Ratio in which solvent and water were collected will still be the same. Accordingly, bound water can be removed from sludge with varied wt. % water content with final residual water content not exceeding 500 ppm.

### Example-6

### Removal of Bound Water from Furnace Oil Sludge with and without Sodium Chloride/Sodium Laurel Sulfate, ONGC Sludge before and after Centrifuge, Diesel Sludge using Toluene as Solvent

In order to better understand the behavior of different types of Sludge, processed in-house using different hydrocarbons with and without Sodium Chloride (salt)/Sodium Laurel Sulfate (SLS) on bound water removal. Sludge from ONGC lagoons as such and different layers thus obtained from centrifuge were considered, from which predefined portions of sludge and solvent by weight were taken in an RB flask of a Dean & Stark Apparatus, followed by continuous heating thereof on the mantle heater while continuously monitoring temperature of material in RB flask with a digital thermometer. The vapors of water and solvent were collected in the receiver after condensing them with circulating cold water 5-6° C. in an insulated condenser. The solvent was allowed to reflux back and water from receiver was collected at marked intervals and was weighed each time.

TABLE 6.1
REMOVAL OF BOUND WATER FROM FURNACE OIL
SLUDGE WITH AND WITHOUT SALT AND WITH SLS

| | | | Test 2 | Test 3 |
|---|---|---|---|---|
| SI. | | Test 1 | FO sludge | FO sludge |
| No. | PARTICULARS | FO Sludge | with salt | with SLS |
| 1 | Amount of Sludge (g) | 301.68 | 300.64 | 300.54 |
| 2 | Wt. % Water Present in Sludge | 49.62 | 49.8968 | 47.4764 |
| 3 | Wt. of Solvent (Toluene) added (g) | 599.55 | 600.28 | 571.23 |
| 4 | Initial wt. Ratio of Solvent to Water | 4.01 | 4.00 | 4.00 |
| 5 | Initial wt. Ratio of Solvent to Furnace Oil | 3.94 | 3.99 | 3.62 |
| 6 | Observed Boiling Temperature Range (° C.) | 86.4-110.6 | 87.8-109.6 | 85.1-110.2 |
| 7 | Low Temperature Water Collection (° C.) with | 88.10 | 89.40 | 91.70 |
| | Constant Rate of Collection | | | |
| 8 | Wt. % Water Collected up to above Temperature | 88.03 | 72.05 | 67.30 |
| 9 | Temperature (° C.) | 109.1 | 109.60 | 110.20 |
| 10 | Wt. Avg. Rate of Water Collection up to above | 1.58 | 1.15 | 1.21 |
| | Temperature (g/min) | | | |
| 11 | Residual Water Present in left over Solvent cum | 265 | 246 | — |
| | Furnace Oil as determined by BTX Test (PPM) | | | |

TABLE 6.2
REMOVAL OF BOUND WATER FROM ONGC SLUDGE, ONGC
SLUDGE VISCOUS LAYER, ONGC SLUDGE BOTTOM LAYER

| | | | | Test 6 |
|---|---|---|---|---|
| | | | Test 5 | ONGC |
| | | | ONGC | Medium |
| | | Test 4 | Viscous | Viscous |
| SI. | | ONGC | Hydro | Hydro |
| No. | PARTICULARS | sludge | carbons | carbons |
| 1 | Amount of Sludge (g) | 301.69 | 303.99 | 300.96 |
| 2 | Wt. % Water Present in Sludge | 45.7909 | 59.3177 | 42.3074 |
| 3 | Wt. of Solvent (Toluene) added (g) | 553.36 | 722.34 | 509.67 |
| 4 | Initial wt. Ratio of Solvent to Water | 4.01 | 4.01 | 4.00 |
| 5 | Initial wt. Ratio of Solvent to Furnace Oil | 3.38 | 5.84 | 2.94 |
| 6 | Observed Boiling Temperature Range (° C.) | 86.2-110.5 | 91.2-108.6 | 81.5-109.8 |
| 7 | Low Temperature Water Collection (° C.) at | 90.60 | 93.00 | 88.00 |
| | Constant Rate of Collection | | | |
| 8 | Wt. % Water Collected up to above Temperature | 66.38 | 81.27 | 70.38 |
| 9 | Temperature (° C.) | 110.50 | 108.40 | 109.60 |
| 10 | Rate of Water Collection for above (last) | 0.76 | 0.29 | 0.88 |
| | Temperature (g/min) | | | |
| 11 | Wt. Avg. Rate of Water Collection up to above | 1.11 | 0.69 | 1.10 |
| | Temperature (g/min) | | | |
| 12 | Residual Water Present in left over Solvent cum | 96 | 110 | 263 |
| | Furnace Oil as determined by BTX Test (PPM) | | | |

TABLE 6.3
REMOVAL OF BOUND WATER FROM
DIESEL SLUDGE WITH SLS

| SI. | | Test 7 |
|---|---|---|
| No. | PARTICULARS | Diesel Sludge |
| 1 | Amount of Sludge (g) | 296.81 |
| 2 | Wt. % Water Present in Sludge | 48.3388 |
| 3 | Wt. of Solvent (Toluene) added (g) | 593.49 |
| 4 | Initial wt. Ratio of Solvent to Water | 4.14 |
| 5 | Initial wt. Ratio of Solvent to Furnace Oil | 3.87 |
| 6 | Observed Boiling Temperature Range (° C.) | 91.2-113.8 |
| 7 | Low Temperature Water Collection (° C.) at | 97.70 |
| | Constant Rate of Collection | |
| 8 | Wt. % Water Collected up to above Temperature | 75.6790 |
| 9 | Rate of Water Collection up to above | 1.35 |
| | Temperature (g/min) | |
| 10 | Final Temperature (° C.) | 113.80 |
| 11 | Wt. % Water Collected up to Final Temperature | 98.00 |
| 12 | Rate of Water Collection for above (last) | 0.68 |
| | Temperature (g/min) | |
| 13 | Overall Rate of Water Collection up to above | 1.20 |
| | Temperature (g/min) | |
| 14 | Residual Water Present in left over Solvent cum | 15 |
| | Diesel as determined by BTX Test (PPM) | |

It was observed that almost entire bound water was removed from Furnace Oil Sludge with and without Sodium Chloride/Sodium Laurel Sulfate, which was consistent with the BTX results of residual material left over in RB.

Further, it was observed that the boiling range remained constant in all three cases of Furnace Oil. The prime detrimental effect of salts was that the amount of energy required to remove bound water from Furnace Oil Sludge was higher where sodium chloride was added and further higher where sodium laurel sulfate was added. It was also observed that the initial azeotropic boiling temperature for toluene and water was higher when salts were added at 87.8° C. and lower when Sodium Laurel Sulfate was added at 85.1° C. The percentage water collected by lower observed temperature of boiling dropped from 88.03% for Furnace Oil alone to 72.05% for Furnace oil sludge with sodium chloride and further to 67.30% for Furnace Oil Sludge with Sodium Laurel Sulfate. Once the azeotropic concentration shifted to higher ratio of toluene to water, the elevation in boiling point effect was observed to decrease, and the final boiling temperature was observed to be in the vicinity of 109-110° C.

For the case of ONGC sludges and its centrifuged layers, the boiling point was observed to be higher for ONGC viscous hydrocarbons at 91.2° C. and least for ONGC medium viscous hydrocarbon layer at 81.5° C. Further, it was observed that wt. % water collected up to low temperature till constant rate of water collection was 81.27% for ONGC Viscous Hydrocarbons which was higher than ONGC sludge at 66.38% and ONGC Medium Viscous Hydrocarbons sludge at 70.38%. It was seen that segregation of water was having adverse effect on the initial boiling ratio hence it was found to be advisable to pretreat the material beforehand. The final temperature of water collection was observed to be in the range of 108.40-110.50° C. for all three ONGC sludges.

In case of diesel sludge, BTX results established that entire bound water was removed similar to that of other sludge types. The low temperature for water collection was observed to be much higher for diesel sludge when compared with other sludges, due to presence of easily separable water from diesel, rendering itself as free water. The water collected during the low temperature was higher for diesel sludge, preferably 75.68% than for ONGC sludge at 66.38% but was lower than that of furnace oil sludge at 88.03%. Further it was observed that the moisture percentage calculated by BTX process is lower than any other sludge at 15 ppm, when compared to Furnace oil sludge at 263 ppm and ONGC sludge at 84 ppm.

### Example-7

### Comparison of Refluxing and without Refluxing Solvent on Removal of Bound Water from Furnace Oil Sludges, by Boiling with Azeotropic Solvents

Experiments were conducted to evaluate the efficacy of removal of bound water by heating with azeotropic solvents and refluxing back the solvent in accordance with the process of the present invention, and juxtapose the results with removal of bound water by heating with azeotropic solvents without refluxing the solvent, noting advantages of present invention.

Accordingly, weight fraction of bound water present in sludges were firstly determined and calculated amount of solvent was added for both with reflux and without reflux followed by heating in a Dean and Stark Apparatus using mantle heater and continuously monitoring the temperature of the material in RB flask. The vapors of water and solvent were collected in the receiver after condensing them with circulating cold water 5-6° C. in an insulated condenser. Accordingly, entire bound water present in sludge was removed with combined effect of solvent cum heat, where one experiment was carried out with refluxing the solvent and the other experiment was carried without refluxing the solvent. Accordingly, the solvents used were benzene, toluene, and xylene.

TABLE 7.1
REMOVAL OF BOUND WATER FROM FURNACE OIL SLUDGE WITH
50 WT % BOUND WATER IN IT BY BOILING WITH XYLENE, WHILE
REFLUXING BACK AND WITHOUT REFLUXING BACK XYLENE

| | | | TEST 2 |
|---|---|---|---|
| | | TEST 1 | (WITHOUT |
| SI. | | (REFLUX | REFLUX |
| No. | PARTICULARS | BACK) | BACK) |
| 1 | Wt. of Sludge taken in RB flask (g) | 303.40 | 155.51 |
| 2 | Wt. % Water Present in Sludge | 49.9137 | 49.8134 |
| 3 | Wt. of Furnace Oil Present in Sludge (g) | 151.96 | 78.04 |
| 4 | Wt. of Solvent added in RB flask (g) | 456.66 | 426.63 |
| 5 | Wt. Ratio of Solvent to Water | 3.02 | 5.50 |
| 6 | Observed Boiling Temperature Range (° C.) | 94.86-137.75 | 96.33-136.27 |
| 7 | Wt. Avg. Rate of Water Collection (g/min) | 1.41 | 0.38 |
| 8 | Residual Water Present in left over Solvent cum | <16 | 62 |
| | Furnace Oil as determined by BTX Test (PPM) | | |

TABLE 7.2
REMOVAL OF BOUND WATER FROM FURNACE OIL SLUDGE WITH 50
WT % BOUND WATER IN IT BY BOILING WITH TOLUENE, WHILE
REFLUXING BACK AND WITHOUT REFLUXING BACK TOLUENE

| | | | TEST 2 |
|---|---|---|---|
| | | TEST 1 | (WITHOUT |
| SI. | | (REFLUX | REFLUX |
| No. | PARTICULARS | BACK) | BACK) |
| 1 | Wt. of Sludge taken in RB flask (g) | 300.73 | 150.43 |
| 2 | Wt. % Water Present in Sludge | 49.554 | 49.8134 |
| 3 | Wt. of Furnace Oil Present in Sludge (g) | 151.71 | 75.5 |
| 4 | Wt. of Solvent added in RB flask (g) | 596.9 | 749.54 |
| 5 | Wt. Ratio of Solvent to Water | 4.01 | 10 |
| 6 | Observed Boiling Temperature Range (° C.) | 87.13-111.18 | 91.83-108.27 |
| 7 | Wt. Avg. Rate of Water Collection (g/min) | 1.17 | 0.24 |
| 8 | Residual Water Present in left over Solvent cum | 0 | 658 |
| | Furnace Oil as determined bv BTX Test (PPM) | | |

TABLE 7.3
REMOVAL OF BOUND WATER FROM FURNACE OIL SLUDGE WITH 50
WT % BOUND WATER IN IT, BY BOILING WITH BENZENE, WHILE
REFLUXING BACK AND WITHOUT REFLUXING BACK BENZENE

| | | | TEST 2 |
|---|---|---|---|
| | | TEST 1 | (WITHOUT |
| SI. | | (REFLUX | REFLUX |
| No. | PARTICULARS | BACK) | BACK) |
| 1 | Wt. of Sludge taken in RB flask (g) | 306.68 | 25.68 |
| 2 | Wt. % Water Present in Sludge | 49.554 | 49.8134 |
| 3 | Wt. of Furnace Oil present in Sludge (g) | 154.71 | 12.89 |
| 4 | Wt. of Solvent added in RB flask (g) | 464.17 | 1023.36 |
| 5 | Wt. Ratio of Solvent to Water | 3.05 | 80.01 |
| 6 | Observed Boiling Temperature Range (° C.) | 73.19-79.93 | 73.80-81.05 |
| 7 | Wt. Avg. Rate of Water Collection (g/min) | 0.53 | 0.02 |
| 8 | Residual Water Present in left over Solvent cum | 194 | 234 |
| | Furnace Oil as determined by BTX Test (PPM) | | |

It was observed that a very high amount of excess of solvent was required to remove bound water without reflux, especially for toluene and benzene, 10 and 80 times to the amount of water present respectively. Average rate of water removal was 1.41, 1.17 and 0.53 g/min for xylene, toluene and benzene respectively for reflux, which was a lot higher than average rate of water removal when not refluxing, 0.38, 0.24 and 0.02 g/min for xylene, toluene and benzene respectively. It was established that addition of more solvent may reduce viscosity of the material but it need not be that low. Water may easily separate in very low viscous material, which might have adversely effected the initial azeotrope boiling.

It was apparent from BTX results of the above experiments that refluxing of solvent was essential to remove entire bound water present in furnace oil sludge irrespective of the choice of solvent, because of solvent stripping of final traces of water during reflux. Accordingly, it was established that refluxing solvent must go to bottom by changing the path of liquid and vapors to sweep out any water present. It was further established that we may have to control rate of heating in case where solvent was not refluxed as solvent depletion might lead to shooting up the final temperature of residual material.

### Example-8

### Impact of Capacity of RB Flask on Removal of Bound Water from Furnace Oil Sludge by Refluxing with Solvents

Experiments were conducted to evaluate efficacy of removal of bound water by heating with azeotropic solvents and refluxing back the solvent in accordance with the process of the present invention while varying the capacity of RB flask, and consequently changing the area of contact between material and heating mantle.

Accordingly, fraction of bound water present in sludges were firstly determined and then calculated amount of solvent was added therein followed by heating in a Dean and Stark apparatus using Mantle Heater and continuously monitoring the temperature of material in RB flask with a digital thermometer. The vapors of water and solvent were collected in the receiver after condensing them with circulating cold water 5-6° C. in an insulated condenser. The solvent was allowed to reflux back and water from receiver was collected at marked intervals and was weighed each time. Accordingly, weight fraction of bound water present in sludge was removed while the solvent was refluxed. Here, RB Flasks of two different capacities were chosen, 2 L and 5 L.

TABLE 8.1
IMPACT OF CAPACITY OF RB FLASK ON REMOVAL OF BOUND
WATER FROM FURNACE OIL SLUDGE USING XYLENE

| SI. | | | |
|---|---|---|---|
| No. | PARTICULARS | TEST 1 | TEST 2 |
| 1 | Wt. of Sludge taken in RB flask (g) | 303.12 | 303.40 |
| 2 | Wt. % Water Present in Sludge (g) | 49.8082 | 49.9137 |
| 3 | Wt. of Furnace Oil Present in Sludge (g) | 152.14 | 151.96 |
| 4 | Wt. of Solvent added in RB flask (g) | 456.45 | 456.66 |
| 5 | Wt. Ratio of Solvent to Water | 3.02 | 3.02 |
| 6 | Capacity of RB flask (L) | 5 | 2 |
| 7 | Wt. % of Water Collected up to a Temperature | 80.24 | 89.16 |
| | of 100° C. | | |
| 8 | Observed Boiling Temperature Range (° C.) | 95.91-137.23 | 94.86-137.75 |
| 9 | Average Rate of Rater Collection (g/min) | 1.32 | 1.41 |
| 10 | Residual Water Present in left over Solvent cum | 49 | <16 |
| | Furnace Oil as determined by BTX Test (PPM) | | |

It was observed that water collected up to a temperature of 100° C. was 89 Wt. % in 2 L RB where as in case of 5 L RB it was 80 Wt. %. Importance of capacity of flask was in utilization of heat flux transferred through a heating mantle. Since mantle was observed to provide heat through a distributed heating coil covered by the entire lower hemisphere of RB, any quantity of sludge not covering the entire lower surface area of RB was observed to have inefficient heating. 5 L heating mantle was observe to have twice the power consumption of a 2 L heating mantle, however rate of water collection was higher for a 2 L mantle than a 5 L mantle. Rate of water collection was 1.41 g/min for 2 L RB and 1.32 g/min for 5 L RB. This highlighted the fact that area of heating surface in contact with liquid to be heated was highly essential in the overall efficiency of bound water removal process.

### Example-9

### Removal of Entire Water from Furnace Oil Sludges Containing 50 Wt. % Water, Entire Water being Bound Water, by Boiling it with Mixture of Azeotropic Solvents, while Re-Fluxing Solvent Back

It was an aim of the experiment to evaluate the process of removal of bound water with mixture of azeotropic solvents from Furnace oil sludge. Accordingly, predefined portions of sludge and solvent by weight were taken in an RB flask of Dean & Stark Apparatus, followed by continuous heating thereof on the mantle heater while continuously monitoring the temperature of material in RB flask with a digital thermometer. The vapours of bound water and solvent were collected in the receiver after condensing them with circulating cold water at 5-6° C. in an insulated condenser. The solvent was allowed to reflux back and water from receiver was collected at marked intervals and was weighed each time.

TABLE 9.1
REMOVAL OF BOUND WATER FROM FURNACE OIL
SLUDGE WITH COMBINED USE OF BENZENE & TOLUENE
AND TOLUENE & XYLENE AT 933 mbar

| SI. | | | |
|---|---|---|---|
| No. | PARTICULARS | TEST 1 | TEST 2 |
| 1 | Wt. of Sludge taken in RB flask (g) | 302.15 | 303.86 |
| 2 | Wt. % Water Present in Sludge | 49.9137 | 49.9137 |
| 3 | Wt. of Hydrocarbons Present in Sludge (g) | 151.34 | 152.19 |
| 4 | Wt. of Xylene added in RB flask (g) | 229.03 | — |
| 5 | Wt. Ratio of Xylene to Water | 1.52 | — |
| 6 | Wt. Ratio of Xylene to Hydrocarbons | 1.51 | — |
| 7 | Wt. of Toluene added in RB flask (g) | 227.77 | 228.61 |
| 8 | Wt. Ratio of Toluene to Water | 1.51 | 1.51 |
| 9 | Wt. Ratio of Toluene to Hydrocarbons | 1.51 | 1.50 |
| 10 | Wt. of Benzene added in RB flask (g) | — | 152.93 |
| 11 | Wt. Ratio of Benzene to Water | — | 1.01 |
| 12 | Wt. Ratio of Benzene to Hydrocarbons | — | 1.00 |
| 13 | Observed Boiling Temperature Range (° C.) | 90.70-122.58 | 78.73-95.92 |
| 14 | Wt. Avg. Rate of Water Collection (g/min) | 1.13 | 0.72 |
| 15 | Residual Water Present in left over Solvent cum | 0 | 164 |
| | Furnace Oil as determined by BTX Test (PPM) | | |

It was observed from the above table that entire bound water could be removed with combined use of azeotropic solvents. It was further observed that maximum temperature reached during process was almost between the boiling temperatures of pure solvents used in said test. Accordingly, under certain conditions, it was advisable to use high and low boiling point solvents to increase kinetics and to depress final temperature of material.

### Example-10

### Removal of Bound Water from Furnace Oil by Initially Refluxing and Eventually Boiling with Azeotropic Solvents

Experiments were conducted to quantitatively retrieve back pure hydrocarbons and water, present in various sludges and retrieve back the entire solvent and free water in accordance with the process of the present invention.

Accordingly, fraction of bound water present in sludges were first determined and then calculated amount of solvent was added therein followed by heating in a Dean and Stark Apparatus using Mantle Heater by continuously monitoring the temperature of material in RB flask with a digital thermometer.

Accordingly, fraction of bound water present in sludge was removed while the solvent was refluxed. The reflux of solvent was halted at material temperature of 100° C., and both solvent and water were collected from thereon. This step was followed to attain and prove an energy efficient procedure, as high energy was required for removing the last 10-15% of water. Subsequently, entire water was condensed and collected, along with substantial amount of solvent. Finally, the water and hydrocarbon samples retrieved were analyzed quantitatively using mass balance study.

Further, in another experiment, fraction of bound water present in sludge was removed while the solvent was refluxed. The reflux of solvent was halted at material temperature of 88° C., and both solvent and water were collected. Further, the temperature was maintained preferably at 97° C. without exceeding 100° C., and subsequently, the process was halted after collection of considerable amount of solvent and bound water.

Further, a calculated amount of free water was added to residual matter in RB Flask and once again the mixture was heated using the same apparatus. Subsequently, entire remaining solvent was removed and collected along with some free water. Thereafter, the entire amount of remaining free water from the residual hydrocarbons was collected through pipette suction after heating the hydrocarbons, which was then followed by one or multiple centrifuges depending on the amount of remaining free water in the hydrocarbons. Finally, the water and hydrocarbon samples were analyzed quantitatively using mass balance study.

TABLE 10.1
REMOVAL OF ENTIRE BOUND WATER FROM FURNACE
OIL BY INITIALLY REFLUXING AND FINALLY BOILING
ALONG WITH AZEOTROPIC SOLVENTS

| | | Test 1 | Test 2 |
|---|---|---|---|
| SI. | | Toluene | Xylene |
| No | PARTICULARS | 1:4 | 1:3 |
| 1 | Amount of Sludge (g) | 303.54 | 302.85 |
| 2 | Wt. % Water Present in Sludge | 49.8253 | 49.9137 |
| 3 | Wt. of Solvent (Toluene) added (g) | 605.65 | 453.66 |
| 4 | Wt. Ratio of Solvent to Water | 4.00 | 3.00 |
| 5 | Wt. Ratio of Solvent to Furnace oil | 3.97 | 2.99 |
| 6 | Observed Boiling Temperature Range (° C.) | 87.6-110.3 | 96.5-136.5 |
| 7 | Temperature up to Solvent Reflux (° C.) | 100.4 | 100.10 |
| 8 | Wt. % Water Collected up to above Temperature | 94.89 | 89.43 |
| 9 | Rate of Water Collection up to above | 1.38 | 1.50 |
| | Temperature (g/min) | | |
| 10 | Temperature with Solvent non Refluxing (° C.) | 110.3 | 136.50 |
| 11 | Rate of Water Collection for Non-Reflux step (g/min) | 0.10 | 0.33 |
| 12 | Overall Rate of Water Collection (g/min) | 0.94 | 1.13 |
| 13 | Initial Collection Ratio of Solvent to Water | 22.54 | 4.31 |
| 14 | Final Collection Ratio of Solvent to Water | 163.2 | 129.06 |
| 15 | Wt. % Solvent Collected | 46.85 | 49.42 |
| 16 | Rate of Solvent Collection after starting Non-Reflux | 6.03 | 5.38 |
| | (g/min) | | |
| 17 | Wt. % Solvent left in the RB flask | 53.15 | 50.58 |
| 18 | Residual Water Present in left over Solvent cum | 620 | 430 |
| | Furnace Oil as determined by BTX Test (PPM) | | |

TABLE 10.2
REMOVAL OF BOUND WATER FROM FURNACE OIL BY
INITIALLY REFLUXING AND FINALLY BOILING ALONG
WITH AZEOTROPIC SOLVENTS TILL 97° C.

| SI. | PARTICULARS | Test 3 |
|---|---|---|
| No. | STEP - 1 | Toluene 1:4 |
| 1 | Amount of Sludge (g) | 303.21 |
| 2 | Wt. % Water Present in Sludge | 49.82530 |
| 3 | Wt. of Solvent added (g) | 604.30 |
| 4 | Wt. Ratio of Solvent to Water | 4.00 |
| 5 | Wt. Ratio of Solvent to Furnace Oil | 3.97 |
| 6 | Observed Boiling Temperature Range (° C.) | 87.2-97.1 |
| 7 | Temperature up to Reflux is carried (° C.) | 88.10 |
| 8 | Wt. % Water Collected up to above Temperature | 64.29 |
| 9 | Rate of Water Collection up to above | 1.57 |
| | Temperature (g/min) | |
| 10 | Temperature up to No Reflux is carried (° C.) | 97.10 |
| 11 | Wt. % Water Collected up to above temperature | 94.68 |
| 12 | Wt. % Solvent Collected up to above Temperature | 24.9 |
| 13 | Rate of Water Collection for above Temperature | 1.10 |
| | (g/min) | |
| 14 | Overall Rate of Water Collection up to above | 1.25 |
| | Temperature (g/min) | |

TABLE 10.3
REMOVAL OF ENTIRE SOLVENT FROM FURNACE
OIL BY HEATING ALONG WITH FREE WATER

| SI. | PARTICULARS | TEST 3 |
|---|---|---|
| No. | STEP - 2 | Toluene 1:4 |
| 1 | Wt. of Furnace Oil Present in RB flask | 152.13 |
| 2 | Wt. of Solvent Present in RB flask (g) | 453.46 |
| 3 | Wt. of Free Water added in RB flask (g) | 450.23 |
| 4 | Initial Ratio of Water to Solvent | 1 |
| 5 | Observed Boiling Temperature Range (° C.) | 95.6-99.5 |
| 6 | Initial Wt. Ratio of Solvent to Water collected | 5.95 |
| 7 | Final Wt. Ratio of Solvent to Water collected | 0.94 |
| 8 | Average Wt. Ratio of Solvent to Water collected | 2.06 |
| 9 | Total wt. of Free Water Collected (g) | 215.18 |
| 10 | Total wt. of Solvent Collected (g) | 443.16 |
| 11 | Wt. of Free water left behind in RB flask at the | 243.09 |
| | end of Experiment (g) | |
| 13 | Wt. % Loss due to the Evaporation, etc. | 0.58 |

It was observed that while refluxing the furnace oil with solvent, by 100° C. the average rate of water collection was observed to be fallen from 1.38 g/min to 0.10 g/min in test 1 and from 1.50 g/min to 0.33 g/min in Test2. Therefore, it was considered energy efficient to discontinue reflux and collect both solvent and water, considering the drop in rate of water collection. The amount of water collected was almost same, which was consistent with the moisture percentage in the residual furnace oil and solvent mixture by BTX at about 620 ppm with toluene and 430 ppm with xylene.

When refluxing was carried out, the solvent went back to RB flask and to the bottom of the vessel, in order to be heated up. Accordingly, reflux during final collections carried any left out water with it and traces of water left behind in the material were solvent stripped. It was seen that kinetics to remove last fraction of water was higher by changing the path of liquid and vapor to sweep out any water present at the bottom. But in case where reflux was not done till the end, this solvent stripping of water may not be effective, which left behind final traces of water in the residual material. Hence, the BTX results obtained were higher than what was usually obtained when reflux was carried out till boiling point.

Further, it was observed that the rate of solvent collection was substantial at 6.03 g/min in Test 1 and 5.38 g/min is Test 2. Consequently, with around half the solvent already separated, the amount of free water required for solvent removal was halved thereby saving energy in free water separation. Further, it was observed from Table 10.2, that the average rate of water collection went down from 1.57 g/min to 1.10 g/min from refluxing condition of the solvent to a not refluxing condition. Also, it was seen that the amount of free water added and subsequently used to remove the free water was less since a portion of solvent was already recovered.

It was observed that the process of removal of bound water by refluxing initially followed by boiling with azeotropic solvent till 97° C. was carried out only for toluene, because the azeotropic boiling point of Xylene with water was higher compared to toluene and the window available to carry out both refluxing and boiling was less than 5° C., in which very less amount of water could only be collected. Hence only toluene was considered for this set of experiments.

### Example-11

### Recovery of Solvents from Hydrocarbons by Heating with Free Water

It was an aim to interpret, establish and evaluate the process of removing entire solvents like Xylene, Toluene and Benzene from Furnace Oil by adding free water and boiling out below 100° C. under atmospheric pressure of 933 mbar. Accordingly, the predetermined proportions of Furnace Oil, solvent and free water were weighed and taken in an RB flask of a Dean and Stark Apparatus followed by heating them in a mantle heater at a controlled heat rate and monitoring the temperature of material in RB flask. It was ensured that initial weight ratio of solvent to Furnace Oil was more than what was left behind in the RB flask after removing entire bound water from Furnace Oil Sludge. The vapors of bound water and solvent were collected in the receiver after condensing them with circulating cold water at 5-6° C. in an insulated condenser. Solvent and water were collected from receiver at periodic intervals and weighed individually after immediate phase separation.

TABLE 11.1.A
REMOVAL OF XYLENE FROM FURNACE OIL WITH VARYING
PROPORTIONS OF FREE WATER AT 933 mbar

| SI. | | | | |
|---|---|---|---|---|
| No. | PARTICULARS | TEST 1 | TEST 2 | TEST 3 |
| 1 | Wt. of Furnace Oil taken in RB flask (g) | 153.86 | 151.18 | 153.31 |
| 2 | Wt. of Solvent taken in RB flask (g) | 923.44 | 453.55 | 460.26 |
| 3 | Wt. of Free Water added in RB flask (g) | 923.82 | 454.02 | 921.76 |
| 4 | Wt. Ratio of Water to Solvent | 1.00 | 1.00 | 2.00 |
| 5 | Wt. Ratio of Solvent to Furnace Oil | 6.00 | 3.00 | 3.00 |
| 6 | Observed Boiling Temperature Range (° C.) | 96.24-97.90 | 97.85-114.70 | 96.89-97.58 |
| 7 | Initial wt. Ratio of Solvent to Water Collected | 2.21 | 2.14 | 2.07 |
| 8 | Final wt. Ratio of Solvent to Water Collected | 0.08 | 0.11 | 0.05 |
| 9 | Average wt. Ratio of Solvent to Water Collected | 1.39 | 1.26 | 0.95 |
| 10 | Total wt. of Water Collected (g) | 669.49 | 364.39 | 489.69 |
| 11 | Total wt. of Solvent Collected (g) | 928.82 | 458.72 | 464.66 |
| 12 | Average Rate of Solvent Collection (g/min) | 3.23 | 2.16 | 1.76 |
| 13 | Wt. of Furnace Oil left behind in RB flask at the end of | 148.48 | 146.01 | 148.91 |
| | the Experiment (g) | | | |
| 14 | Wt. of Free Water left behind in RB flask at the end of | 246.24 | 84.09 | 424.34 |
| | the Experiment (g) | | | |
| 15 | Wt. % Loss due to Evaporation, etc. | 0.40 | 0.52 | 0.50 |

TABLE 11.1.B
REMOVAL OF TOLUENE FROM FURNACE OIL WITH VARYING
PROPORTIONS OF FREE WATER AT 933 mbar

| Sl. No. | PARTICULARS | TEST 1 | TEST 2 | TEST 3 | TEST 4 |
|---|---|---|---|---|---|
| 1 | Wt. of Furnace Oil taken in RB flask (g) | 150.96 | 151.62 | 150.32 | 150.00 |
| 2 | Wt. of Solvent taken in RB flask (g) | 452.88 | 450.74 | 450.42 | 600.01 |
| 3 | Wt. of Free Water added in RB flask (g) | 339.96 | 450.02 | 675.64 | 600.36 |
| 4 | Wt. Ratio of Water to Solvent | 0.75 | 1.00 | 1.50 | 1.00 |
| 5 | Wt. Ratio of Solvent to Furnace Oil | 3.00 | 2.97 | 3.00 | 4.00 |
| 6 | Observed Boiling Temperature Range (° C.) | 96.21-101.23 | 95.06-98.09 | 95.90-97.60 | 97.28-98.50 |
| 7 | Initial wt. Ratio of Solvent to Water Collected | 5.82 | 4.87 | 4.73 | 4.85 |
| 8 | Final wt. Ratio of Solvent to Water Collected | 0.17 | 0.06 | 1.98 | 0.08 |
| 9 | Average wt. Ratio of Solvent to Water Collected | 2.94 | 2.05 | 1.87 | 2.38 |
| 10 | Total wt. of Water Collected (g) | 155.18 | 221.79 | 241.15 | 252.31 |
| 11 | Total wt. of Solvent Collected (g) | 455.82 | 454.83 | 452.12 | 602.66 |
| 12 | Average Rate of Solvent Collection (g/min) | 3.12 | 2.06 | 2.29 | 2.96 |
| 13 | Wt. of Furnace Oil left behind in RB flask at | 148.02 | 147.53 | 148.62 | 147.35 |
| | the end of the Experiment (g) | | | | |
| 14 | Wt. of Free Water left behind in RB flask at | 182.68 | 226.04 | 417.00 | 343.86 |
| | the end of the Experiment (g) | | | | |
| 15 | Wt. % Loss due to Evaporation, etc. | 0.23 | 0.21 | 1.37 | 0.31 |

TABLE 11.1.C
REMOVAL OF BENZENE FROM FURNACE OIL WITH VARYING
PROPORTIONS OF FREE WATER AT 933 mbar

| Sl. No. | PARTICULARS | TEST 1 | TEST 2 | TEST 3 |
|---|---|---|---|---|
| 1 | Wt. of Furnace Oil taken in RB flask (g) | 151.64 | 154.18 | 158.58 |
| 2 | Wt. of Solvent taken in RB flask (g) | 303.29 | 308.36 | 475.74 |
| 3 | Wt. of Free Water added in RB flask (g) | 151.70 | 616.83 | 951.49 |
| 4 | Wt. Ratio of Water to Solvent | 0.50 | 2.00 | 2.00 |
| 5 | Wt. Ratio of Solvent to Furnace Oil | 2.00 | 2.00 | 3.00 |
| 6 | Observed Boiling Temperature Range (° C.) | 77.39-135.43 | 82.27-97.82 | 80.12-98.59 |
| 7 | Initial wt. Ratio of Solvent to Water Collected | 54.92 | 64.73 | 47.31 |
| 8 | Final wt. Ratio of Solvent to Water Collected | 0.16 | 0.03 | 0.05 |
| 9 | Average wt. Ratio of Solvent to Water Collected | 5.19 | 1.82 | 3.34 |
| 10 | Total wt. of Water Collected (g) | 59.23 | 170.95 | 143.37 |
| 11 | Total wt. of Solvent Collected (g) | 307.61 | 312.14 | 479.55 |
| 12 | Average Rate of Solvent Collection (g/min) | 3.55 | 2.28 | 3.79 |
| 13 | Wt. of Furnace Oil left behind in RB flask at | 147.32 | 150.40 | 154.77 |
| | the end of the Experiment (g) | | | |
| 14 | Wt. of Free Water left behind in RB flask at | 87.66 | 438.83 | 801.55 |
| | the end of the Experiment (g) | | | |
| 15 | Wt. % Loss due to Evaporation, etc. | 0.79 | 0.77 | 0.41 |

It was observed that entire solvent was boiled out from furnace oil in the presence of free water at a temperature below 100° C. irrespective of an amount of solvent or type of solvent. It was observed that for collection of entire solvent without presence of free water, the boiling temperature range was observed to be 110.93-350.15° C. Here solvents like benzene, toluene and xylene did not form azeotrope with water, as presence of water was more in the reactor, steam stripping was playing a role in the removal of entire solvent.

From Table 11.1.A it was observed that maximum temperature of the reactor rose to 114.70° C., when xylene was added 3 times to the weight of furnace oil and water added was 1 time to the weight of xylene. In Test 3 of Table 11.1.A, same amount of solvent was taken but water was taken 2 times to the weight of solvent, with increase in the amount of water it was possible to collect entire Xylene at temperature under 100° C. Further it was observed that in case of toluene, to achieve entire solvent collection at lower temperatures the ratio of water to solvent was explored to be equal to 1. The tests in which ratio of water to solvent was less than 1, in such tests the maximum temperature rose to 101° C. In case of Benzene used as a solvent, it was essential to add one time to the weight of solvent for collection at lower temperatures when solvent to furnace oil ratio was 3.

It was seen that increasing the quantum of free water beyond a certain limit, not only allowed the boiling point range for solvent to fall down but also the quantity of solvent removed by unit mass of water boiling out was also decreased. In all cases excess amount of solvent was collected than the added amount. Accordingly, the solvent was allowed to be collected till it appears a bit yellowish in color which assured that entire 100% solvent got collected with least amount of furnace oil.

### Example-12

### Removal of Free Water from Hydrocarbons by using Pipette Suctions and Centrifuge

Experiments were conducted to speed up the removal of free water existing in the Hydrocarbons, initially using suction of water using a pipette followed by centrifuging the residual hydrocarbons for one or multiple times. The hydrocarbons, specifically for furnace oil and diesel oil, were obtained after removal of bound water by refluxing with a solvent in Dean and Stark apparatus and after subsequent removal of solvent, by heating with free water for removal of the added solvent.

Accordingly, the Hydrocarbons were heated in an RB flask till boiling point of water in order to reduce the viscosity and facilitate settling of water. The volumetric glass pipette was inserted to the bottom of the RB flask and suction was applied. After no more free water was observed in the pipette, the suction was halted. Further, depending on the remaining amount of water present in the material, the material was centrifuged after thin layer boiling. At no stage vapors were not allowed to be condensed during the experiment. The hot centrifuged material was further separated to hydrocarbons and water. After separating the top layer of hydrocarbons, the separated water was visible in the centrifuge bottle, which was subsequently removed using a pipette or simply by pouring it out. Depending on the remaining water content of the material, it was selected for further centrifuge. The Hydrocarbons were analyzed for their moisture content using BTX process.

TABLE 12.1
REMOVAL OF FREE WATER USING PIPETTE SUCTION AND CENTRIFUGE

| Sl. No. | PARTICULARS | TEST 1 | TEST 2 |
|---|---|---|---|
| 1 | Oil taken for Treatment | DIESEL | FURNACE OIL |
| 2 | Wt. of Oil taken for Treatment (g) | 400.28 | 400.33 |
| 3 | Wt. of Water taken for Boiling (g) | 300.13 | 300.27 |
| 4 | Loss of weight during Boiling (g) | 0.85 | 2.55 |
| 5 | Temperature at the Start of Vacuum Suction (° C.) | 77.1 | 79.5 |
| 6 | Pressure for Vacuum Suction (mbar) | 900 | 870 |
| 7 | Holding Time Required in Pipette Vacuum Suction | 19.44 | 13.50 |
| | (min) | | |
| 8 | Temperature of Material after Removing the Free | 59.00 | 67.9 |
| | Water by Suction (° C.) | | |
| 8 | Wt. of Water separated by Suction (g) | 297.91 | 268.12 |
| 9 | Wt. % of Water separated by Suction | 99.26 | 79.08 |
| 10 | Wt. of Water separated from Separating Funnel (g) | 1.11 | 0.56 |
| 11 | Wt. of Total Water separated (g) | 299.87 | 268.68 |
| 12 | Wt. % of Total Water separated (g) | 99.91 | 89.48 |
| 13 | Remaining Wt. of Oil + Free Water in RB Flask (g) | 396.98 | 416.32 |
| 14 | Wt. of Material Lost due to Evaporations, etc. (g) | 0.98 | 1.46 |
| 15 | Wt. of Material adhering to Various Surfaces (g) | 2.58 | 14.14 |
| 16 | Residual water Present after Suction as determined | 59 | — |
| | by BTX Test (PPM) | | |
| 17 | Wt. of Oil + Fee Water taken for Centrifuge (g) | — | 416.32 |
| 18 | Wt. % Water left in the Sample before Centrifuge | — | 10.52 |
| 19 | Temperature of Material before Centrifuge (° C.) | — | 95 |
| 20 | Wt. of Water Collected during thin layer boiling | | 9.63 |
| | before centrifuge (g) | | |
| 21 | Max. Relative Centrifugal Force at which the | — | 4500 |
| | Centrifuge was Operated (RCF) | | |
| 22 | Temperature of Material after Centrifuge (° C.) | | 62.3 |
| 23 | Residual Water Present in hydrocarbons after | — | 3,050 |
| | Centrifuge as determined by BTX Test (PPM) | | |

It was observed that it was difficult to remove entire free water from Furnace Oil being relatively viscous. It was seen that heating the material to the boiling point of water lowered the viscosity of Furnace Oil, enabling gravity separation of Furnace Oil and water into two layers, wherein water settled down at the bottom. It was observed that by pipetting out water using reduced pressure of 870 mbar, and further separating the bottom layer of Furnace Oil from separating funnel, only about 90% of water was separated.

Further, it was observed that by hot centrifuging Furnace Oil with inlet temperature of 95° C., most of the water was separated at the bottom. Further, it was observed that only around 3050 ppm of water was left in the furnace oil as measured by BTX process. This observed low percentage of water content after centrifuge which was probably due to uneven size droplets of water in the residual furnace oil sludge. It was established that, while the centrifuge was not as effective as on sludge due to same size of droplets, but due to boiling differing droplet size caused sweeping effect of bigger droplets to smaller ones which caused effective separation due to centrifuge.

In case of diesel, due to clear visible separation between diesel and water, the amount of water separated using pipette suction and later remaining by centrifuge was 99.9%. This good separation of water from diesel was further established after calculation of moisture percentage using BTX process in residual diesel which was measured to be 59ppm.

### Example-13

### Impact on Purity of Solvent Recovered from Sludge Due to Hydrocarbons Present in Sludge

Experiments were conducted to better understand the factors affecting purity of solvent obtained from solvent recovery. Predefined proportions of oil, water and solvent were weighed and taken in an RB flask of a Dean & Stark Apparatus followed by continuous heating on mantle heater and monitoring the temperature of material in RB flask. The vapors of water and solvent were collected in the receiver after condensing them with circulating cold water at 5-6° C. in the insulated condenser. Water and solvent were collected from the receiver at periodic intervals and allowed them to settle. In order to determine the point of collection where contamination was occurring, more solvent samples were collected when there was about 20% solvent left in RB flask.

In order to evaluate and improve the purity of solvent recovered, experiments were conducted to remove low boiling hydrocarbons which were found to be affecting the solvent purity by adding free water and boiling. Accordingly predetermined amounts of sludge and free water were weighed and taken in an RB flask of Dean & Stark Apparatus, followed by continuous heating thereof on the mantle heater while continuously monitoring temperature of material in RB flask with a digital thermometer. The vapors of water and oil were collected in the receiver after condensing them with circulating cold water at 5-6° C. in the insulated condenser.

Once the temperature of material in RB reached 97° C., heating was stopped and weighed amount of solvent was added immediately followed by continuous heating. The vapors of solvent and water were collected in the receiver after condensing thereby allowing the solvent to reflux at the top and water settled in the bottom was collected at periodic intervals and weighed. Once the water collection is stopped, weighed amount of free water based on the amount of solvent present in RB was added for solvent recovery followed by continuous heating thereby monitoring the temperature of material in RB flask. The vapors of solvent and water were allowed to condense in an insulated condenser with cold water circulated at 5-6° C. Accordingly, the solvent and water were collected from receiver at definite intervals and allowed to separate, from which solvent samples were taken for Gas Chromatography to determine solvent purity. Average sample was taken to compare overall solvent purity.

TABLE 13.1
REMOVAL OF LIGHT HYDROCARBONS FROM
DIESEL SLUDGE BY STEAM STRIPPING

| Sl. No. | PARTICULARS | TEST 1 | TEST 2 | TEST 3 | TEST 4 |
|---|---|---|---|---|---|
| 1 | Wt. of Diesel sludge present in RB flask (g) | 300.97 | 300.10 | 300.18 | 303.10 |
| 2 | Wt. of free water added in RB flask (g) | 200.21 | 0.00 | 0.00 | 0.00 |
| 3 | Initial Ratio of water to sludge | 0.67 | — | — | — |
| 4 | Observed boiling temperature Range (° C.) | 97.0-97.2 | 98.0-98.5 | 97.6-98.4 | 98.0-100.2 |
| 5 | Initial Wt. ratio of oil to Water collected | 0.54 | 0.59 | 0.60 | 0.54 |
| 6 | Final Wt. ratio of oil to Water collected | 0.15 | 0.19 | 0.27 | 0.22 |
| 7 | Average Wt. Ratio of oil to Water collected | 0.24 | 0.28 | 0.29 | 0.27 |
| 8 | Total wt. of water collected (g) | 204.17 | 104.22 | 97.35 | 108.21 |
| 9 | Total wt. of oil Collected (g) | 50.00 | 29.26 | 27.86 | 29.51 |
| 10 | Wt. of Diesel sludge left behind in the RB | 246.36 | 166.62 | 167.47 | 165.38 |
| | flask at the end of the experiment (g) | | | | |

TABLE 13.2
REMOVAL OF BOUND WATER FROM DIESEL SLUDGE WITH SLS BY AZEOTROPIC
BOILING WITH SOLVENT, WHILE REFLUXING SOLVENT BACK

| Sl. No. | PARTICULARS | TEST 1 | TEST 2 | TEST 3 | TEST 4 |
|---|---|---|---|---|---|
| 1 | Amount of sludge (g) | 176.46 | 166.62 | 167.47 | 165.38 |
| 2 | Wt. % water present in sludge | 55.2790 | 25.95 | 29.24 | 23.39 |
| | Solvent added | Toluene | Toluene | Toluene | Xylene |
| 3 | Wt. of Solvent added (g) | 449.98 | 166.27 | 193.00 | 118.42 |
| 4 | Wt. ratio of Solvent/Water collected | 4.61 | 4.02 | 3.94 | 3.06 |
| 5 | Wt. ratio of Solvent/Diesel oil collected | 5.70 | 1.41 | 1.63 | 0.93 |
| 6 | Observed boiling temperature Range (° C.) | 86.2-109.9 | 95.8-99.5 | 89.6-109 | — |
| 7 | Final Temperature (° C.) | 109.9 | 99.0 | 109.0 | 99.7 |
| 8 | Wt. % water collected up to final | 101.85 | 78.48 | 96.23 | — |
| | temperature | | | | |
| 9 | Residual water present in left over solvent | 832 | — | — | — |
| | cum Diesel Oil as determined by BTX test | | | | |
| | (ppm) | | | | |

TABLE 13.3
REMOVAL OF TOLUENE FROM DIESEL SLUDGE VIA STEAM STRIPPING

| Sl. No. | PARTICULARS | TEST 1 | TEST 2 | TEST 3 | TEST 4 |
|---|---|---|---|---|---|
| 1 | Wt. of Diesel present in RB flask (g) | 64.64 | 117.16 | 102.89 | 126.69 |
| 2 | Wt. of solvent present in RB flask (g) | 449.98 | 166.27 | 193.00 | 118.42 |
| 3 | Wt. of free water added in RB flask (g) | 449.88 | 166.75 | 193.10 | 236.84 |
| 4 | Initial Ratio of water to solvent | 1.00 | 1.00 | 1.00 | 2.00 |
| 5 | Observed boiling temperature Range (° C.) | 96.0-99.1 | 92.2-98.1 | 96.8-98.4 | 95.5-99.9 |
| 6 | Initial wt. ratio of Solvent to Water collected | 5.04 | 4.36 | 6.36 | 1.54 |
| 7 | Final wt. ratio of Solvent to Water collected | 0.11 | 0.22 | 0.08 | 0.07 |
| 8 | Average Wt. Ratio of Solvent to Water collected | 2.44 | 2.12 | 1.70 | 0.63 |
| 9 | Total wt. of free water collected (g) | 185.28 | 78.7 | 121.74 | 209.26 |
| 10 | Total wt. of Solvent Collected (g) | 452.84 | 167.1 | 206.62 | 131.38 |
| 11 | Average solvent purity (%) | 99.2797 | 97.7809 | 98.12 | 93.3812 |

TABLE 13.4
REMOVAL OF FREE WATER BY CENTRIFUGE

| Sl. No. | PARTICULARS | TEST 1 | TEST 2 | TEST 3 | TEST 4 |
|---|---|---|---|---|---|
| 1 | Wt. of Hydrocarbons left behind in the RB flask at | 50.34 | 39.54 | 102.89 | — |
| | the end of experiment (g) | | | | |
| 2 | Wt. of Free Water left behind in the RB flask at | 248.8 | 95.85 | 74.53 | 134.09 |
| | the end of experiment (g) | | | | |
| 3 | Wt. of emulsion left behind in the RB flask at | 3.69 | 83.36 | 2.56 | 148.55 |
| | the end of experiment (g) | | | | |
| 4 | Wt. of Hydrocarbons separated from emulsion | — | 13.21 | — | 19.62 |
| | after centrifuge 1 (g) | | | | |
| 5 | Wt. of Hydrocarbons separated from emulsion | — | 13.63 | — | 21.37 |
| | after centrifuge 2 (g) | | | | |
| 6 | Wt. of Hydrocarbons separated from emulsion | — | — | — | 5.73 |
| | after centrifuge 3 (g) | | | | |
| 7 | Wt. of Hydrocarbons separated from emulsion | — | — | — | 4.29 |
| | after centrifuge 4(g) | | | | |
| 8 | Wt. of free water separated from emulsion | — | 23.48 | — | 42.05 |
| | after centrifuge (g) | | | | |
| 9 | Wt. of residual emulsion after centrifuge (g) | — | 32.87 | — | 54.81 |
| 10 | Estimated wt. % water present in residual | — | 4.77 | — | 16.00 |
| | emulsion | | | | |

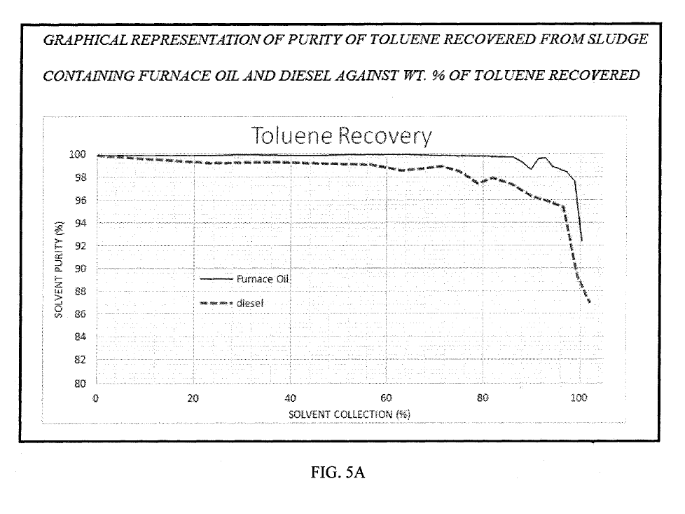

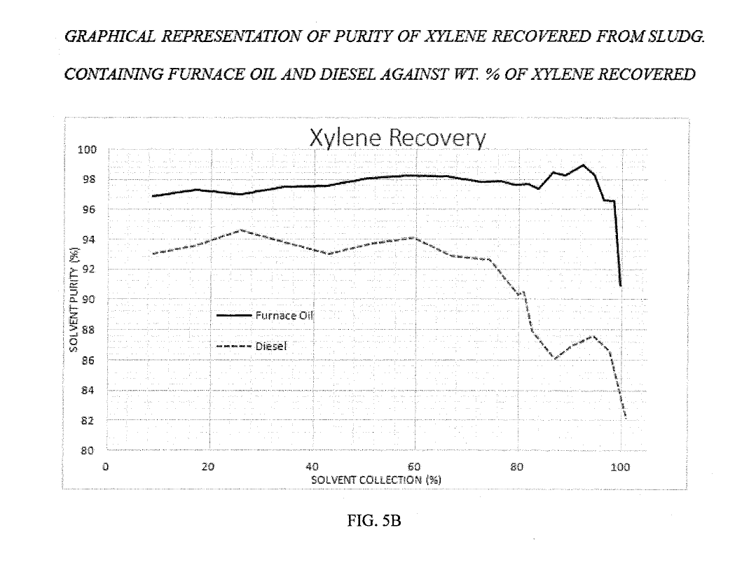

From FIGS. 5A and 5B, it was observed that the solvent purity of recovered solvent during final collections was deteriorated, due to light hydrocarbon fractions boiling out at the temperature range. In case of xylene, the purity of solvent recovered was comparatively lower because, the boiling point of xylene was high and more fraction boiled out especially in case of diesel.

It was observed that during recovery of solvent from diesel or Furnace Oil, the amount of solvent removed exceeded the amount of solvent added to the system. Gas spectrometry resulted for solvent at various stages of wt. % solvent recovered indicated impurities of oil in recovered solvent. Purity of solvent recovered dropped steeply after approximately 90% of solvent was already recovered. It was seen that the impurities were higher for diesel than for furnace oil in case of both solvents, which was expected as diesel was having a greater fraction of low boiling hydrocarbons that were likely to be stripped along with solvent. It was also seen that the impurities were more for xylene than for toluene for both Furnace Oil and Diesel, which was also expected since xylene was having a higher boiling point and higher vapour pressure comparable to a wider range of hydrocarbons present in oil. Accordingly, the average purity of solvent recovered was tabulated in table 13.5 below

TABLE 13.5
AVERAGE PURITY OF SOLVENT RECOVERED:

| | Toluene | Xylene |
|---|---|---|
| Pure Solvent | 99.8265% | 98.4411% |
| Furnace Oil | 99.5266% | 97.29% |
| Diesel | 97.4976% | 93.6148% |

TABLE 13.6
CALORIFIC VALUES OF DIESEL USED FOR
EXPERIMENTS AND LIGHT HYDROCARBONS
OBTAINED BY STEAM STRIPPING

| Sl. No. | PARTICULARS | Calorific value (kcal/kg) |
|---|---|---|
| 1 | Pure Diesel | 10,826 |
| 2 | Light Hydrocarbons extracted | 10,924 |

Accordingly, in the view of tables 13.1-13.5, it was observed that when part of Diesel Sludge was stripped before solvent was added to remove bound water from sludge, average purity of solvent recovered from Diesel by free water addition for steam stripping was higher. Purity of solvent recovered was directly related to amount of diesel removed before solvent addition. When free water was added to remove diesel, 50 g diesel was removed via steam stripping whereas in other cases where free water was not added and sludge was simply boiled to remove diesel along with bound water while not exceeding boiling point of water, Diesel recovered was approximately 27 g. Average ratio of solvent to water collected was approximately equal in all experiments. It was observed that, purity was raised up to 99.2797% when more Diesel was removed. It was observed that purity rose to 97.4976% when no Diesel was removed. When 27 g of diesel was removed then purity of recovered solvent was 97.7809%, in case where bound water removal with solvent was terminated at 100° C., and 98.12%, in case where bound water removal with solvent was terminated at boiling point of solvent.

It was also observed that purity of solvent was slightly poor for initial collection of solvent recovered. This was mainly due to presence of light hydrocarbons with boiling point less than boiling point of solvent. Contamination for initial collections was more in case of xylene than for toluene because of higher boiling point of xylene. It was also observed that purity of solvent was less for xylene throughout the collection process while recovering xylene from diesel. There could be due to fraction of diesel with boiling point similar to xylene which contaminated xylene.

It was observed that fraction of diesel was still present as an emulsion even after recovery of solvent. It existed partly as bound water not removed during azeotropic boiling stage and partly as free water dispersed in diesel at the water-diesel interface. This was a fairly weak emulsion, part of which could be easily separated using high speed centrifuge. Amount of emulsion layer formed was observed to be proportional to amount of bound water remaining after azeotropic boiling stage. Weight of emulsion layer when reflux stage was carried up to boiling point of solvent was 3.69 g and 2.56 g, whereas weight of emulsion when reflux stage was carried up to 100° C. was 83.36 g. In the above experiment, 31.32 g of bound water still remained in sludge after boiling with reflux. In 83.36 g of sludge that remained, approximately 30% was water and this water was not tightly bound. After high speed centrifuge at 14000 RPM for 10 min, 23.48 g of water was separated from sludge and correspondingly 26.84 g of diesel was also separated. 32.87 g of tightly bound emulsion remained after centrifuge and water content in this emulsion was 4.77%. Accordingly, it was found that it was very difficult to remove water from such emulsion. It was also observed that calorific value of hydrocarbons fraction obtained during initial steam stripping was found to be higher than pure oil.

### Example-14

### Removal of Water from Petroleum Sludge with Relatively High Boiling Azeotropic Solvent While Ensuring that Hydrocarbons were Not Subjected to Higher than Boiling Point of Water at Atmospheric Pressure

Experiments were conducted to quantitatively retrieve back pure hydrocarbons and water, present in various sludges and also retrieve back the entire solvent and free water in accordance with the process of the present invention. Accordingly, weight fraction of bound water present in sludges were firstly determined and then calculated amount of solvent was added in an RB flask of a Dean and Stark Apparatus, followed by continuous heating using Mantle Heater and continuous monitoring of the temperature of material using digital thermometer. The temperature was maintained such that the liquid temperature does not exceed 100° C., and preferably 97° C.

Accordingly, weight fraction of bound water present in sludge was removed while the solvent was refluxed. Subsequently, water vapors were condensed and collected. Further, calculated amount of free water was added to residual matter in RB Flask and once again heated using the same apparatus. Subsequently, entire remaining solvent was removed and collected along with some free water. Thereafter, the entire amount of remaining free water from the residual hydrocarbons was collected through pipette suction after heating the hydrocarbons, followed by one or multiple centrifuge depending on the amount of remaining free water in the Hydrocarbons. Finally, the water and hydrocarbon samples were analyzed quantitatively using mass balance study.

TABLE 14.1
REMOVAL OF BOUND WATER FROM SLUDGES
BY REFLUXING WITH AZEOTROPIC SOLVENTS

| Sl. No. | PARTICULARS | TEST 1 | TEST 2 | TEST 3 |
|---|---|---|---|---|
| 1 | Name of Sludge | Furnace Oil | Diesel Sludge | |
| | | Sludge | | |
| 2 | Name of Solvent added | Toluene | Toluene | Xylene |
| 3 | Amount of Sludge (g) | 302.3 | 300.10 | 301.62 |
| 4 | Wt. % Water Present in Sludge | 50.2441 | 48.3400 | 48.3400 |
| 5 | Wt. of Solvent added (g) | 607.82 | 582.88 | 453.36 |
| 6 | Wt. Ratio of Solvent to Water | 4.00 | 4.02 | 3.11 |
| 7 | Observed Boiling Temperature Range (° C.) | 85.6-97 | 92.89-98.82 | 92.7-97 |
| 8 | Controlling Maximum Temperature (° C.) | 97 | 98.82 | 97 |
| 9 | Wt. % water collected up to above Temperature | 93.00 | 92.56 | 58.59 |

TABLE 14.2
REMOVAL OF ENTIRE SOLVENTS FROM DE-WATERED
HYDROCARBONS BY USING FREE WATER

| Sl. No. | PARTICULARS | TEST 1 | TEST 2 | TEST 3 |
|---|---|---|---|---|
| 1 | Hydrocarbons | Furnace Oil | Diesel | |
| 2 | Wt. of Solvent Present in RB flask (g) | 607.51 | 582.56 | 453.36 |
| 3 | Wt. of Free Water added in RB flask (g) | 607.20 | 584.00 | 907.60 |
| 4 | Initial Ratio of Water to Solvent present in RB | 1.02 | 1.00 | 2.14 |
| | flask | | | |
| 5 | Observed Boiling Temperature Range (° C.) | 95.4-99.2 | 93.29-97.54 | 93.8-96.7 |
| 6 | Initial Wt. Ratio of Solvent to Water collected | 6.38 | 4.78 | 2.00 |
| 7 | Final Wt. Ratio of Solvent to Water collected | 0.08 | 0.13 | 0.55 |
| 8 | Average Wt. Ratio of Solvent to Water collected | 2.33 | 2.03 | 1.52 |
| 9 | Total wt. of Free Water Collected (g) | 259.63 | 305.96 | 586.20 |
| 10 | Total wt. of Solvent Collected (g) | 605.63 | 619.95 | 479.17 |
| 11 | Wt. of estimated Hydrocarbons left behind in the | 150.41 | 116.4 | 92.19 |
| | RB flask at the end of the Experiment (g) | | | |
| 12 | Wt. of estimated Free Water left behind in the | 357.98 | | 381.77 |
| | RB flask at the end of the Experiment (g) | | | |
| 13 | Wt. % Loss due to the Evaporation, etc. | 0.91 | 0.70 | 0.43 |

TABLE 14.3
REMOVAL OF FREE WATER FROM HYDROCARBONS

| Sl. No. | PARTICULARS | TEST 1 | TEST 2 | TEST 3 |
|---|---|---|---|---|
| 1 | Hydrocarbons | Furnace Oil | Diesel | |
| 2 | Wt. of Hydrocarbons collected (g) | — | 86.39 | — |
| 3 | Wt. of Free Water collected (g) | 320.01 | 285.13 | 312.9 |
| 4 | Wt. of Emulsion left behind in the RB flask at | 174.30 | 21.76 | 159.49 |
| | the end of Experiment (g) | | | |
| 5 | Wt. of Water separated from Emulsion after | 9.32 | 8.03 | — |
| | Centrifuge 1 (g) | | | |
| 6 | Wt. of Hydrocarbons separated from Emulsion | — | 10.16 | 8.54 |
| | after Centrifuge 1 (g) | | | |
| 7 | Wt. of Free water separated from Emulsion | — | — | 54.17 |
| | after Centrifuge (g) | | | |
| 8 | Wt. of Hydrocarbons separated from Emulsion | — | — | 17.1 |
| | after Centrifuge 2 (g) | | | |
| 9 | Wt. of Residual Emulsion after Centrifuge (g) | 164.98 | 3.50 | 79.68 |
| 10 | Estimated Wt. % Water Present in Residual | 11.61 | — | 24.68 |
| | Emulsion | | | |

It was observed that due to halting the Step 1 at ˜97° C., the percentage of water removed was 93.15% for furnace oil while even lower at 85.75% for Diesel with toluene as the solvent and 58.59% with xylene as the solvent. For experiments with Diesel, Test 2 and Test 3 revealed that more than hundred percent of solvent was collected due to contamination of solvent by light hydrocarbons present in Diesel.

It was also observed, most of the water was collected by 100° C., and to collect that remaining last bit of water, the kinetics is very slow and the energy required is also high, which can be left out, to be taken care of in further processing.

In processing of Diesel Sludge, it was observed that part of the Diesel was still emulsified after solvent recovery stage. Diesel remains emulsified partly because of bound water remaining in sludge after the first stage and partly as a weak emulsion existing at the Diesel-free water interface. Weight of emulsion layer formed is directly proportional to the weight of bound water remaining in sludge. This is a fairly weak emulsion, part of which can be separated using high speed centrifuge. It is very difficult to separate water from other part for which we have to go to boiling point of solvent. It is not advisable to stop bound water removal process at 100° C. in case of hydrocarbons with high viscosity.

### Example-15

### Recovery of Pure Hydrocarbons, Bound Water, Solvent and then Free Water from Petroleum Sludges

Experiments were conducted to quantitatively retrieve back pure hydrocarbons and entire water, inclusive of entire bound water, present in various sludges and entire solvent and free water in accordance with the process of the present invention.

Accordingly, weight fraction of bound water present in sludges were firstly determined and then calculated amount of solvent was added therein followed by heating in a Dean and Stark apparatus using Mantle Heater and continuously monitoring the temperature of material in RB flask. Accordingly, weight fraction of bound water present in sludge was removed while the solvent was refluxed. Subsequently, water vapors were condensed using cold water at 5-6° C. in an insulated condenser and collected thereafter. Accordingly, calculated amount of free water was added to residual matter in RB Flask and once again was heated using the same apparatus. Subsequently, entire remaining solvent was removed and collected along with some free water. Thereafter, the entire amount of remaining free water from the residual hydrocarbons was collected through pipette suction after heating the hydrocarbons, which was then followed by thin layer boiling with cascading or spraying by ensuring that temperature of material doesn't go below boiling point of water, so that vapors do not condense. Hot Centrifuge could also be an alternative depending on amount of water present. After solvent removal, at no stage water vapors were allowed to condense. Finally, the water and hydrocarbon samples retrieved were analyzed quantitatively using mass balance study.

TABLE 15.1
REMOVAL OF BOUND WATER FROM SLUDGE BY BOILING
WITH SOLVENT WHILE REFLUXING SOLVENT

| | | TEST 1 | TEST 2 |
|---|---|---|---|
| Sl. No. | PARTICULARS | TOLUENE | XYLENE |
| 1 | Amount of Sludge (g) | 303.36 | 303.40 |
| 2 | Wt. % Water Present in above Sludge | 49.9137 | 49.9137 |
| 3 | Wt. of Solvent added (g) | 600.55 | 456.66 |
| 4 | Wt. Ratio of Solvent to Water | 3.97 | 3.02 |
| 5 | Wt. Ratio of Solvent to Hydrocarbons | 3.95 | 3.01 |
| 6 | Observed Boiling Temperature Range (° C.) | 87-109.7 | 94.86-137.75 |
| 7 | Temperature at Constant Water Collection (° C.) | 88.90 | 100.07 |
| 8 | Wt. % Water Collected up to above Temperature | 85.27 | 89.26 |
| 9 | Rate of Water Collection up to above Temperature | 1.54 | 1.50 |
| | (g/min) | | |
| 10 | Temperature (° C.) | 94.8 | 134.65 |
| 11 | Wt. % Water Collected up to above Temperature | 89.49 | 97.92 |
| 12 | Rate of Water Collection for above Temperature | 1.05 | 0.53 |
| | (g/min) | | |
| 13 | Overall Rate of Water Collection up to above Temp | 1.52 | 1.41 |
| | (g/min) | | |
| 14 | Residual Water Present in left over Solvent cum | 212 | <66 |
| | Furnace Oil as determined by BTX Test (PPM) | | |

TABLE 15.2
RECOVERY OF SOLVENT FROM HYDROCARBONS
BY BOILING WITH FREE WATER

| | | TEST 1 | TEST 2 |
|---|---|---|---|
| Sl. No. | PARTICULARS | Toluene | Xylene |
| 1 | Wt. of Furnace Oil + Solvent Present in RB flask (g) | 750.59 | 604.37 |
| 2 | Wt. of Solvent Present in RB flask (g) | 600.55 | 456.66 |
| 3 | Wt. of Free Water added in RB flask (g) | 600.20 | 915.42 |
| 4 | Initial Ratio of Water to Solvent | 1.00 | 2.00 |
| 5 | Observed Boiling Temperature Range (° C.) | 95.5-99.3 | 94.86-137.85 |
| 6 | Initial Wt. Ratio of Solvent to Water | 5.00 | 2.07 |
| 7 | Final Wt. Ratio of Solvent to Water | 0.08 | 0.05 |
| 8 | Average Wt. Ratio of Solvent to Water | 2.31 | 1.05 |
| 9 | Total wt. of Free Water Collected (g) | 263.59 | 437.209 |
| 10 | Total wt. of Solvent Collected (g) | 604.12 | 460.22 |
| 11 | Wt. of FO + Free Water left behind in the RB flask at | 475.28 | 613.86 |
| | the end of the Experiment (g) | | |
| 12 | Estimated wt. of Free Water left behind in the RB flask at | 328.80 | 469.71 |
| | the end of the experiment (g) | | |
| 13 | Wt. % Loss due to the Evaporation, etc. | 0.40 | 0.43 |

TABLE 15.3
FREE WATER REMOVAL FROM FURNACE OIL

| Sl. No. | PARTICULARS | TEST 1 | TEST 2 |
|---|---|---|---|
| 1 | Wt. of Furnace Oil + Free Water Remaining (g) | 475.28 | 613.86 |
| 2 | Estimated wt. of Water Remaining (g) | 328.8 | 469.71 |
| 3 | Wt. of Water separated by Suction (g) | 302.13 | 443.87 |
| 4 | Wt. % of Water separated by Suction | 91.89 | 94.50 |
| 5 | Wt. of Material taken for cascading thin layer boiling (g) | — | 169.99 |
| 6 | Temperature of Material(° C.) | — | 111.2 |
| 7 | Wt. of Material taken for Centrifuge (g) | 173.15 | — |
| 8 | Temperature of Material(° C.) | 94.50 | — |
| 9 | Water separated after Centrifuge (g) | 22.45 | — |
| 10 | Residual Water Present after Centrifuge as determined by | 2959 | 2296 |
| | BTX Test in Centrifuge Bottom (PPM) | | |
| 11 | Calorific value of recovered Furnace Oil (Kcal/kg) | 10,029 | 10,137 |

It was observed that about 98% of bound water present in sludge was collected during azeotropic boiling stage of the process for both solvents. However BTX results revealed that the residual water present in sludge was less than 200 ppm for both solvent. The remainder of water was most likely lost due to evaporation or as condensates on various parts of equipment other than the receiver. Temperature during this stage never exceeded boiling point of solvent.

In solvent recovery stage enough free water was given to prevent depletion of water at the end of solvent recovery. It was seen that the weight of solvent collected was more than weight of solvent added during bound water removal stage. Accordingly, it was observed that the light hydrocarbons in furnace oil whose boiling point was closer to solvent also got steam stripped along with solvent.

Lastly, it was observed that more amount of free water in the furnace oil resulted in separation of more amount of water through suction. Residual material in hot condition may go for thin layer boiling where temperature of material could be raised above boiling point of water, not letting vapours to condense and to remove maximum amount of water possible by cascading or spraying to release those uncondensed vapours. Further, hot centrifuge was also found to be an alternative but not preferred, in removing the remaining dispersed water.

The present invention has been described in an illustrative manner, and it is to be understood that the terminology used is intended to be in the nature of description rather than of limitation. It is not intended to be exhaustive or to limit the invention to the precise form disclosed. Many modifications and verifications are possible in light of the above teaching. It is intended that the scope of the invention be limited not by this detailed description, but rather by the claims appended hereto. It is also to be understood that the following claims are intended to cover all of the generic and specific features of the invention described herein.

1. A process for treatment of sludge mixture, emulsions and water bearing hydrocarbons preferably with determined quantity of water present therein, said process comprising the steps of:
a) pretreating the sludge mixture for removal of unbound water, salts, solids, water soluble emulsifiers, free flowing hydrocarbons and viscous pure hydrocarbons thereby obtaining a predefined amount of remaining sludge;
b) segregating the remaining sludge by viscosity using separation equipment followed by recovering a plurality of recovered fractions separately for removal of entire or partial bound and/or unbound water therefrom;
c) treating a plurality of different hydrocarbon fractions containing bound water and low boiling hydrocarbons thereby optionally adding free water followed by heating up to a boiling point of the water thereby employing steam stripping in said process;
d) treating a plurality of hydrocarbon fractions separately for removal of both bound and unbound water recovered in step b) thereby selectively depressing boiling point through addition of a predefined amount of water immiscible solvent in said process;
e) boiling a reaction mixture in step d) by applying heat for achieving a predefined temperature of said mixture optionally controlling said process on the basis of final raised temperature or by an amount of water collected or both;
f) recovering a specific quantity of the solvent and water added thereby partially or continuously refluxing a predefined amount of the recovered solvent during said process until achieving the predefined temperature in step e);
g) adding a predefined amount of free water to the hydrocarbons in step f) followed by boiling out the solvent through application of heat thereby removing excess free water left behind by optionally through a gravity settling or a centrifuge in hot condition or via boiling, thereby rapidly separating residual water from said hydrocarbons;
h) recovering a specific amount of original hydrocarbons in marketable form with highest possible commercial value thereof followed by recovering bound water, unbound water and free water in an environmentally safe and useful condition after treating the water for such use; and
i) reusing the recovered solvent in said process for further removal of bound water of incoming sludge mixture after removing entrained, soluble water therein followed by purifying at least a part of said solvent for removing fractions of dissolved hydrocarbons therefrom.

2. The process for treatment of sludge mixture as claimed in claim 1,
wherein said process of pretreatment forms the sludge mixture as a saleable product emulsion after removal of entire solids from the viscous fraction thereof,
wherein said process facilitates removal of salt and a fraction of water soluble emulsifiers present in the sludge mixture, and
wherein viscous/non-viscous portions obtained after pretreatment followed by addition of the solvent and reflux till boiling point of the solvent forms hydrocarbons in saleable form, wherein the hydrocarbons are formed along with weak emulsion that is further treated in case of non-viscous sludge.

3-5. (canceled)

6. The process for treatment of sludge mixture as claimed in claim 1,
wherein addition of solvent to the viscous portion obtained after pretreatment followed by heating said mixture below boiling point of the solvent forms a stronger emulsion with low water content present therein,
wherein addition of solvent to the non-viscous portion of the sludge mixture containing emulsifiers followed by heating thereof below the boiling point of the solvent forms saleable hydrocarbons and strong emulsion product, and
wherein addition of solvent in the non-viscous sludge followed by boiling with solvent slightly below the boiling point of the solvent forms a weak emulsion that is broken during the pretreatment step for producing pure hydrocarbons at a lower temperature and without any thermal damage.

7-8. (canceled)

9. The process for treatment of sludge mixture as claimed in claim 1,
wherein said process recovers strongly held solids-free, salts-free but not necessarily emulsifier-free water in hydrocarbon emulsions as value added marketable product with water content varying in a range of about 50 wt. % to 80 wt. % by addition of hot solvent and centrifuge, and
wherein segregation of sludge during the pretreatment step is facilitated by the separation equipment such as a cold centrifuge, a hot centrifuge, a vibratory flow-table, a settling tank with or without aeration and the like.

10. (canceled)

11. The process for treatment of sludge mixture as claimed in claim 1,
wherein said process of pretreatment removes salts from said process thereby allowing carrying saline-free hydrocarbons in a downstream of said process thereby preventing corrosion and fouling of equipment used in the downstream of said process,
wherein said process of pretreatment removes salts and solids from said process thereby aiding removal of emulsifiers present in the sludge mixture, wherein said removal of solids during pretreatment enhances commercial value of the recovered hydrocarbons and prevents fouling of heat transfer surfaces, and wherein said removal of solids during pretreatment and before boiling reduces loss of hydrocarbons due to oily sludge and reduction in the cost of de-oiling of solids,
wherein said process of pretreatment removes most of the unbound water thereby subjects only the viscous part of the sludge containing bound water in the downstream of said process, and
wherein said process of pretreatment reduces quantum of the sludge mixture which effectively reduces solvent required to treat the sludge mixture and further reduces quantity of free water required to remove said solvent from recovered hydrocarbons thereby reducing heat required to remove bound water, solvent and free water for increasing productivity of said process.

12-15. (canceled)

16. The process for treatment of sludge mixture as claimed in claim 1,
wherein the solvent is added in hot a condition to the viscous fraction of hydrocarbon to reduce viscosity and increase density difference between hydrocarbon and water or solids that facilitates removal solids and free water by a gravity settling or a centrifuge while maintaining high temperature of the sludge, wherein the solvent depresses the boiling point of water through heterogeneous low boiling azeotrope, reduces viscosity and enhances density difference thereby facilitating ease of transportation of water vapor and liquid droplets through reduced viscosity liquid pool, and
wherein said refluxing of the solvent facilitates addition of smaller initial quantum of solvent for a given weight of sludge at given water content in order to reduce quantum and cost of overall solvent required in said process.

17-19. (canceled)

20. The process for treatment of sludge mixture as claimed in claim 1,
wherein said refluxing of the solvent improves kinetics through reduction of viscosity during boiling step thereby improving productivity of said process,
wherein said refluxing of the solvent maintains constant viscosity in said process that is amenable to add excess solvent for obtaining lower average viscosity without depletion of the solvent level,
wherein said refluxing of the solvent is such that a ratio of residual weight of solvent to residual weight of water is maintained above a specified point irrespective of a heating rate,
wherein said refluxing of the solvent avoids explosive discharge of vapors thereby reducing risk factors in said process, and
wherein said refluxing of the solvent ensures that a temperature required for driving out entire bound water is below the boiling point of solvent.

21-24. (canceled)

25. The process for treatment of sludge mixture as claimed in claim 1,
wherein the solvent is an azeotrope of water selected from the group of benzene, toluene, xylene, hexane, heptane, or mixtures thereof and the like,
wherein the predefined amount of solvent is in a ratio of 1.6 to 8.0 times the weight of water/hydrocarbons present in the feed stream,
wherein the predefined temperature in said process is in a range of 70° C. to 140° C.,
wherein residual water content for all the solvents is less than 10 wt. % of the original water present therein,
wherein residual water content for all the solvents is less than 10 wt. % of the original water present therein, and
wherein the predefined amount of solvent is selected based on the nature of hydrocarbons present in the sludge and maximum allowable temperature of the sludge mixture in order to prevent thermal cracking.

26-29. (canceled)

30. The process for treatment of sludge mixture as claimed in claim 1,
wherein the solvent is added in a ratio of 3-4 times the weight of water or 1-2 times the weight of hydrocarbons such that the solvent added is more than or equal to both the ratios thereof,
wherein the free water added during solvent recovery step is 1-2.5 times the weight of residual solvent present in the hydrocarbons, and
wherein said process removes entire bound water from the sludge mixture approximately around a boiling point of the solvent irrespective of the nature and quantity of the water content of the sludge mixture.

31-32. (canceled)

33. The process for treatment of sludge mixture as claimed in claim 1,
wherein said process improves productivity of the heating vessel or reactor either by increasing heat transfer area or by increasing temperature difference between heating medium and system, wherein said heating vessel or reactor optionally includes extra heat transfer plates to have an increased heat transfer area,
wherein said process uses waste heat available in flue gases during co-generation with gas turbine based power plant or any other industrial operation,
wherein said process treats high viscosity hydrocarbons such that final free water is removed by boiling the water out by one or more of the following processes such as a thin film evaporator with cascading trays, hot spraying of hydrocarbons into an evaporation chamber at a temperature above the boiling point of water, passing fine bubbles of inert flue gas/air or a hot cyclone or agitator with or without baffles, and
wherein said process avoids higher temperature when using high boiling solvents thereby terminating said process at a lower temperature when the maximum fraction of water is removed followed by addition of free water to remove solvent and subsequent separation of hydrocarbons from free water by gravity separation, wherein said process is preferred when low viscosity hydrocarbons are present in the sludge mixture.

34. (canceled)

35. The process for treatment of sludge mixture as claimed in claim 1,
wherein said refluxing of the solvent is preferred with low boiling solvents in order to complete said process at a temperature substantially lower than boiling point of water,
wherein said refluxing of the low boiling solvent is carried out with co-generation or in a multi-effect evaporator as it requires less energy, and
wherein heat from vapor of condensate is used for further boiling through an evaporator, or a multiple effect evaporator or a mechanical vapor re-compressor such that heat is dissipated from the final condenser into large water bodies.

36-41. (canceled)

42. The process for treatment of sludge mixture as claimed in claim 1,
wherein said process recovers heat from hot dewatered hydrocarbons without leading to excessive rise in viscosity such that the dewatered hydrocarbons are discharged at a temperature below flash point thereof,
wherein said process utilizes a condenser that has a smaller volume in order to ensure that most of the solvent stays in the reactor during said process,
wherein said process removes traces of hydrocarbons present in recovered water by bio-degradation, and
wherein said process removes solvent from the sludge mixture by adding free water in an excess amount that is determined by azeotropic ratio of solvent and water by ensuring that water added is sufficient enough to recover entire solvent from hydrocarbons.

43-45. (canceled)

46. The process for treatment of sludge mixture as claimed in claim 1,
wherein boiling point of azeotrope increases with decrease in droplet size in said process however finer droplets are more dispersed such that water can be removed at a lower temperature, and
wherein the sludge mixture containing emulsifiers re-emulsify with free water during solvent removal stage.

47-48. (canceled)

49. The process for treatment of sludge mixture as claimed in claim 1,
wherein said process utilizes thermal or mechanical foam breakers to mitigate foaming during reflux or solvent recovery step of said process, wherein the thermal foam breakers are preferred when emulsifiers are present in the sludge mixture, and wherein said thermal foam breakers are followed by temperature conditioner in case of partial refluxing of the solvent in order to mitigate the problem of light hydrocarbons contaminating solvent condensate.

50-51. (canceled)

52. The process for treatment of sludge mixture as claimed in claim 1,
wherein part of solvent is removed from the condenser without being refluxed,
wherein partial removal of solvent is continued till solvent to hydrocarbon ratio does not diminish below a predefined solvent-hydrocarbon ratio in said process,
wherein said refluxing of solvent is terminated when the sludge temperature reaches up to 90° C. followed by boiling of the sludge without solvent reflux till the sludge temperature reaches up to 100° C.,
wherein the solvent recovered from hydrocarbons is contaminated with light hydrocarbons towards the end of the solvent recovery step of said process, and
wherein the solvent recovered from the sludge mixture is purified by process selected from steam stripping or fractional distillation or both.

53-56. (canceled)

57. The process for treatment of sludge mixture as claimed in claim 1,
wherein said process recovers light hydrocarbons by having boiling before solvent addition during said process in order to reduce contamination of the recovered solvent from the sludge such that said boiling is with or without free water addition
wherein said process facilitates at least a portion of hydrocarbons or a portion of medium viscosity hydrocarbons with relatively higher residual water content to be boiled preferably under vacuum thereby having a thickness of a liquid layer to be substantially small during said boiling, and
wherein said process utilizes an appropriate combination of various mechanisms such as azeotropy, steam stripping and solvent stripping in order to effectively remove water from the sludge mixture, wherein said azeotropy is modified by solvent being contaminated by hydrocarbons thereby altering boiling point thereof across a large range and fine water droplets present in sludge have slight increase in boiling point thereof.

58. (canceled)

59. The process for treatment of sludge mixture as claimed in claim 1,
wherein the solvent being refluxed in the reactor or heating vessel enters at a lowest part of said vessel preferably with heating element present at the bottom thereof in order to ensure presence of solvent throughout the bulk of sludge mixture for effective water removal with enhanced kinetics, and
wherein said process facilitates boiling of non-viscous or low viscous hydrocarbon sludge with or without free water with view to remove low boiling hydrocarbons present therein, wherein the low boiling hydrocarbons boil out at a temperature significantly below than their original boiling point and with higher calorific value on account of higher hydrogen to carbon ratio thereby having a high commercial value.

60-63. (canceled)

64. The process for treatment of sludge mixture as claimed in claim 1, wherein a ratio of water to recovered solvent increases on account of rapidly rising boiling point of solvent in case where solvent present is in a smaller amount during solvent recovery step of said process, wherein the viscous sludge having high boiling hydrocarbons observe rapid rise in the boiling point of the solvent such that said rise in boiling point is arrested to some extent by presence of low boiling hydrocarbons thereby aiding efficient and quick removal thereof.

65. (canceled)

66. The process for treatment of sludge mixture as claimed in claim 1, wherein the strong sludges hold azeotropic ratio and azeotropic temperature for a larger fraction of water removal without having segregation of water due reduced viscosity and increased density difference on account of solvent present in said process.

67. The process for treatment of sludge mixture as claimed in claim 1, wherein the solvents with varying boiling points are used in different evaporation chambers if a multi effect evaporator for saving overall energy cost in said process, wherein xylene, toluene and benzene are respectively added to said evaporation chambers of said multi effect evaporator such that vapors evolving from the chamber containing xylene supply heat to the chamber containing toluene and vapors evolving from the chamber containing toluene supply heat to the chamber containing benzene.

68. (canceled)
